(19) United States
(12) Patent Application Publication
(10) Pub. No.: US 2022/0261801 A1
(43) Pub. Date: Aug. 18, 2022

(54) Computer Systems and Software for Self-Executing Code and Distributed Database

(71) Applicant: Joshua Paul Davis, Plano, TX (US)

(72) Inventor: Joshua Paul Davis, Plano, TX (US)

(21) Appl. No.: 17/396,203

(22) Filed: Aug. 6, 2021

Related U.S. Application Data
(60) Provisional application No. 63/149,209, filed on Feb. 12, 2021.

(51) Int. Cl. G06Q 20/40; G06Q 40/08

(52) U.S. Cl. CPC G06Q 20/401; G06Q 10/1057; G06Q 2220/00; G06Q 40/08

(57) ABSTRACT

In certain embodiments, a system includes a processor and non-transitory computer-readable medium storing instructions that, when executed, cause the processor to perform operations including depositing, for each of multiple group members, a payment to a first cryptocurrency address for the member, the payment corresponding to an amount withheld from a wage payment to the member. Each member has a respective device, and each first cryptocurrency address has a corresponding private key stored on the member's device. The operations include receiving an approved benefit request for a requesting member, and communicating, in response to the approved request, an instruction to each device that causes use of the private key on the device to initiate a transfer of a partial benefit claim payment from the device's first cryptocurrency address to a computer-implemented hub for depositing to a second cryptocurrency address of the requesting member according to a ruleset enforced by the hub.

### CROSS-REFERENCE TO RELATED APPLICATIONS

This application claims the benefit of U.S. Provisional Application No. 63/149,209, filed on Feb. 12, 2021, which application is incorporated by reference.

### TECHNICAL FIELD

This disclosure relates generally to computer systems, and, in particular embodiments, to computer systems and software for self-executing code and distributed database.

### BACKGROUND

Distributed ledger technology allows data and transactions to be stored in a distributed database, making it difficult or impossible to tamper with or falsify the data, or to otherwise deny the occurrence of a transaction recorded on the distributed ledger. This attribute of distributed ledger technology is called non-repudiation. Self-executing agreements, commonly referred to as smart contracts, execute in a distributed ledger environment.

### SUMMARY

In certain embodiments, a system includes a processor and non-transitory computer-readable medium storing instructions that, when executed, cause the processor to perform operations including depositing, for each of multiple group members, a payment to a first cryptocurrency address for the member, the payment corresponding to an amount withheld from a wage payment to the member. Each member has a respective device, and each first cryptocurrency address has a corresponding private key stored on the member's device. The operations include receiving an approved benefit request for a requesting member, and communicating, in response to the approved request, an instruction to each device that causes use of the private key on the device to initiate a transfer of a partial benefit claim payment from the device's first cryptocurrency address to a computer-implemented hub for depositing to a second cryptocurrency address of the requesting member according to a ruleset enforced by the hub.

In certain embodiments, a non-transitory computer-readable medium stores instructions that, when executed by one or more processors, cause the one or more processors to perform operations that include facilitating generation of a first cryptocurrency address having a first private key. The first cryptocurrency address is for storing first cryptocurrency funds for funding a benefit claim. The first private key is for storing on a user device of a first group member of a plurality of group members of a group. The operations include initiating, in response to receiving an instruction from a device associated with a trusted intermediary, a transfer, via a computer-implemented hub, of a first cryptocurrency payment from the first cryptocurrency address to a benefit cryptocurrency address of a benefit award recipient. The instruction is associated with an approval of a benefit claim request of the benefit award recipient.

### BRIEF DESCRIPTION OF THE DRAWINGS

For a more complete understanding of this disclosure, and the advantages thereof, reference is now made to the following descriptions taken in conjunction with the accompanying drawings, in which:

FIG. 1 illustrates a block diagram of an example system for providing a group benefit using a self-executing agreement and distributed ledger, according to certain embodiments of this disclosure;

FIG. 2 illustrates an overview of an example process for providing a group benefit using a self-executing agreement and distributed ledger, according to certain embodiments of this disclosure;

FIG. 3 illustrates another view of an example process for providing a group benefit using a self-executing agreement and distributed ledger, according to certain embodiments of this disclosure;

FIG. 4 illustrates example division of operations between a fiat currency layer and a cryptocurrency layer, according to certain embodiments of this disclosure;

FIG. 5 illustrates another view of an example process for providing a group benefit using a self-executing agreement and distributed ledger, according to certain embodiments of this disclosure;

FIG. 6 illustrates example details of the group management processing system of FIG. 1, according to certain embodiments of this disclosure;

FIG. 7 illustrates example details of the group information of FIG. 1, according to certain embodiments of this disclosure;

FIG. 8 illustrates example details of the user device of FIG. 1, according to certain embodiments of this disclosure;

FIG. 9 illustrates example details of the computer-implemented hub of FIG. 1, according to certain embodiments of this disclosure;

FIG. 10 illustrates an example framework of certain rights and obligations created by an example system for providing a group benefit using a self-executing agreement and distributed ledger, according to certain embodiments of this disclosure;

FIGS. 11A-11B illustrate logical boundaries of components of the system of FIG. 1 and associated custody of private keys, according to certain embodiments of this disclosure;

FIG. 12 illustrates an example record that may be stored in distributed ledger, according to certain embodiments of this disclosure;

FIG. 13 illustrates an example method for forming a group, according to certain embodiments of this disclosure;

FIG. 14 illustrates an example method for providing a group benefit using a self-executing agreement and distributed ledger, according to certain embodiments of this disclosure;

FIG. 15 illustrates an example method for adding a user (new group member) to a group, according to certain embodiments of this disclosure;

FIG. 16 illustrates an example method for providing a group benefit using a self-executing agreement and distributed ledger, according to certain embodiments of this disclosure;

FIG. 17 illustrates an example method for a group member exiting a group, according to certain embodiments of this disclosure;

FIG. 18 illustrates an example method for providing a group benefit using a self-executing agreement and distributed ledger, according to certain embodiments of this disclosure; and

FIG. 19 illustrates a block diagram of an example processing system, according to certain embodiments of this disclosure.

### DETAILED DESCRIPTION OF ILLUSTRATIVE EMBODIMENTS

Individuals may form groups for a variety of reasons. For example, individuals may form a group to pool resources, such as funds, that can be used by members of the group when an agreed-upon event occurs. In a particular example, individuals may form a group to provide group benefit coverage for certain types of benefits or other purposes. Furthermore, the group may desire to create a record of the handling of the group and the group's resources, such as by creating a publicly-available and immutable record. As just a few examples of the types of benefits for which members of a group may desire to pool resources, such benefits may include paid sick leave, health care coverage, or workers' compensation benefits. This disclosure contemplates any suitable types of benefits.

Taking paid sick leave as an example, many countries or other jurisdictions do not mandate that employers pay employees when those employees take time off from work while sick, a benefit otherwise known as paid sick leave. The federal government of the United States of America, for example, currently does not mandate that employers provide paid sick leave, and instead leaves to the states (or a more local governing body) the decision of whether to mandate that employers provide paid sick leave. While some states currently require that some or all employers provide paid sick leave, most states currently do not. Furthermore, even in certain states that have passed laws to mandate that some or all employers provide paid sick leave, businesses have filed lawsuits attempting to have those laws voided or otherwise overturned.

Arguments abound for whether or not providing paid sick leave is advisable economically. Proponents of mandatory paid sick leave argue that failing to provide paid sick leave is more costly to employers and the overall economy because it encourages sick workers to work rather than stay home and recover, delaying the sick employee's recovery and exposing other workers to the illness. Opponents of mandatory paid sick leave argue that requiring businesses, and especially small businesses, to assume the full cost of providing paid sick leave would be overly burdensome and perhaps not financially feasible.

Nonetheless, the failure to provide paid sick leave likely encourages sick employees to appear for work despite their illness. This is particularly true for workers who live paycheck-to-paycheck, often working a job that does not offer paid sick leave. Due to the contagious nature of many illnesses, sick employees at the workplace can lead to other sick employees, presenting the other employees the same dilemma of whether to stay home or come to work sick. Even if the sick employee(s) does show up for work, that employee probably is operating at substantially less than full efficiency, which might or might not be tolerable for a single employee (though it may slow recovery time) but likely is problematic if spread to multiple employees. These negative consequences can be magnified in the midst of a pandemic, such as the ongoing (at the time of filing) global pandemic related to coronavirus disease 2019 (COVID-19), particularly in the face of a highly communicable illness/disease.

While the U.S. federal government does not mandate paid sick leave, the Employee Retirement Income Security Act of 1974 (ERISA), a federal statute that has been found to preempt any state or local laws, includes certain provisions that make it difficult, if not impossible, for employers to implement plans that allow employees to share or bear the cost of providing paid sick leave using conventional techniques. ERISA and/or other applicable laws or regulations do not permit an employer to withhold funds from an employee's paycheck, deposit those funds in an employee benefit plan, and then pay a benefit in an employee's paycheck. For example, under ERISA, the combination of automatic enrollment in the employee benefit plan and payroll deductions may run afoul of ERISA. As another example, under ERISA, one-hundred percent of the premiums must be used to pay benefit claims, and the employer or its affiliate cannot maintain the employee benefit plan funds.

According to certain embodiments of this disclosure, a group of individuals may wish to provide group coverage to one another to provide a financial payment to a group member who submits through a trusted intermediary (e.g., an employer, union, health care provider, or other appropriate trusted intermediary) a benefit claim (e.g., payment for days taken off while sick). Embodiments of this disclosure provide a mechanism implemented using a distributed ledger, or blockchain, that can help businesses, including even small businesses, make paid sick leave benefits available to their workers in a way that implicates and complies with ERISA.

In certain embodiments, employees in a group of employees (which could be all or a portion of the employees of a company) agree to have a portion of their wages (e.g., paycheck) withheld and deposited into respective accumulating cryptocurrency funds that are employee specific. For each employee that is a group member, the employer may withhold the agreed portion of the employee's wages, convert the withheld amount into cryptocurrency, and deposit the converted amount in cryptocurrency to a cryptocurrency address specific to the employee and for which the employee holds a private key on a user device, such as a smartphone, of the employee. In certain embodiments, employees interact with the system using an application stored on the user device, such as a mobile application on the user's smartphone, and this application automatically handles aspects of this disclosure while also hiding the private key from the user.

An employee who is a group member may submit a benefit claim request to request payment for time off while sick. The trusted intermediary (e.g., the employer) may approve the benefit claim request and send an approval message to the user devices of the employees and to a computer-implemented hub, or smart contract, operating on a distributed ledger system (e.g., blockchain). The user devices, using their respective hidden private key, may then sign respective transactions to cause an appropriate portion of the funds accumulating in their respective withholding cryptocurrency addresses to be transferred, via the computer-implemented hub, to a benefit cryptocurrency address of the benefit award recipient. The computer-implemented hub may enforce certain rules and restrictions and if appropriate, transfer the funds received from the withholding cryptocurrency addresses of the employees to the benefit cryptocurrency address of the benefit award recipient.

Each user device also may store a private key for a respective benefit cryptocurrency address such that if that user is the benefit award recipient, the user device of that user is able to conduct transactions relating to that user's benefit cryptocurrency address. The group administrator (e.g., employer) may then pay the benefit award recipient an appropriate amount for the paid sick leave in a fiat currency, such as in the benefit award recipient's next paycheck. When the benefit award recipient confirms, using the application on the benefit award recipient's user device for example, that payment (in the fiat currency) for the paid sick leave was received, the application on the benefit award recipient's user device signs a transaction using the private key for the employee's benefit cryptocurrency address to cause the funds at the benefit cryptocurrency address to be transferred to a reimbursement cryptocurrency address of the group administrator (e.g., employer), reimbursing the employer for at least a portion of the benefit paid to the benefit award recipient. The benefit cryptocurrency address of the benefit award recipient may return to a zero balance at this point. Furthermore, in certain embodiments, the ability to crowdfund benefits using funds that are held and controlled by user devices and without a central hub storing reserve funds for crowdfunding those benefits may make the system a zero-reserve system.

Embodiments of this disclosure provide an escrow functionality rooted in technology, including both distributed ledger technology and self-executing agreement technology. Furthermore, certain embodiments deploy and make use of technology to provide paid sick leave or other benefits in a way that is not possible with conventional solutions. For example, while an employer withholding funds from an employee's wages and depositing those funds in an employee benefit plan may violate the laws of certain jurisdictions, embodiments of this disclosure convert the withheld amounts into cryptocurrency and deposit the converted amounts to a withholding cryptocurrency address of the employee and for which the employee possesses the private key (e.g., on a user device of the employee). Thus, in certain embodiments, neither the employer nor another third party possesses the withheld funds.

As another example, using the private key for the withholding cryptocurrency address that is in the employee's possession, the employee may request that remaining funds at the withholding cryptocurrency address be deposited in an exit cryptocurrency fund of the employee, meaning that the employee can leave with a remaining balance of the withholding cryptocurrency fund (with, in certain embodiments, certain limitations or additional hurdles). This withdrawal typically would occur when the employee is no longer employed by the employer but could be for any reason and results in the employee leaving the group.

The withholding cryptocurrency address and associated rules (e.g., enforced by a user device application and/or a computer-implemented hub) may act as an IOU lock contract escrow that allows funds deposited to the withholding cryptocurrency address to remain on the user device in the group member's possession because the user device of the group member stores the private key for the withholding cryptocurrency address. In certain embodiments, the rules enforced by the user device application and/or the computer-implemented hub prevent the group member from spending the funds, which are designed to pay future benefit awards, until the group member leaves the group, which may force the group member to save for future benefit awards as long as the group member remains a group member.

Certain embodiments include a fraud prevention mechanism by which the trusted intermediary (e.g., the group administrator) who approves benefit claim requests provides a surety bond that can be lost if a dispute is filed against the intermediary. The surety bond may provide an increased level of trust in the intermediary, as it provides a strong disincentive to approving invalid benefit claims. In certain embodiments, dispute resolution could be handled by a third-party ombudsman or other form of dispute resolution.

Certain embodiments use an IOU pledge, which is signed or otherwise agreed to by each group member, and includes a promise to pay all approved benefit claims as long as the group member remains in the group. If funds are available, this may ensure that any benefit claims that are approved by the group administrator (e.g., the employer) are at least partially paid by the group members. In certain embodiments, one-hundred percent of the premiums paid by a group member to the group member's withholding cryptocurrency address are used to pay benefit awards and, if the premiums are not used to pay benefit awards, the remaining premiums are available to refund to the group member when the group member leaves the group.

In certain embodiments, the group members are employees of an employer, the benefit is a paid sick leave benefit, the contributions are amounts withheld from the employees' wages, and the trusted intermediary is the employer, a union, a health care provider, or other appropriate trusted intermediary. This mechanism may reduce or eliminate the cost to the employer or other entity of providing paid sick leave while possibly also being compliant with legal restrictions, such as those imposed by ERISA. For example, certain embodiments enforce mandatory enrollment in the paid sick leave program and use automatic payroll deduction to gather premiums, all while allowing the employees to maintain custody of their premiums. These features may render ERISA the applicable law, and the system may comply with that law. Furthermore, because ERISA may preempt state and local laws, individual determinations of whether the system complies with those state and local laws may be unnecessary.

Furthermore, because the employer does not possess the private key for the withholding cryptocurrency addresses, the employer lacks the ability to spend the funds at the withholding cryptocurrency addresses of the group members (e.g., employees), except in ways previously agreed to by the group members.

In certain embodiments, a record of approved benefit claim requests and associated payments is created using a self-executing agreement (e.g., a smart contract), a distributed ledger system (e.g., a blockchain system), and cryptocurrency. The self-executing agreement includes computer instructions that when executed by a node in the distributed ledger system operate one or more escrow accounts that receive payments, store payments, and release payments, all under conditions set by the computer instructions. Furthermore, because the self-executing agreement operates in the distributed ledger system (e.g., blockchain environment), the self-executing agreement uses cryptocurrency for executing transactions and stores those transactions on the distributed ledger in a way that is available to the public. This creates an essentially immutable but transparent record of the transactions executed by the self-executing agreement that is stored in a distributed database and verified by the nodes in the distributed ledger system. Additionally, using self-executing agreement and associate cryptocurrency managed in the distributed ledger system reduces or eliminates the need for a third party to manage the funds/escrow(s) of the group. Furthermore, this immutable and publicly available record may be useful to the employer and/or a taxing agency to audit paid sick leave or other benefit payments, if appropriate.

Furthermore, using self-executing agreements, or smart contracts, to allow groups to corporately hold and distribute funds may address certain custody issues associated with providing benefits. For example, self-executing agreements existing in a distributed ledger, or blockchain, may be at little or no risk of regulatory interference because such self-executing agreements relieve group members of relying on third parties to hold funds. In certain embodiments, rather than being held by a bank, insurer, or third-party intermediary, in their cryptocurrency form, funds are held on the blockchain, which facilitates implementing legally- and regulatorily-compliant agreements to pay paid sick leave benefit claims.

Certain embodiments implement a zero-reserve architecture in which a computer-implemented hub holds zero reserves for paying benefit awards. Certain embodiments provide a mechanism for joint custody that is implemented using a suitable combination of software stored on user devices, software and/or hardware associated with a group administrator, cryptocurrency, and a distributed ledger system, and that may be more viable in the context of certain restrictive regulations. In certain embodiments, through this joint custody mechanism, the employer or other group administrator does not pool employee contributions (e.g., withheld amounts from employee wages) until a time for crowdfunding a particular benefit award using the employee contributions occurs. Certain embodiments allow benefit awards to be crowdfunded as needed at least in part by enforcing mandatory payment of a crowdfunded request through the technological mechanisms that implement the system. In certain embodiments, the benefit award recipient holding a benefit claim award does not create a third-party custody liability at least because the claim award recipient has ownership rights to the benefit claim award. In certain embodiments, the group administrator (e.g., the employer) holding fiat currency to pay benefit claim awards does not create a third-party custody liability at least because the benefit claim award recipient (e.g., an employee) does not have an ownership claim to these funds. In this way, a zero-reserve architecture may reduce or eliminate problems associated with third-party custody liability issues that may conflict with certain regulatory rules.

Embodiments, thus, exploit technical characteristics of software applications stored on user devices, software and/or hardware implemented at a group management system, and distributed ledgers and self-executing agreements to provide features that are not possible with other types of systems.

Although this disclosure primarily describes an embodiment in which the benefit is paid sick leave, this disclosure contemplates funds being collected for any suitable type of benefits, such as health coverage benefits or workers' compensation benefits. This disclosure can be implemented in other suitable embodiments. For example, this disclosure contemplates embodiments for crowdfunding any suitable benefit in which amounts are held to fund a future benefit, and a trusted intermediary is used to determine when those funds (or a portion thereof) are awarded to a beneficiary. For example, this disclosure may be used in the context of any system in which one or snore deposit cryptocurrency payments, in cryptocurrency, in a fund (e.g., including an accumulating fund) for dispensation to a party (e.g., potentially but not necessarily limited to one of the one or more users) at the discretion of a trusted intermediary, where the one or more users hold the key to releasing the funds to the party.

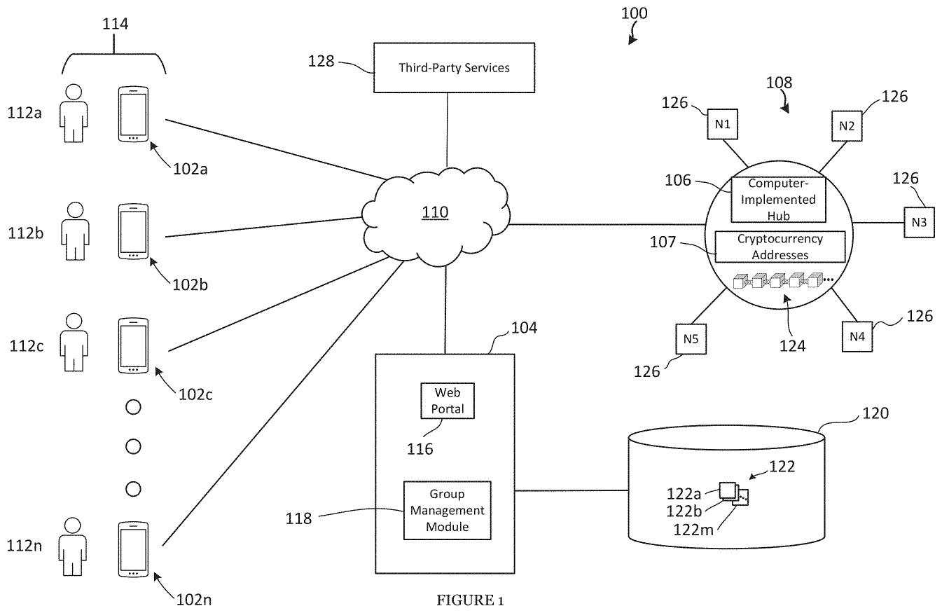

FIG. 1 illustrates a block diagram of an example system 100 for providing a group benefit using a self-executing agreement and distributed ledger, according to certain embodiments of this disclosure. In this example, system 100 includes user devices 102 (user devices 102a through 102n), group management processing system 104, and a computer-implemented hub 106 implemented on a distributed ledger system 108, all of which are configured to communicate via network 110. Although this particular implementation of system 100 is illustrated and described, this disclosure contemplates system 100 being implemented in any suitable manner, according to particular needs.

In general, users of user devices 102 interact with group management processing system 104 to form and manage a group for implementing some type of group benefit coverage. Users of user devices 102 also interact with computer-implemented hub 106 and distributed ledger system 108 to implement a financial escrow (e.g., individual funds for each of the group members, such as withholding amounts from the group members' paychecks) for providing the group's benefit coverage (e.g., using aggregated contributions from each group member's individual fund). The financial escrow may operate according to a set of rules and software instructions defined at least in part in computer-implemented hub 106 and managed by an entity associated with group management processing system 104 and in a computer application stored on user devices 102 of group members. Portions of system 100 implemented using distributed ledger system 108 may create a digital, publicly-available, and non-repudiable record of the benefit claims (e.g., claims for paid sick leave) and the group's handling of those benefit claims (payments from the aggregate funds of the group for paid sick leave).

User devices 102 may include any suitable computing devices, such as smartphones, tablets, desktop computers, laptop computers, wearable devices, or any other suitable web-enabled computing devices, in any suitable combination. In such embodiments, user devices 102 may include one or more memory devices and one or more processors configured to execute instructions stored on the one or more memory devices. Thus, user devices 102 may execute the computer instructions to implement the various operations described herein in reference to user devices 102. User devices 102 may be configured to communicate with one or more of group management processing system 104 and distributed ledger system 108, via network 110 for example.

User devices 102 have corresponding users 112 (users 112a through 112n). In the illustrated example, users 112 are members of a group 114 (group members) formed to provide group benefit coverage.

Group 114 is a collection of individuals (users 112) who provide each other group benefit coverage. Throughout this disclosure, group 114 also may be referred to as a community and users 112 also may be referred to as group members. Group 114 may include any suitable number of group members that is appropriate for a particular implementation. In certain embodiments, users 112 of group 114 are co-employees of an employer.

Users 112 of user devices 102 also have one or more cryptocurrency addresses 107 established with distributed ledger system 108. For example, each user 112 may have one or more corresponding cryptocurrency addresses 107 established with distributed ledger system 108. In certain embodiments, each user 112 has at least three cryptocurrency addresses 107 for use in conjunction with the features of system 100. Corresponding private keys for signing transactions associated with the one or more cryptocurrency addresses 107 of a user 112 may be stored on (or otherwise accessible to) the user device(s) 102 for that user 112. Example purposes of these cryptocurrency addresses 107 and associated private keys are described in greater detail below.

According to the terms of a group charter (described below), group members (e.g., users 112) of group 114 agree to pay one or more premiums into a premiums escrow implemented using distributed ledger system 108. In certain embodiments, group members of group 114 agree to pay premiums into the premiums escrow at suitable intervals. In an example in which group members of group 114 are co-employees, the premiums may be an amount withheld from the group member's paycheck, such as from every paycheck (e.g., twice per month) or every other paycheck (e.g., once per month). An employer (which might or might not be the administrator of group management processing system 104) may withhold an amount from the wages (e.g., from the paycheck) of the users 112, convert the withheld amount to a cryptocurrency, and deposit the converted withheld amount (in cryptocurrency) in respective cryptocurrency addresses 107 of users 112. Although this disclosure contemplates using any suitable type of cryptocurrency, in certain embodiments, the cryptocurrency is a so-called stablecoin (DAI, Tether, Diem, USDCoin, or any other suitable type of stablecoin) the value of which is tied to a fiat currency (e.g., the U.S. dollar).

A user 112 may submit a benefit claim request (e.g., to group management processing system 104) to request a benefit claim payment from the aggregate funds of users 112 for the type of benefit supported by system 100 (e.g., paid time off for sick leave). At any time (possibly with certain restrictions), a user 112 may request a refund of a remaining balance of the accumulating withholding amounts paid into the cryptocurrency address 107 of the user 112 that holds the payments withheld from the user's wages.

Group management processing system 104 may include one or more computer systems operating at one or more locations. In certain embodiments, group management processing system 104 may include one or more servers and/or or other computing devices able to communicate with user devices 102 and distributed ledger system 108 via network 110. In certain embodiments, group management processing system 104 may include one or more servers or other computing devices and/or one or more user terminals or other user devices able to communicate with user devices 102 and/or distributed ledger system 108 via network 110. In certain embodiments, each computer system of group management processing system 104 may include one or more memory devices and one or more processors configured to execute instructions stored in the one or more memory devices. In certain embodiments, group management processing system 104 may include multiple computing elements including, for example, multiple central processing units (CPUs) or multiple graphical processing units (GPUs).

Group management processing system 104 generally serves in part as an intermediary to facilitate the establishment of group 114 by users 112, the setup and configuration of user devices 102 to interact within system 100 to provide the group benefit coverage, and the management of those groups 114. Group management processing system 104 also may facilitate interaction by user devices 102 (with or without input by users 112) with computer-implemented hub 106 and distributed ledger system 108, if appropriate.

Group management processing system 104 may be operated by a trusted intermediary, such as an employer of users 112 of group 114, a healthcare provider, a union, or any other entity suitable to be a trusted intermediary for the benefit provided by system 100. For ease of reference throughout this disclosure, the entity operating group management processing system 104 may be referred to generally as the group administrator.

Group management processing system 104 may be accessible to appropriate personnel associated with the trusted intermediary, and generally may be referred to as administrators. For example, in the case of the trusted intermediary being an employer of group 114, the administrators may include personnel with the human resources (HR) department of the employer and/or other suitable personnel within the employer. For purposes of this disclosure, it should be understood that group administrator, employer, trusted intermediary, entity managing group management processing system 104, and the like may be used interchangeably. Furthermore, it should be understood that the group administrator might or might not be the entity with which users 112 of group 114 have a relationship. For example, an employer of users 112 of group 114 may use a trusted third party to act as the group administrator.

The administrators may have access to login credentials authorizing the administrators to execute certain actions with group management processing system 104. Additionally or alternatively, the administrators may have access to one or more private keys that authorize such administrators to perform transactions using distributed ledger system 108. For example, the administrators may have access to a user device (e.g., a user terminal or other suitable processing device) that stores or otherwise has access to the one or more private keys. Such a user device may include a private key management application, such as a software wallet, for managing access to and use of the private keys. Although this disclosure contemplates using any suitable type of software wallet, example software wallets include METAMASK, MYCRYPTO, TRUSTWALLET, MYETHERWALLET, ARGENT, COINBASE WALLET, GNOSIS SAFE, INSTADAPP, ZERION, and POKETTO. As another example, the administrators may have access to private key management hardware, such as a hardware wallet or other suitable type of private key storage device that may be portable and connectable to other user devices to grant the administrator access to the private keys. Although this disclosure contemplates using any suitable type of hardware wallet, example hardware wallets include LEDGER NANO S, LEDGER NANO X, and TREZOR T.

In certain embodiments, group management processing system 104 includes web portal 116 and group management module 118. Web portal 116 provides an interface to user devices 102 through which a user 112 of a user device 102 can manage aspects of that user's involvement in group 114 and the group benefit coverage provided for group 114.

For example, web portal 116 may provide a user 112 with an interface for establishing an account with group management processing system 104, an account which may be linked to group 114. As another example, web portal 116 may provide a user 112 with a link for downloading to the user device 102 of that user 112 an application (e.g., a mobile application or any other suitable type of application) for interacting with system 100, including for interacting with group management processing system 104 and distributed ledger system 108 (e.g., computer-implemented hub 106 and/or cryptocurrency addresses 107). Additional details related to such an application are described in greater detail below. The link may be a link to a downloadable version of the application stored in association with group management processing system 104 or available from a third-party application distribution platform (an “app store,” such as the APPLE APP STORE, or GOOGLE PLAY). In certain embodiments, some or all of web portal 116 is implemented using JavaScript.

Group management module 118 provides at least certain features accessible to an administrator to manage appropriate portions of system 100. In certain embodiments, group management module 118 provides the logic and associated computer code underlying the features made available through web portal 116. Group management module 118 may communicate with distributed ledger system 108 (including computer-implemented hub 106), where appropriate. For example, group management module 118 may manage computer-implemented hub 106, which as described below enforces certain rules for system 100, including configuring computer-implemented hub 106, notifying computer-implemented hub 106 of the group members of group 114 and any associated changes to the group membership (remove group members or add group members), notifying computer-implemented hub 106 of approved benefit claims, and performing other suitable operations with respect to computer-implemented hub 106. As another example, group management module 118 may interact with user devices 102 to configure (and potentially install) the application stored on user devices 102 for interacting with system 100, notify user devices 102 of the group members of group 114 and any associated changes to the group membership (remove group members or add group members), notify user devices 102 of approved benefit claims, and perform other suitable operations with respect to user devices 102.

Web portal 116 and/or group management module 118 may be one or more stand-alone applications or may be integrated into another application, such as an application that may be used to provide HR features to employees of a company as just one example.

The group administrator also may have one or more cryptocurrency addresses 107 established with distributed ledger system 108. In certain embodiments, the group administrator has at least one cryptocurrency address for storing funds in cryptocurrency and an associated private key. Furthermore, group management processing system 104 may store one or more private keys for interacting with computer-implemented hub 106 or other secure mechanisms (e.g., self-executing agreements, such as smart contracts) operating with distributed ledger system 108. As described above, in certain embodiments, one or more administrators may have access to a user device (e.g., a user terminal or other suitable processing device) that stores or otherwise has access to the one or more private keys using a private key management application (e.g., a software wallet) or private key management hardware (e.g., a hardware wallet). This disclosure, however, contemplates the one or more private keys used by group management processing system 104 being stored in any suitable manner that is acceptable for a given implementation.

Example purposes of these cryptocurrency addresses 107 and associated private keys are described in greater detail below.

Group management processing system 104 may have access to a storage module 120, and may store group information 122 in storage module 120. Although a single group 114 is illustrated, the group administrator may be able to establish multiple groups. Thus, in certain embodiments, group management processing system 104 may be used to manage multiple groups, each of which may have the same or different purpose behind providing group benefit coverage and which might or might not have overlapping group members. Group information 122 may include multiple instances of group information (e.g., group information 122a through 122m) and may be organized by group, such that the group information 122 for a particular group is accessible only to members of the particular group.

Storage module 120 may take the form of volatile or non-volatile memory including, without limitation, magnetic media, optical media, RAM, ROM, removable media, or any other suitable memory component. In certain embodiments, a portion of all of storage module 120 may include a database, such as one or more structured query language (SQL) servers or relational databases. Storage module 120 may store a variety of information that may be used by group management processing system 104, including group information 122.

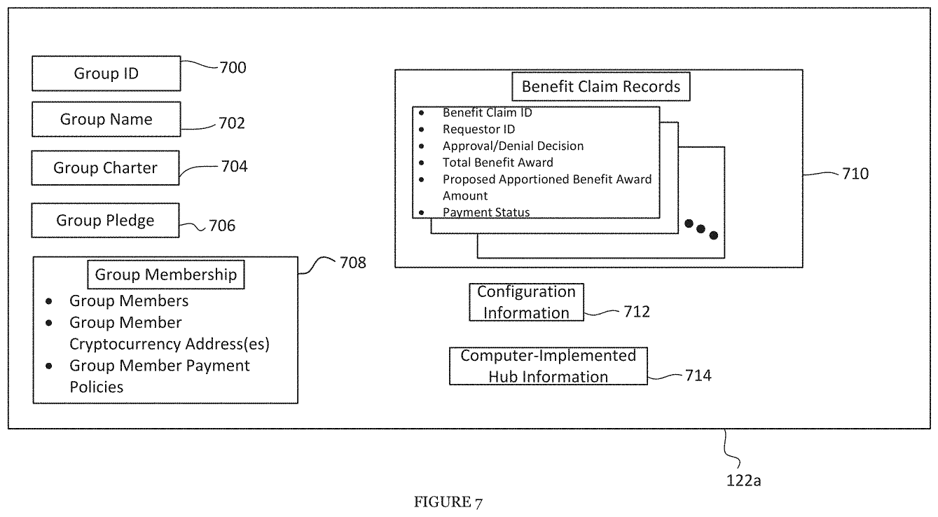

Group information 122 is described in greater detail below with reference to FIG. 7. As an introduction, however, group information 122 may include (taking group 114 as an example) a group ID for group 114, a group name for group 114, a group charter for group 114, a group pledge for group 114, group membership information of group 114, benefit claim records for group 114, configuration information for group 114, computer-implemented hub information, and any other suitable information.

As described above, system 100 may include a distributed ledger system 108. Distributed ledger system 108 may be implemented as a decentralized blockchain platform. Distributed ledger system 108 provides distributed storage of data using a distributed ledger 124. In certain embodiments, distributed ledger 124 is a blockchain. Distributed ledger system 108 includes nodes 126 (N1, N2, N3, N4, N5, etc.) that interact in a peer-to-peer network, each storing a copy of distributed ledger 124.

The distributed ledger architecture described herein may be implemented in a computer or network of computers (e.g., nodes 126) having one or more processors executing instructions of software programs that are stored in one or more computer-readable storage. Nodes 126 may be connected through a public network, such as through the internet, in some embodiments. In other embodiments, nodes 126 may be connected through a private network, such as an internal company network, e.g., an intranet. In specific embodiments, nodes 126 are connected through a local area network (LAN), wide area network (WAN), or another suitable type of network. Although a particular number of nodes 126 are illustrated, distributed ledger system 108 may include any suitable number of nodes 126. In particular embodiments, distributed ledger system 108 includes 100 or more nodes 126.

This disclosure contemplates system 100 including any suitable number of distributed ledger systems 108. For example, one or more distributed ledger systems 108 may be used for storing a record of ownership and transactions involving cryptocurrency (e.g., cryptocurrency addresses 107 may be located on these distributed ledger systems 108) and one or more distributed ledger systems 108 may be used for storing and executing computer-implemented hub 106 and/or any self-executing agreements (e.g., smart contracts) used in system 100.

The group benefit policy for group 114 may be governed at least partially by a computer-implemented hub 106 (e.g., a self-executing agreement, such as so-called a smart contract) operating on distributed ledger system 108 (operating on blockchain technology). For example, as described above, computer-implemented hub 106 may implement one or more financial escrows for group 114. Computer-implemented hub 106 may be implemented on multiple computing nodes (nodes 126) in a computer network. Nodes 126 may collaborate in a decentralized manner to operate a consensus network using blockchain or another distributed ledger technology. For example, distributed ledger system 108 uses a public or global ledger (distributed ledger 124) to confirm each transaction and operation on the global ledger using consensus. For example, the ETHEREUM platform uses a global ledger or blockchain that hosts and executes a Turing complete instruction set.

In certain embodiments, computer-implemented hub 106 operates on the ETHEREUM blockchain which executes cryptocurrency transactions, known as ether powered transactions, as resource transactions and implements the software instructions of computer-implemented hub 106 submitted to the ETHEREUM blockchain. Computer-implemented hub 106 may operate on another type of decentralized computing system.

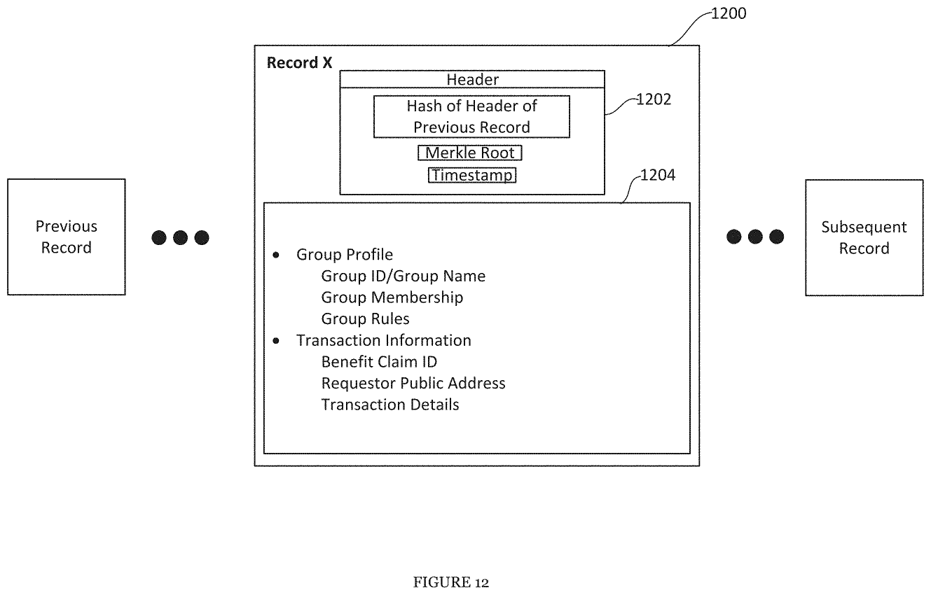

Distributed ledger 124 is an expanding list of records (blocks) that are linked using some form of cryptography. In distributed ledger system 108, a copy of distributed ledger 124 is stored on multiple (and possibly all) nodes 126 of distributed ledger system 108. Each record (block) in distributed ledger 124 includes a header and data for the current block, along with a hash of the header of the previous block in distributed ledger 124. An example record in the context of system 100 is described in greater detail below with reference to FIG. 12. In certain embodiments, distributed ledger system 108 creates an immutable record of transactions (distributed ledger 124) that is stored in multiple (and possibly all) nodes 126 of distributed ledger system 108.

Computer-implemented hub 106, which also may be referred to as a self-executing agreement or “smart contract,” provides a set of instructions (e.g., software code) that perform certain actions based on the occurrence of certain events. Distributed ledger system 108 supports the use of public key cryptography, which enables users to sign transactions using the user's unique, specially generated cryptographic codes. A public key, which is a string of characters, is an address on the blockchain. A user 112 stores a private key (e.g., on user device 102), which operates like a pen generating unforgeable signatures that can later be verified by software running on distributed ledger system 108 (e.g., blockchain software) as authorizing transactions to move funds (e.g., cryptocurrency or other digital assets) from an associated public key address, which is known to distributed ledger system 108, including computer-implemented hub 106. The public, however, including other users 112 and those other than users 112, may generally view published versions of distributed ledger 124. Transactions signed with private keys in a public key infrastructure have the property of being non-repudiable.

Computer-implemented hub 106 implements the logic of the group benefit policy implemented by group 114. Computer-implemented hub 106 may be implemented as software code that is stored on multiple nodes 126 (and possibly all nodes 126) of distributed ledger system 108 and executed by the nodes 126 on which it is stored so that transactions are executed by each of those nodes 126, verified by each of those nodes 126, and stored on the version of distributed ledger 124 maintained by each of those nodes 126.

Computer-implemented hub 106 is stored and executed in a distributed ledger, such as a block chain. Each transaction associated with computer-implemented hub 106 is stored and verified by each of multiple nodes 126 in distributed ledger system 108 (e.g., a peer-to-peer network) that supports the distributed ledger 124. Nodes 126 verify each transaction. The use of computer-implemented hub 106 and distributed ledger 124 provides a verifiable public record that is difficult or impossible to be repudiated by the parties to computer-implemented hub 106. Distributed ledger 124 provides a distributed public record of the transactions associated with computer-implemented hub 106. Thus, this system provides both non-repudiation and transparency.

Computer-implemented hub 106 and distributed ledger system 108 may implement a self-executing agreement (e.g., smart contract) escrow for implementing the group policy desired by group 114. These financial escrows exist on distribute ledger 124 (e.g., blockchain) such as ETHEREUM and are enforced by self-executing agreement code. A smart contract is a self-executing agreement that establishes the terms of an agreement between members of a group that wish to provide each other group coverage for a certain category of incident claim. This agreement and the associated financial obligations of the participants are written into lines of code. This code is maintained within a distributed database (e.g., a decentralized blockchain network) and executed when transactions are sent across the decentralized blockchain network.

Computer-implemented hub 106 may receive configuration information from group management processing system 104. For example, the configuration information may include information regarding group 114. The information may include the group ID, an identification of the group members (which, in certain embodiments, are addresses of users 112 on distributed ledger system 108), a number of group members, information from a group charter for group 114, and any other suitable information that may be used by computer-implemented hub 106 to implement the functions computer-implemented hub 106 is designed to provide.

In certain embodiments, system 100 includes one or more third-party services 128. Third-party services 128 may include, for example, one or more services associated with one or more banks or other financial institutions, one or more surety bond providers, or any other suitable third-party services. Users 112 and the group administrator may interact with third-party services 128 for a variety of purposes. For example, users 112 and the group administrator may interact with one or more banks or other financial institutions to facilitate portions of the operations of system 100 that occur in fiat currency. As another example, the group administrator may interact with a surety bond provider to establish a surety bond for providing the benefit associated with system 100. In the context of benefits provided in association with the employment of users 112 (e.g., paid sick leave, health benefits, workers' compensation benefits), it may be appropriate due to legal obligations or otherwise for the group administrator to obtain a surety bond to ensure that users 112 (e.g., group members) that users 112 are reimbursed if the group administrator approves invalid benefit claim requests (whether through fraud, mistake, or otherwise).

Network 110 facilitates wireless or wireline communication. Network 110 may communicate, for example, IP packets, Frame Relay frames, Asynchronous Transfer Mode (ATM) cells, voice, video, data, and other suitable information between network addresses. Network 110 may include one or more LANs, radio access networks (RANs), metropolitan area networks (MANS), WANs, mobile networks (e.g., using WiMax (802.16), WiFi (802.11), 3G, 4G, 5G, or any other suitable wireless technologies in any suitable combination), all or a portion of the global computer network known as the Internet, and/or any other communication system or systems at one or more locations, any of which may be any suitable combination of wireless and wireline.

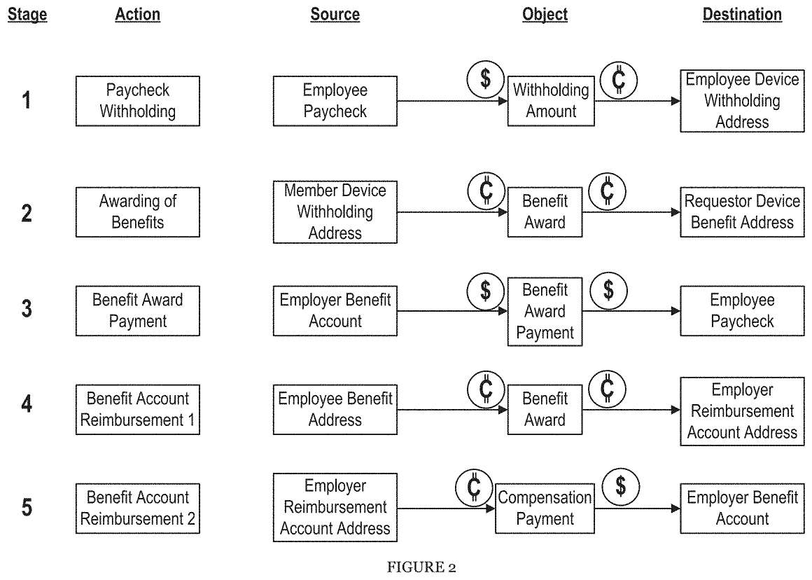

FIG. 2 illustrates an overview of an example process for providing a group benefit using a self-executing agreement and distributed ledger, according to certain embodiments of this disclosure. In the particular example of FIG. 2, the group members (users 112) are employees, and the source of the funds for the group benefit is wages, or paycheck, withholding from employees' wages. Additionally, each employee has at least two cryptocurrency addresses 107 (referred to as the withholding cryptocurrency address and the benefit cryptocurrency address), with the corresponding private keys for those cryptocurrency addresses 107 being stored on an associated user device 102 of the employee (e.g., user 112). The employer also has at least one cryptocurrency address 107 (referred to as the employer reimbursement cryptocurrency address) and associated private key possessed by the employer. Although not described in relation to FIG. 2, the employee also may have an associated exit cryptocurrency address and associated private key that may be used to obtain a refund of a remaining balance of the withholding cryptocurrency address and leave the group. Furthermore, although described as an employer, this disclosure contemplates any other suitable entity performing the operations described in relation to the employer.

At stage 1, an amount in fiat currency (e.g., U.S. dollars) is withheld from an employee's paycheck. The withholding amount is converted from the fiat currency (e.g., U.S. dollars, as shown in FIG. 2 using a generic dollar symbol) to a suitable cryptocurrency (as shown in FIG. 2 using a generic cryptocurrency symbol). Although this disclosure contemplates using any suitable type of cryptocurrency, in certain embodiments, the cryptocurrency is a so-called stablecoin (DAI, Tether, Diem, USDCoin, or any other suitable type of stablecoin) the value of which is tied to the fiat currency from which the cryptocurrency is being converted (e.g., the U.S. dollar). Stage 1 may be performed for all group members of group 114. In certain embodiments, stage 1 may be performed on an ongoing basis at suitable intervals. For example, for employees who receive biweekly paychecks, stage 1 may be performed with each paycheck (twice per month), with every other paycheck (once per month), or at another suitable interval. The employer may convert the funds using a suitable cryptocurrency exchange, for example.

The employer may then deposit the withholding amount, as converted into cryptocurrency, to a cryptocurrency address 107 (the withholding cryptocurrency address) for the employee. For example, group management module 118 may access group information 122 to determine the withholding cryptocurrency address of an employee (along with the suitable withholding amount, which may be the same amount or a different amount for different employees, depending on the implementation), and deposited the withheld amount, after conversion to cryptocurrency, to the determined withholding cryptocurrency address of the employee.

In operation of an example embodiment of system 100 shown in FIG. 1, an administrator of group management processing system 104 (e.g., an employer or other suitable entity) may cause an amount to be withheld from an employee's paycheck according to the terms specified in group information 122. This withholding capability might be built into group management module 118 or other suitable software (e.g., HR or payroll software), if desired. Group management processing system 104 then may interact with a cryptocurrency exchange to convert the withheld amount, which is in a fiat currency, into a cryptocurrency. Group management processing system 104 facilitates depositing the withheld amount to a withholding cryptocurrency address 107 of the employee. For example, group management module 118 may access group information 122, determine a withholding cryptocurrency address 107 of the employee, and deposit the withheld amount, as converted into cryptocurrency, to the determined withholding cryptocurrency address 107 of the employee as a premium payment. These operations may be performed for each group member of group 114 (e.g., each user 112).

Some or all of these operations may be automated such that an administrator of group management processing system 104 performs little to no operations after an initial setup.

Stage 2 includes awarding of benefits (e.g., a paid sick leave benefit) to group members (e.g., users 112). After a benefit claim request is approved for a group member who submitted a benefit claim request, also referred to as the requesting group member (e.g., user 112a), an amount in cryptocurrency is transferred from the respective withholding cryptocurrency addresses of the group members to a benefit cryptocurrency address of the requesting group member (user 112a in this example). For example, some or all of the group members (users 112, including in certain embodiments user 112a), crowdfund the approved benefit claim of user 112 by transferring an appropriate amount in cryptocurrency to the benefit cryptocurrency address of the requesting group member (user 112a in this example). In certain embodiments, all of the group members (users 112, including in certain embodiments user 112a) crowdfund the approved benefit claim of user 112 by transferring an appropriate amount in cryptocurrency to the benefit cryptocurrency address of the requesting group member (user 112a in this example).

In operation of an example embodiment of system 100 shown in FIG. 1, a requesting group member of group 114 (e.g., user 112a) may submit a benefit claim request using user device 102 to group management processing system 104 (e.g., to group management module 118). Additionally or alternatively, in certain embodiments, the requesting group member (e.g., user 112a) may be able to submit the benefit claim request via web portal 118. The benefit claim request may include an identifier of the requesting group member, details of the benefit claim request, and/or any other suitable information. The identifier of the requesting group member may include any suitable information, such as the name or employee number of the requesting group member. The details of the benefit claim request may include, for example, some indication of the quantity of the benefit requested. In an embodiment in which the benefit is for paid sick leave, for example, the details of the benefit claim request may include the number of days/hours for which paid sick leave is requested.

An administrator of group management processing system 104 may evaluate and determine whether to approve the benefit claim request. The administrator may input the decision using group management module 118 (and possibly web portal 116) or in any other suitable manner.

Additionally or alternatively, group management module 118 may be configured to automatically approve all benefit claim requests, leaving the evaluation of those benefit claim requests to rules established in computer-implemented hub 106, or group management module 118 may evaluate benefit claim requests according to certain rules to determine automatically whether to approve the benefit claim requests. Such rules may include, for example, whether the benefit claim requests exceeds certain limits (e.g., a certain number of paid sick days/hours, including potentially, an accumulating number of paid sick days/hours for the requesting group member over an ongoing period, such as the current year of employment), how long the requesting group member has been a member of group 114 and/or how many (or the total amount of) withholding payments the group member has made to his/her corresponding withholding cryptocurrency address 107, and/or any other suitable rules.

In certain embodiments, group management module 118 may determine certain information based on the benefit claim request. For example, group management module 118 may determine a total benefit award amount of the requested benefit (e.g., the total, in fiat currency or cryptocurrency, that would be needed to fulfill the benefit claim request or a portion of the benefit claim request that is approved), a proposed apportioned benefit award amount (e.g., the amount that group management module 118 determines that each group member should pay, as determined, for example, according to the terms of the group charter), or any other suitable information. In certain embodiments, the proposed apportioned benefit award amount is determined simply by dividing the total benefit award amount by the current number of group members such that each group member of group 114 might pay an equal share of the total benefit award amount. This disclosure, however, contemplates any suitable approach to calculating the proposed apportioned benefit award amount, such as an approach in which the proposed contribution of certain group members is weighted more heavily than others (e.g., potentially based on salary, withholding amounts, etc.).

If a benefit claim request is denied, group management module 118 may notify the requesting group member of the denial and potentially provide a reason and/or an opportunity to address any deficiencies of the benefit claim request (if possible). If a benefit claim request is partially approved (e.g., because the requesting group member requested greater benefits than those to which they are entitled), group management module 118 may notify the requesting group member of the partial approval and potentially provide a reason why the full benefit claim request was not approved. In certain embodiments, the approval by group management processing system 104 (including a partial or full approval) causes group management module 118 to communicate an approval notification to user devices 102 and/or computer-implemented hub 106. In addition to simply notifying the receiving component of the approval, the notification may include any suitable information.

For example, the approval notification communicated from group management module 118 to user device 102 may include a claim ID and/or a benefit award amount (e.g., a proposed apportioned benefit award amount and/or a total benefit award amount). The claim ID may be a number or other identifier that can be used by components of system 100 to correlate and track processing of the approved benefit claim request. The total benefit award amount may be the full amount of the benefit award approved using group management processing system 104 (e.g., which might or might not be the full amount requested in the benefit claim request). The proposed apportioned benefit award amount may be, on a group member by group member basis, the amount that each group member is proposed to pay of the total benefit award amount. In certain embodiments, each user device receives the proposed apportioned benefit award amount that is allocated to the user 112 of that user device 102, with each user device 102 receiving their respective allocation in the approval notification. The approval notification communicated from group management module 118 to user devices 102 may be signed in a way that user devices 102 can authenticate. This disclosure contemplates the authentication being performed in any suitable manner.

As another example, the approval notification communicated from group management module 118 to computer-implemented hub 106 may include the claim ID, an identifier of the benefit award recipient (e.g., the benefit cryptocurrency address 107 of the approved benefit award recipient) and/or a benefit award amount (e.g., a total benefit award amount). The approval notification communicated from group management module 118 to computer-implemented hub 106 may be signed in a way that computer-implemented hub 106 can authenticate. For example, group management processing system 104 may possess a private key for performing certain operations with respect to computer-implemented hub 106, and the approval notification communicated from group management module 118 to computer-implemented hub 106 may be signed using this private; however, this disclosure contemplates the authentication being performed in any suitable manner.

An application running on user device 102 may receive the approval notification from group management module 118. In response to the approval notification, the application running on user device 102 may cause the application to initiate a transfer, via computer-implemented hub 106, of a cryptocurrency payment from the withholding cryptocurrency address 107 of the user 112 associated with that user device 102 to the benefit cryptocurrency address 107 of the requesting group member who received the benefit award (the benefit award recipient). In certain embodiments, in response to the approval notification, the application on the user device 102 may access the withholding private key on the user device 102 (the private key that corresponds to the withholding cryptocurrency address 107 for that user device 102, and presumably for the user 112 associated with that user device 102), and sign a transaction using that private key to transfer cryptocurrency in a specified amount from the withholding cryptocurrency address 107 for that user device 102 to computer-implemented hub 106 (e.g., to a cryptocurrency address of computer-implemented hub 106). The signed transaction from the application on the user device 102 to computer implemented hub 106 may include the benefit claim ID, a signed transaction that authenticates user device 102 (e.g., using the private key for the withholding cryptocurrency address for that user device 102), the value of the funds being sent (which might or might not match the proposed apportioned benefit award amount), the time the funds were sent, and/or any other suitable information. As described in greater detail below, computer-implemented hub 106 may facilitate further transferring the received cryptocurrency payment to the benefit cryptocurrency address 107 of the benefit award recipient.

In certain embodiments, in response to the approval notification from group management module 118, the application running on user device 102 may determine certain information prior to initiating the above-described transfer. Various examples of these determinations are described below.

As a first example, the information in the approval notification may include a proposed apportioned benefit award amount. In certain embodiments, each user device 102 determines whether the particular proposed apportioned benefit award amount does not exceed a maximum allowable value. To that end, each user device 102 may store a maximum allowable value or information sufficient to determine a maximum allowable value. In a context in which the benefit is for paid sick leave, the maximum allowable value may be captured as one or more of a maximum allowable number of sick days that can be awarded in a single benefit award (e.g., five days) and/or a maximum possible daily benefit rate of any particular group member, for example. In certain embodiments, user devices 102 also are aware of the number of group members in group 114, such as via an initial configuration or updated configuration from group management module 118. In certain embodiments, the application on user device 102 may perform the following calculation: (Maximum allowable number of sick days*the daily benefit amount)/current number of group members=maximum expected daily benefit amount. The application on the user device 102 may then determine whether the proposed apportioned benefit award amount is less than or equal to the maximum expected benefit amount. If the proposed apportioned benefit award amount does not exceed the maximum expected benefit amount, then the application on user device 102 may initiate the transfer of the proposed apportioned benefit award amount (or another amount, as described below).

As another example, the application on user device 102 may access the private key for the withholding cryptocurrency address 107 of the user 112 associated with that user device 102, and use the private key to determine the current balance of withholding cryptocurrency address 107. The application running on user device 102 may determine whether the proposed apportioned benefit award amount exceeds the current balance of the withholding cryptocurrency address 107 for that user device 102. If the proposed apportioned benefit award amount does not exceed the current balance of the withholding cryptocurrency address 107 for that user device 102, then the application on user device 102 may initiate the transfer of the proposed apportioned benefit award amount.

If the proposed apportioned benefit award amount exceeds the current balance of the withholding cryptocurrency address 107 for that user device 102, then the application on user device 102 may initiate the transfer of the remaining balance of the withholding cryptocurrency address 107 for that user device 102 (or of a lesser amount, depending on the implementation). In this scenario, the application on the user device 102 may notify computer-implemented hub 106 (e.g., as part of the signed transaction that includes the transfer request) that the transfer amount authorized by the signed transaction request is less than the proposed apportioned benefit award amount due to insufficient funds being available in the withholding cryptocurrency address 107 of the user device 102.

In certain embodiments, a group member being unable to pay the entire proposed apportioned benefit award amount due to insufficient funds being available in the withholding cryptocurrency address 107 of the user device 102 for that group member is an acceptable outcome. In certain embodiments, reimbursements of paid benefit claim payments to the employer (or other entity associated with group management processing system 104) are not guaranteed to cover the full cost of the benefit award (the total benefit award amount). In such embodiments, reimbursements merely attempt to reduce the total liability of the employer whenever possible. Furthermore, in certain embodiments, after an initial attempt by a user device 102 to send the proposed apportioned benefit award amount, which in this example results in only a partial payment, the group member associated with that user device 102 is not required to make an additional payment for the same benefit claim at a later time.

As described above, computer-implemented hub 106 may facilitate transferring the cryptocurrency payments received by computer-implemented hub 106 from the withholding cryptocurrency address 107 of group members to the benefit cryptocurrency address 107 of the benefit award recipient. In certain embodiments, based on the configuration of computer-implemented hub 106, the approval notification computer-implemented hub 106 receives from group management module 118, and the transactions computer-implemented hub 106 receives from user devices 102, computer-implemented hub 106 may make certain determinations prior to transferring the received funds to the benefit cryptocurrency address 107 of the benefit award recipient.

For example, computer-implemented hub 106 may correlate the transactions (payments) received from user devices 102 to a particular benefit award using the benefit claim ID that is included in the transaction from the user devices 102 and of which computer-implemented hub 106 is aware from the benefit award notification received from group management processing system 106.

As another example, computer-implemented hub 106 may verify that the amount received in a transfer transaction received from a user device 102 meets the following condition: amount received=total benefit award amount/the number of group members in group 114. This particular comparison assumes that the payment that computer-implemented hub 106 expects to receive from each user device 102 is divided equally among the group members of group 114 (expected payment=total benefit award amount/number of group members), which might or might not be the case for a given implementation. Thus, the expected payment for a particular group member could be determined in any suitable manner. In certain embodiments, the expected payment for a particular group member (user device 102) equals the proposed apportioned benefit award amount for that group member (user device 102).

As another example, if the payment received from a user device 102 is less than the proposed apportioned benefit award amount for that user device 102 (which may be treated as the expected received payment), then computer-implemented hub 106 may have received a notification from that user device 102 that this would be the case, or computer-implemented hub 106 may make this determination on its own.

If computer-implemented hub 106 determines that the received payment from a user device 102 differs from the expected received payment, then computer-implemented hub 106 may send a notification to group management module 118. This may allow the employer or other suitable entity to address any deficiency in a suitable manner, if desired. Additionally or alternatively, if computer-implemented hub 106 determines that the received payment from a user device 102 differs from the expected received payment, then computer-implemented hub 106 may reject the incorrect received payment, accept the incorrect received payment (the recorded transaction reflecting the discrepancy), or proceed in another suitable manner.

Other rules that may be enforced by computer-implemented hub 106 may include enforcing a time-lock on transferring funds from the respective withholding cryptocurrency addresses 107 of users 112, enforcing a minimum membership time for the benefit claim requester, and any other suitable rules.

For example, certain embodiments may implement a time lock, which introduces a delay before a transaction signed with the appropriate private key is completed. The time lock may provide an opportunity for the proper owner of the private key (e.g., the user 112 of the user device 102 on which the private key is store) to intervene if that owner did not authorize or expect the transaction (e.g., possibly because the private key was compromised), thereby potentially enhancing security of the system.

As another example, enforcing a minimum membership time for the benefit claim requestor may include requiring that a benefit claim requestor be a group member for a certain amount of time (e.g., at least two weeks) before being eligible to receive payment for a benefit award, which may limit the opportunity for fraud in the system, such as by the group administrator adding and immediately paying awarding a benefit claim to an individual who should not be a group member. While this requirement could be enforced by the group administrator (e.g., when determining whether to approve the benefit claim request), configuring computer-implemented hub 106 to make this determination may provide a greater degree of security because even though the group administrator may be able to modify the rules enforced by computer-implemented hub 106 (to somehow bypass this minimum membership time requirement), such changes would be recorded on distributed ledger 124 and could be subsequently audited.

In certain embodiments, computer-implemented hub 106 pools transactions from user devices 102 (the transactions from user devices 102 of funds from the respective withholding cryptocurrency addresses 107 of user devices 102 to computer-implemented hub 106, which ultimately are destined for the benefit cryptocurrency address 107 of the benefit award recipient) into one or more combined transactions for transferring those payments to the benefit cryptocurrency address 107 of the benefit award recipient. This pooling, or batch processing, approach may reduce fees associated with performing transactions using distributed ledger system 108, by reducing the number of transactions recorded on distributed ledger 124. However, this disclosure contemplates computer-implemented hub 106 individually (and potentially substantially immediately) transferring, for each user device 102, the funds received from the withholding cryptocurrency address 107 for that user device 102 to the benefit cryptocurrency address 107 of the benefit award recipient via computer-implemented hub 106.

In certain embodiments, one or more of the operations described with reference to stage 2 of FIG. 2 are performed automatically by user device 102 (e.g., by the application running on user device 102) such that they are hidden from and do not rely on input from the user 112 of user device 102, or by group management module 118 such that they are hidden from and do not rely on input from an administrator of group management processing system 104. Additionally or alternatively, if appropriate, the user 112 of user device 102 or the administrator of group management processing system 104 may provide certain input or be notified of certain information.

At stage 3, a benefit payment is made by the employer or other suitable entity from a benefit account of the employer to the benefit claim requestor for whom the benefit claim was awarded (e.g., one of the group members, user 112a in this example). The benefit payment is made in a fiat currency, most likely the same as the fiat currency in which the employer typically pays wages to the benefit claim requester. For example, the benefit payment may appear in a next paycheck (e.g., by physical check or direct deposit) of the employee or may be paid at any suitable time.

In operation of an example embodiment of system 100 shown in FIG. 1, group management module 118, another suitable component of group management processing system 104, or the group administrator may interact with third-party services 128 to pay the benefit award amount associated with the group benefit award to the benefit award recipient. This disclosure also contemplates the payment of the benefit award in fiat currency being performed outside the bounds of system 100.

The group administrator may initiate payment for the benefit award in the fiat currency in response to any suitable event. For example, the group administrator may initiate payment in the fiat currency promptly after approval of the benefit claim request, without waiting for any other events within system 100. In certain embodiments, computer-implemented hub 106 sends a notification to group management module 118 upon transfer of the funds received from the withholding cryptocurrency addresses 107 of users 112 to the benefit cryptocurrency address 107 of the benefit award recipient, which may cause the group administrator to initiate payment of the benefit award in fiat currency. In certain embodiments, group management module 118 may request transaction/payment updates from computer-implemented hub 106 or a suitable third-party service for requesting blockchain transaction status.

Stages 4 and 5 represent a reimbursement process for reimbursing the employer for some or all of the benefit payment made to the benefit claim requestor at stage 3.

At stage 4, in a first reimbursement action, the benefit claim requestor (user 112a in this example) transfers the cryptocurrency in the benefit cryptocurrency address 107 of the benefit claim requestor (user 112a in this example) to a reimbursement cryptocurrency address 107 of the employer (labeled Employer Reimbursement Account Address in FIG. 2). If made, this transfer of the cryptocurrency in the benefit cryptocurrency address 107 of the benefit claim requestor (user 112a in this example) to a reimbursement cryptocurrency address 107 of the employer may partially or wholly for the fiat-currency-based benefit payment made by the employer at stage 3. In certain embodiments, this transfer of the cryptocurrency in the benefit cryptocurrency address 107 of the benefit claim requestor (user 112a in this example) to a reimbursement cryptocurrency address 107 of the employer returns the benefit cryptocurrency of the benefit claim requestor (user 112a in this example) to a zero balance.

In operation of an example embodiment of system 100 shown in FIG. 1, at some time subsequent to the approval of the benefit award to the benefit award recipient, the benefit award recipient may be asked to confirm that the payment of the benefit award (e.g., as made at stage 3) was received by the benefit award recipient. The request for confirmation may be made by the application running on the user device 102 of the benefit award recipient, by group management module 118, or in any other suitable manner.

For example, after an approval of a benefit claim request, group management module 118 may cause an approval notification to be sent to the user device 102 of the benefit award recipient (which may be in addition to, or part of, the approval notification sent to all user devices 102 to prompt the transfer of funds from the withholding cryptocurrency address 107 to computer-implemented hub 106) to prompt the benefit award recipient to confirm receipt of the payment of the benefit award. This approval notification may cause the application running on the user device 102 of the benefit award recipient to display a confirmation prompt on a repeated basis until the benefit award recipient confirms receipt of the payment of the benefit award or the situation is otherwise addressed (e.g., by notifying the group manager that payment for the benefit award has not been received after a reasonable amount of time).

As another example, computer-implemented hub 106 may send a notification to the user device 102 of the benefit award recipient upon transfer of the funds received from the withholding cryptocurrency addresses 107 of users 112 to the benefit cryptocurrency address 107 of the benefit award recipient. This notification may cause the application running on the user device 102 of the benefit award recipient to display a confirmation prompt on a repeated basis until the benefit award recipient confirms receipt of the payment of the benefit award or the situation is otherwise addressed (e.g., by notifying the group manager that payment for the benefit award has not been received after a reasonable amount of time).

Although particular techniques are described, this disclosure contemplates any suitable process for group management module 118 receiving confirmation of receipt of the payment of the benefit award by the benefit award recipient.

In response to confirmation that payment of the benefit award has been received by the benefit award recipient, the application on the user device 102 of the benefit award recipient may access a private key, stored on the user device 102, for the benefit cryptocurrency address 107 of the benefit award recipient and send a signed transaction to computer-implemented hub to initiate a transfer of funds at the benefit cryptocurrency address 107 of the benefit award recipient to a reimbursement cryptocurrency address of the group administrator. In certain embodiments, this transfer returns the benefit cryptocurrency address 107 of the benefit award recipient to a zero balance.

At stage 5, in a second reimbursement action, the employer converts the funds in the reimbursement cryptocurrency address 107 of the employer from cryptocurrency (e.g., stablecoin) to a fiat currency (e.g., U.S. dollars), and deposits those funds (as converted into the fiat currency) in a suitable employer account (e.g., using third-party services 128, if appropriate), such as a traditional bank account.

In operation of an example embodiment of system 100 shown in FIG. 1, using a private key of the group administrator (e.g., stored on group management processing system 104), group management module 118, another suitable component of group management processing system 104, or the group administrator may access the cryptocurrency funds deposited to the employer reimbursement cryptocurrency address 107, have those cryptocurrency funds converted to a fiat currency, and deposit the converted funds in the fiat currency to a fiat-currency account of the employer (e.g., with a bank that is part of third-party services 128).

In certain embodiments, system 100 also may allow group members to share paid sick leave with other group members. For example, a first group member may need to take time off for an extended illness, but may have used up all paid sick leave that would be allowable under the rules enforced within system 100. A second group member may have unused paid sick leave and may be willing to transfer some or all of that unused paid sick leave to the first group member. In certain embodiments, system 100 allows the second group member to transfer funds from the withholding cryptocurrency address 107 of the second group member to the benefit cryptocurrency address 107 of the first group member via computer-implemented hub 106. In one example, the group administrator pays, in fiat currency, the transferred paid sick leave amount to the first group member, and the first group member reimburses the group administrator in a manner similar to that described above with reference to stage 4. The group administrator also may update any records stored at group management processing system 104, and potentially computer-implemented hub 106, to reduce the amount of paid sick leave available to the second group member by the amount the second group member transferred to the first group member.

Throughout the process described above with reference to FIG. 2, computer-implemented hub 106 may record certain transactions on distributed ledger 124, which may create a record of those transactions that is publicly available, trustworthy, and immutable, and can be audited at any time.

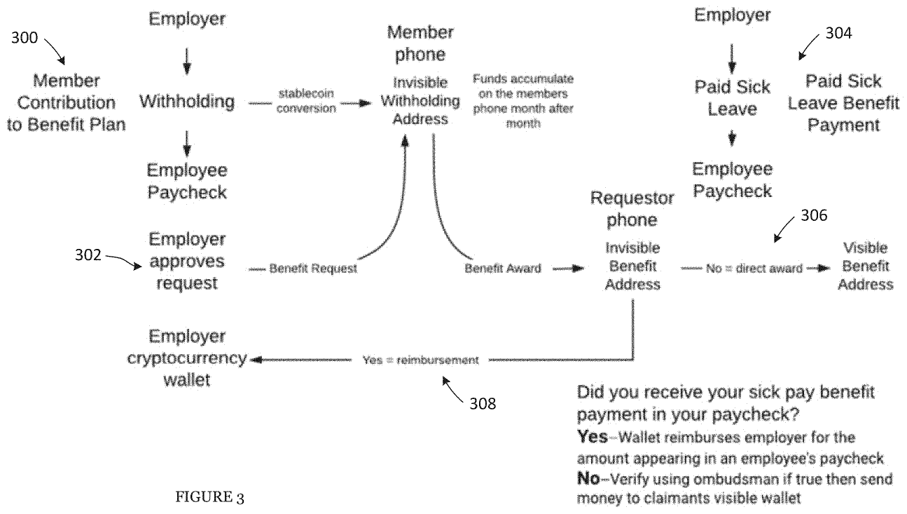

FIG. 3 illustrates another view of an example process for providing a group benefit using a self-executing agreement and distributed ledger, according to certain embodiments of this disclosure. The example process described with reference to FIG. 3 shares certain assumptions and features in common with the example process described with reference to FIG. 2, and those assumptions and features if not repeated are incorporated by reference.

At stage 300, group members (e.g., users 112) of group 114 make contributions to a benefit plan. In certain embodiments, stage 300 is analogous to stage 1 illustrated in FIG. 2 and described above. As illustrated, stage 300 includes a group administrator (e.g., an employer) withholding wages from an employee's wages (e.g., paycheck), and converting the withheld amount from a fiat currency (e.g., U.S. dollars) to a cryptocurrency (e.g., a stablecoin). The withheld funds, in cryptocurrency, are deposited to a withholding cryptocurrency address 107 of the employee, and that withholding cryptocurrency address 107 may be substantially invisible to the employee. That is, although in certain embodiments the employee may be able to view a balance in the withholding cryptocurrency address 107, the private key that is stored on the user device 102 (e.g., member phone) of the employee may be hidden from the employee at the user interface level, and the user interface of an application on the user device 102 might not present the user with an option to transfer the funds in the withholding cryptocurrency address 107 other than to a designated address, as described below. The funds in the withholding cryptocurrency address 107 of the employee accumulate over time (e.g., month-to-month).

At stage 302, which in certain embodiments is analogous to stage 2 of FIG. 2, the group administrator (e.g., the employer) approves a benefit claim request submitted by a group member of group 114. A notification of the approval is communicated to the user device 102 of the employee (the “member phone”), which causes the user device 102 of the employee to transfer an amount from the withholding cryptocurrency address 107 of the employee to a benefit cryptocurrency address of the benefit award recipient. The benefit cryptocurrency address of the benefit award recipient may be substantially invisible to the requestor.

At stage 304, which in certain embodiments is analogous to stage 3 of FIG. 2, the group administrator (e.g., the employer) causes a paid sick leave benefit payment (in fiat currency) to be made to the benefit award recipient in the benefit award recipient's employee paycheck.

At this point, the benefit award recipient may be asked to confirm whether he or she received payment (in fiat currency) for the approved benefit claim (e.g., “Did you receive your sick pay benefit payment in your paycheck?”).

At stage 306, if the benefit award recipient does not receive the paid sick leave benefit payment in fiat currency, the benefit award recipient may use their user device 102 to transfer the funds from the benefit cryptocurrency address 107 of the benefit award recipient to a visible benefit cryptocurrency address 107 of the benefit award recipient, and the funds may then be available to the benefit award recipient to use as cryptocurrency or convert to a fiat currency and deposit or spend, as desired. Certain verifications may be performed before allowing this direct payment to the visible benefit cryptocurrency address 107 of the benefit award recipient.

At stage 308, which in certain embodiments is analogous to stage 4 of FIG. 2, if the benefit award recipient receives the paid sick leave benefit payment in fiat currency, the benefit award recipient confirms using the user device 102 of the benefit award recipient (e.g., benefit award recipient phone) that the funds were received and initiates transfer of the cryptocurrency funds from the benefit cryptocurrency address 107 of the benefit award recipient to an employer reimbursement cryptocurrency address 107.

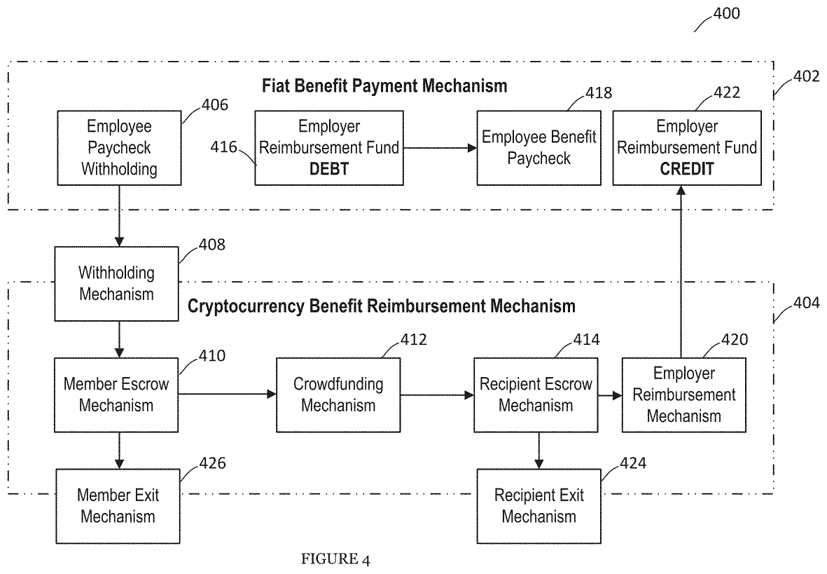

FIG. 4 illustrates example division 400 of operations between a fiat currency layer and a cryptocurrency layer, according to certain embodiments of this disclosure. As shown in FIG. 4, certain operations fall within a fiat benefit payment mechanism layer 402, and certain operations fall within a cryptocurrency benefit reimbursement mechanism layer 404.

Employee paycheck withholding mechanism 406 generally includes the group administrator (e.g., an employer) withholding wages from the paycheck of a user 112 (e.g., an employee) that would otherwise be paid in a fiat currency. Withholding mechanism 408 generally includes the conversion of the withheld amount from an employee's paycheck to cryptocurrency. Member escrow mechanism 410 generally includes the depositing of the converted withheld amount to a withholding cryptocurrency address 107 of the employee. In certain embodiments, employee paycheck withholding mechanism 406, withholding mechanism 408 and member escrow mechanism 410 are analogous to portions of stage 1 of FIG. 2 and/or stage 300 of FIG. 3.

Crowdfunding mechanism 412 generally includes the transfer of cryptocurrency from the withholding cryptocurrency address 107 of an employee to a benefit cryptocurrency address 107 of a benefit award recipient via computer-implemented hub 106. Recipient escrow mechanism 414 generally includes the benefit cryptocurrency address 107 of the benefit award recipient, which acts as an escrow for the claim benefit award. In certain embodiments, crowdfunding mechanism 412 and recipient escrow mechanism 414 are analogous to portions of stage 2 of FIG. 2 and/or stage 302 of FIG. 3.

Employer reimbursement fund mechanism 416 generally includes the amount withdrawn from a fiat currency account of the employer to pay the benefit award in cryptocurrency to the benefit award recipient. Employee benefit paycheck generally refers to the receipt by the benefit award recipient of payment in fiat currency of the benefit award. In certain embodiments, employer reimbursement fund mechanism 416 and employee benefit paycheck mechanism 418 are analogous to portions of stage 3 of FIG. 2 and/or stage 304 of FIG. 3.

Employer reimbursement mechanism 420 generally includes the transfer of funds from the benefit cryptocurrency address 107 of the benefit award recipient to a reimbursement cryptocurrency address 107 of the employer. In certain embodiments, employer reimbursement mechanism 420 is analogous to portions of stage 4 of FIG. 2 and/or stage 308 of FIG. 3.

Employer reimbursement fund mechanism 422 generally includes the conversion into fiat currency of the cryptocurrency received via employer reimbursement mechanism 420 and depositing of the converted funds into a fiat currency account of the employer (potentially the same fiat currency account that was used for employer reimbursement fund mechanism 416). In certain embodiments, employer reimbursement fund mechanism 422 is analogous to portions of stage 5 of FIG. 2.

Recipient exit mechanism 424 generally includes the transfer of funds from a benefit cryptocurrency address 107 of the benefit award recipient in the event the payment of the benefit award is not received (via mechanisms 416 and 418). In certain embodiments, recipient exit mechanism 424 is analogous to portions of stage 306 of FIG. 3.

Member exit mechanism 426 generally includes the transfer of a remaining balance of the withholding cryptocurrency address of a particular member (e.g., employee) to an exit cryptocurrency address 107 of the particular member. Member exit mechanism 426 may include the member leaving group 114 (and potentially employment with the employer).

In this example, employee paycheck withholding mechanism 406, employer reimbursement fund mechanism 416 (a debt to the employer), employee benefit paycheck mechanism 418, and employer reimbursement fund mechanism 422 (a credit to the employer) execute in fiat benefit payment mechanism layer 402. Additionally, in this example, withholding mechanism 408, member escrow mechanism 410, crowdfunding mechanism 412, recipient escrow mechanism 414, employer reimbursement mechanism 420, recipient exit mechanism 424, and member exit mechanism 426 execute in cryptocurrency benefit reimbursement mechanism layer 404.

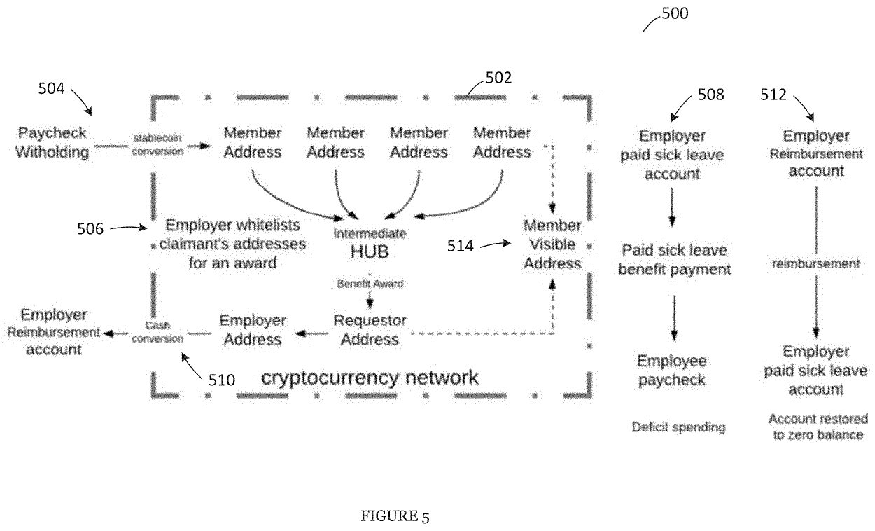

FIG. 5 illustrates another representation of an example process 500 for providing a group benefit using a self-executing agreement and distributed ledger, according to certain embodiments of this disclosure. The example process 500 described with reference to FIG. 5 shares certain assumptions and features in common with the example processes described with reference to FIGS. 2-4, and those assumptions and features if not repeated are incorporated by reference. Additionally, FIG. 5 illustrates example entry and exit points of the example process 500 into a cryptocurrency network layer 502, which may be analogous to distributed ledger system 108 (or portions thereof) of FIG. 1.

At stage 504, group members (e.g., users 112, which may be employees) of group 114 make contributions to a benefit plan through a paycheck withholding mechanism. In particular, the group administrator (e.g., employer) withholds a portion of the wages (e.g., the paycheck) of each user 112, converts the withheld amounts from a fiat currency (e.g., U.S. dollars) to a cryptocurrency (e.g., a stablecoin), and deposits the withheld amounts (as converted) to respective withholding cryptocurrency address 107 (shown as member addresses) of users 112. In certain embodiments, stage 504 is analogous to stage 1 illustrated in FIG. 2, stage 300 illustrated in FIG. 3, and mechanisms 406, 408, and 410 of FIG. 4. The funds at the respective withholding cryptocurrency addresses 107 of the users 112 accumulate over time (e.g., month-to-month).

At stage 506, which in certain embodiments is analogous to stage 2 of FIG. 2, stage 302 of FIG. 3, and stage 412 of FIG. 4, the group administrator (e.g., the employer) approves a benefit claim request submitted by a group member of group 114. A notification of the approval is communicated to computer-implemented hub 106, and that notification may identify the benefit cryptocurrency address 107 of the benefit award recipient as being approved for payment (e.g., whitelists the benefit cryptocurrency address 107 of the benefit award recipient). A notification of the approval is communicated to the user devices 102 of users 112, which causes the user devices 102 of the users 112 to transfer an amount from the respective withholding cryptocurrency addresses 107 of the users 112 to an address of computer-implemented hub 106, for subsequent transfer to a benefit cryptocurrency address 107 of the benefit award recipient (the “requestor address” in FIG. 5). Computer-implemented hub 106 may individually or collectively (e.g., in a pooled transaction) deliver the received funds to the benefit cryptocurrency address 107 of the benefit award recipient as a benefit award. The benefit cryptocurrency address 107 of the benefit award recipient may be substantially invisible to the benefit award recipient.

At stage 508, which in certain embodiments is analogous to stage 3 of FIG. 2, stage 304 of FIG. 3, and stages 416-418 of FIG. 4, the group administrator (e.g., the employer) causes a paid sick leave benefit payment (in fiat currency) to be made to the benefit award recipient in the benefit award recipient's employee paycheck. For example, the group administrator may make a paid sick leave benefit payment from a fiat-currency paid sick leave account of the group administrator to the benefit award recipient in a paycheck of the benefit award recipient.

At this point, the benefit award recipient may be asked to confirm whether he or she received payment (in fiat currency) for the approved benefit claim.

At stage 510, if the benefit award recipient receives the paid sick leave benefit payment in fiat currency, the benefit award recipient (e.g., an application on the user device 102) initiates transfer of the cryptocurrency funds from the benefit cryptocurrency address 107 of the benefit award recipient to an employer reimbursement cryptocurrency address 107. The employer may then convert the funds in the employer cryptocurrency address to a fiat currency and deposit the converted funds into an employer reimbursement account. Stage 510 may be analogous to stage 4 of FIG. 2, stage 308 of FIG. 3, and mechanisms 414, 420, and 422 of FIG. 4.

At stage 512, the employer may transfer the fiat currency funds from the employer reimbursement account to an employer paid sick leave account, and those funds may be used to pay, in fiat currency, future benefit awards. Stage 510 may be analogous to stage 5 of FIG. 2.

In the illustrated example, stages 506 and 514 occur in cryptocurrency network layer 502, and stages 508 and 512 occur outside cryptocurrency network layer 502. Stages 504 and 510 occur at entry and exit points, respectively, of cryptocurrency network layer 502.

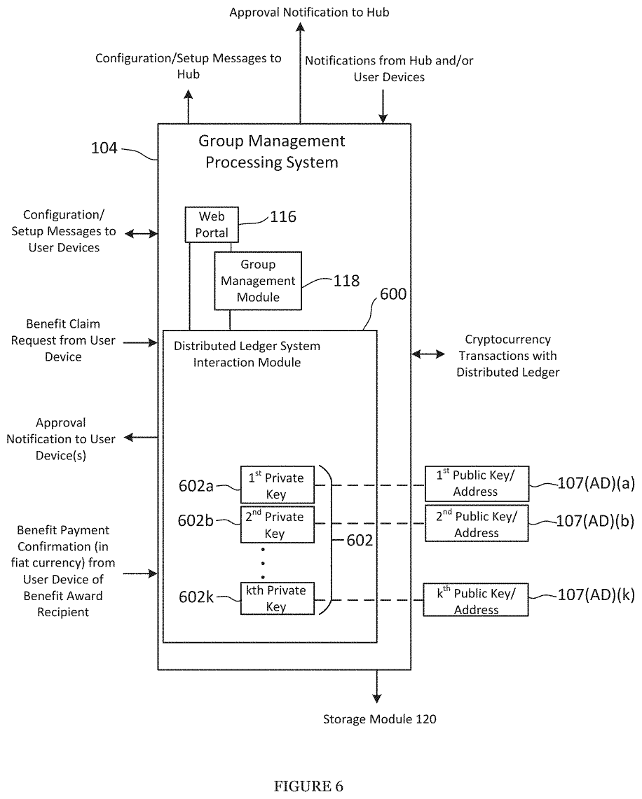

FIGS. 6-9 illustrate further example details of components of system 100, according to certain embodiments of this disclosure. Although components of system 100 are shown and described with reference to FIGS. 6-9 as having particular components, system 100 and its components may be implemented in any suitable manner. Additionally, although particular components of system 100 (and particular components within those components) are shown and described as performing particular operations, this disclosure contemplates any suitable component performing operations. Each of FIGS. 6-9 is described below.

FIG. 6 illustrates example details of group management processing system 104, according to certain embodiments of this disclosure. Group management processing system 104, as described above with reference to FIG. 1, may be implemented using one or more computer systems, and may include web portal 116 and group management module 118. Additionally, in certain embodiments, group management processing system 104 includes distributed ledger system interaction module 600.

Distributed ledger system interaction module 600 is configured, at least in part, to provide private key management, and may be implemented as a browser extension/plug-in, desktop application, mobile application, web application, hardware component, or in another suitable manner. In one example, distributed ledger system interaction module 600 is or includes cryptocurrency and/or smart contract wallet software that is configured to facilitate communication between group management processing system 104 and distributed ledger system 108, in part to implement transactions in distributed ledger system 108 on behalf of group 114. As just a few examples of software wallet implementations, distributed ledger system interaction module 600 may be METAMASK, MYCRYPTO, TRUSTWALLET, MYETHERWALLET, ARGENT, COINBASE WALLET, GNOSIS SAFE, INSTADAPP, ZERION, POKETTO, and the like. In another example, distributed ledger system interaction module 600 is or includes cryptocurrency and/or smart contract wallet hardware or other suitable type of private key storage device that may be portable and connectable to other user devices to grant the administrator access to the private keys and is configured to facilitate communication between group management processing system 104 and distributed ledger system 108, in part to implement transactions in distributed ledger system 108 on behalf of group 114. As just a few examples of hardware wallet implementations, distributed ledger system interaction module 600 may be LEDGER NANO S, LEDGER NANO X, TREZOR T, and the like.

Distributed ledger system interaction module 600 may be configured to assist group administrator of group 114 with obtaining one or more cryptocurrency addresses 107 (e.g., an ETHEREUM wallet) for use with transactions effected using distributed ledger system 108, initiating a premiums escrow mechanism for group 114, and facilitating transactions (e.g., exchange/transfer/receipt of cryptocurrency, and certain transactions performed by or with computer-implemented hub 106) on behalf of group 114. In the illustrated example, the cryptocurrency addresses 107 associated with the group administrator are labeled as cryptocurrency addresses 107(AD)(a) through 107(AD)(k), with the AD representing administrator and the a through k representing k distinct (e.g., first, second, third, and so on) but not necessarily consecutive addresses, with a and k being integers greater than 0, k being greater than a (to the extent more than one cryptocurrency address 107(AD) is used). In one example, the cryptocurrency addresses 107 associated with the group administrator include reimbursement cryptocurrency address 107(AD)(a) (e.g., also referred to in some instances as employer reimbursement cryptocurrency address 107(AD)(a)).

In certain embodiments, distributed ledger system interaction module 600 may assist a user (e.g., the group administrator) in modifying computer-implemented hub 106, if appropriate. Specifically, distributed ledger system interaction module 600 may generate public-private key pairs using a cryptographic method (e.g., elliptic curve cryptography) on behalf of the group administrator that is compliant with distributed ledger system 108 (e.g., the ETHEREUM blockchain). Distributed ledger system interaction module 600 may use these key pairs to sign transactions that authorize payments from addresses holding cryptocurrency, allows the group administrator to interact with computer-implemented hub 106 on behalf of group 114, or perform other actions particular to group 114 when interacting with distributed ledger system 108.

Distributed ledger system interaction module 600 may store and manage one or more administrator private keys 602 for performing transactions associated with distributed ledger system 108. Private keys 602 may correspond to a cryptocurrency address 107(AD) (which also could be referred to as a public key or public address) of distributed ledger system 108. Such transactions may include signing transactions with computer-implemented hub 106 (and/or one or more other self-executing agreements used in system 100) and/or signing transactions associated with transferring funds from a reimbursement cryptocurrency address 107(AD)(a) of the group administrator to a fiat currency account (via a cryptocurrency exchange). Private keys 602 may be stored in any suitable location that is acceptable for a given implementation. Administrator private keys 602 may be stored in storage module 120 or another suitable secure location of group management processing system 104. For example, as described above, private keys 602 may be stored using a software wallet implemented on a particular user terminal (and potentially a suitably air-gapped user terminal) of group management processing system 104, on a hardware wallet that is connectable to one or more user terminals (and potentially a suitably air-gapped user terminal) of group management processing system 104.

In certain embodiments, some of the features available with distributed ledger system interaction module 600 are provided through web portal 116; however, in certain embodiments, only particular users (e.g., the secretary) may use some or all of those features. Access to those features may be restricted in any suitable manner, according to particular needs.

One or more users associated with group administrator may be authorized to perform operations that involve interaction with distributed ledger system 108. Those authorized users may have access to one or more private keys 602 for interacting with distributed ledger system 108. For example, those users may have access to a user terminal that includes a software wallet for accessing private keys 602. As another example, those users may have access to a hardware wallet that can be plugged into a user terminal to cause that user terminal to become authorized to perform transactions using private keys 602. If appropriate those authorized users may separately authenticate to group management module 118 to perform certain operations through group management module. Limiting access to private keys 602, whether by storing a software wallet on a selected user terminal or by providing only certain authenticated users with access to a hardware wallet, may provide heightened security for conducting transactions using private keys 602 beyond any authentication implemented by web portal 116 and/or group management module 118.

As described above with reference to FIG. 1, group management processing system 104 may have access to storage module 120, and may store group information 122 in storage module 120.

Group management processing system 104 may send and receive a variety of information and instructions. For example, group management processing system 104 may exchange setup and configuration messages with user devices 102. As another example, group management processing system 104 may exchange setup and configuration messages with computer-implemented hub 106. As another example, group management processing system 104 may receive benefit claim requests from user devices 102. As another example, in response to an approval of a benefit claim request, group management processing system 104 may communicate an approval notification (also referred to as an instruction) and an approval notification to computer-implemented hub 106. As another example, group management processing system 104 may receive a benefit payment confirmation from a user device 102 when a user 112 confirms using that user device 102 that the user 112 (the benefit award recipient) received payment for the benefit award in a fiat currency (e.g., in a paycheck). As another example, group management processing system 104 may receive notifications from computer-implemented hub 106 and/or user devices 102. As another example, group management processing system 104 may communicate with one or more self-executing agreements and/or with one or more cryptocurrency addresses 107(AD) using appropriate private keys 602.

Additional details regarding the operation of group management processing system 104 are described throughout this disclosure.

FIG. 7 illustrates example details of group information 122, according to certain embodiments of this disclosure. In the illustrated example, group information 122 includes a group identifier (ID) 700 for group 114, a group name 702 for group 114, a group charter 704 for group 114, a group pledge 706 for group 114, group membership 708 for group 114, benefit claim records 710 for group 114, configuration information 712, and computer-implemented hub information 714. Although group information 122 is illustrated and described as including particular information, group information 122 may include any suitable information according to particular needs.

Group ID 700 may be a unique identifier, such as character sequence generated by group management module 118, and group name 202 for group 114 may be a group moniker selected by group 114.

Group information 122 may include group charter 704 and group pledge 706 for group 114. Group charter 704 may be a published document that identifies the rules that govern group 114, and that outlines how group 114 will manage the affairs of group 114. Although group charter 704 is described below as including particular information, this disclosure contemplates group charter 704 including any suitable information.

Certain embodiments use group charter 704 to establish and inform group members (users 112) of the rules of group 114, including membership requirements, obligations of the group administrator (e.g., the employer), obligations of the group members (e.g., users 112), and any other suitable information. Group charter 704 may establish the contribution amount and frequency (e.g., the paycheck withholding amount and whether the withholding will occur biweekly or monthly) for a given group member or set of group members of group 114.

Group charter 704 may establish the terms by which benefit claim requests will be evaluated for approval and any associated terms and restrictions. For example, group charter 704 may establish the terms by which benefit claim requests for paid sick leave will be evaluated for approval, the payment amount for paid sick leave, any limits on paid sick leave (e.g., a limit on the amount paid per day, a limit on the number of days, etc.), and any other suitable terms and restrictions. It should be understood that the particular criteria for approval may depend on the types of benefit claims contemplated by group 114 and the associated goals of the group members.

In certain embodiments, if applicable, group charter 704 may indicate that membership in group 114 is mandatory. For example, an employer may specify to its employees that membership in group 114 is mandatory. The information in group charter 704 regarding who is eligible to be group member may include what training group 114 undertakes to prepare someone for the correct submission of benefit claims, how quickly a benefit claim request must be made from the time of an associated event (e.g., when the employee took days off due to illness), what actions allow an individual to acquire group membership and eligibility for coverage from group 114, what actions result in group members becoming ineligible and being removed from group 114, and/or guidelines for dispute resolution within group 114.

Group pledge 706 may include the signature of other indication of an agreement by group members (and possibly also by the group administrator) that they have read, understand, and agree to the terms explained in group charter 704. By signing group pledge 706, group members agree, in part, to obtain coverage by paying premiums to a premium fund (e.g., a withholding fund), pay approved benefit claims, and reimburse the group administrator according to certain limits. As part of group charter 704 and/or group pledge 706, the group administrator agrees that the group members can exit group 114 with the remaining balance of the premium fund, if desired, and to maintain a surety bond.

Group charter 704 and group pledge 706 may be the same or separate items as may be appropriate for a given implementation. In certain embodiments, group charter 704 and/or group pledge 706 may be implemented as an end-user license agreement and/or may be included as part of an employment agreement; however, this disclosure contemplates group charter 704 and/or group pledge 706 being implemented in any suitable manner.

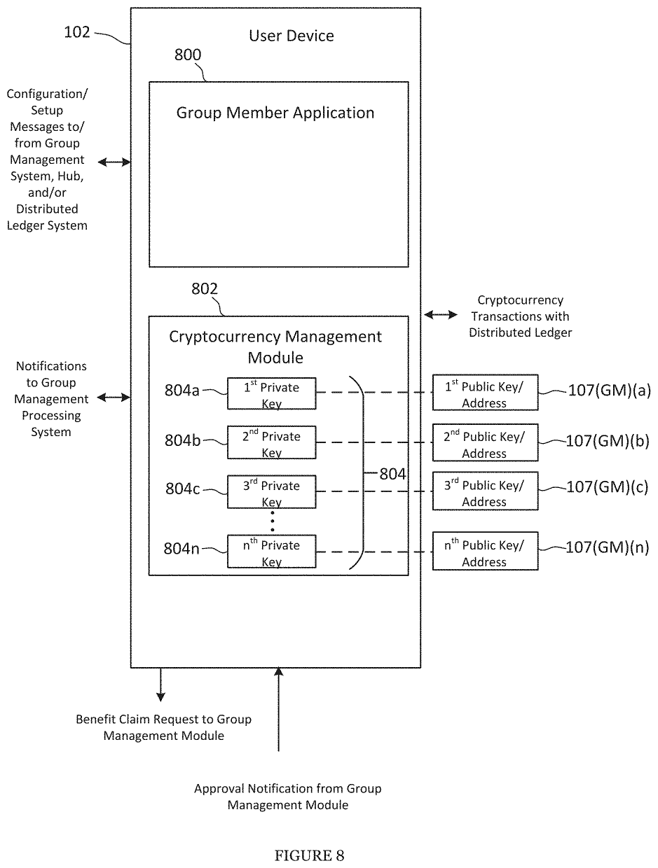

Group membership information 208 may include may include any suitable information about group 114. For example, group membership information 208 of group information 122 may include identifiers (names and/or other suitable identifiers) of the group members (e.g., users 112), one or more cryptocurrency addresses 107 of the group members (which may be referred to as cryptocurrency addresses 107(GM), as described further below with reference to FIG. 8), information identifying or sufficient to determine benefit amounts (e.g., paid sick leave rates and/or limits) for group members, current status of benefit amounts (e.g., number sick hours/days taken year-to-date) for each group member, and any other suitable information.

After receiving an invitation to participate in group 114 from the group administrator, the recipient may access web portal 116 for group 114 to complete a group membership process. For example, the individual may be directed to suitable location for downloading an application (e.g., a mobile application) to the individual's user device 102, and the application may guide the individual through a membership process. Additionally or alternatively, the invitation may include an email link that the recipient can use to log into web portal 116 for group 114. Using the application on the user device 102 or web portal 116, the recipient can then create an account and sign group pledge 706 to uphold group charter 704. Once an individual signs group pledge 706 and completes the registration, the individual can use additional features available through the application on the user device 102 or log into web portal 116 for group 114 using the individual's registered account. The application on the user device 102 or the invitation also may include links or other information to facilitate the recipient obtaining a distributed ledger system interaction module (e.g., a digital wallet) and one or more cryptocurrency addresses 107(GM), described in greater detail below with reference to FIG. 8, for interacting with distributed ledger system 108 and making or receiving payments in cryptocurrency.

In certain embodiments, storage module 120 may store a correlation between identities of users 112 (members of group 114) and public keys (e.g., cryptocurrency addresses 107(GM)) of users 112, as part of group information 122 (e.g., as part of group membership information 208) for group 114. For example, when a user 112 registers the user's identity through web portal 116 (e.g., in response to an invitation from the secretary), group management processing system 104 may correlate the public key of user 112 with the identity of user 112. As such, the public key of user 112 may be stored by group management processing system 104 (e.g., in storage module 120) as part of group information 122. The identity of user 112 might not be public, but the public key (e.g., cryptocurrency address 107) is public. In certain embodiments, the group administrator is able to verify that each digital persona (e.g., associated with a respective public key) has a single unique offline real identity in a possession of a user device 102 that is granted permission to pay a premium.

The group administrator may coordinate the activities of group 114. In certain embodiments, the group administrator has access to certain features via web portal 116 to which the group members (users 112) do not have access. For example, the group administrator may be able to perform one or more of sending invites to individuals to become group members, removing group members, approving deny benefit claim requests, updating computer-implemented hub 106 (if appropriate), or other suitable features associated with managing group 114.

The group administrator may perform group initialization, which may include drafting the language of group charter 704 and group pledge 706. Group initialization may include establishing the parameters in group management processing system 104 that allow group members (e.g., users 112) to log into web portal 116 for group 114 or use an application on user devices 102. These parameters also may serve to generate the account of group 114 with distributed ledger system 108, including with computer-implemented hub 106. In certain embodiments, the group administrator, as part of group initialization, may personally invite each desired individual to be a group member of group 114. Group initialization may include training group members, including informing the group members of the rights and responsibilities of a group member.

The group administrator may facilitate payments made through system 100. This may include assisting group members with using the application on user device 102 to pay premiums (if user interaction is involved), obtain refunds when leaving the group, resolve technical problems, and perform other suitable actions.

In certain embodiments, the group administrator is responsible for approving or denying benefit claim requests. In other words, the group administrator may determine whether a benefit claim request from a user 112 should be approved to receive a benefit award, which entitles the associated benefit claim requester (e.g., a user 112) to receive payment for the benefit award. In certain embodiments, this operation is automated, but in other embodiments, the group administrator provides input to the approval/denial process. If the group administrator determines that benefit claim request satisfies the criteria for approval established in group charter 704, then the group administrator approves the benefit claim request to receive a benefit award (and ultimately payment for the benefit award). Approving a benefit award to a benefit claim requestor may include whitelisting a benefit cryptocurrency address 107 (benefit cryptocurrency address 107(GM)(b), as described below) in distributed ledger system 108 for payment of the benefit award by users 112 (from the respective withholding cryptocurrency addresses 107 (benefit cryptocurrency address 107(GM)(a), as described below) to the benefit cryptocurrency address 107 (benefit cryptocurrency address 107(GM)(b), as described below) of the benefit award recipient via computer-implemented hub 106).

The group administrator may be responsible for removing group members from group 114. As just one example, a group member may be removed for violating group pledge 706 to uphold group charter 704, or a group member may no longer be employed by group administrator (e.g., whether at the group administrator's determination or otherwise). In certain embodiments, group members may leave group 114 of their own volition at any time.

Benefit claim records 710 of group information 122 may include any suitable information about benefit claim requests and associated approvals/denials and statuses of those benefit claim requests. For example, each benefit claim request received from a user device 102 may be assigned a benefit claim ID, which may be used to correlate messages and transactions associated with the benefit claim request/award throughout system 100. For each benefit claim request, the benefit claim record may include the benefit claim ID, an identifier of the benefit claim requestor (e.g., the name or other identifier (e.g., the benefit cryptocurrency address 107 (benefit cryptocurrency address 107(GM)(b), as described below)) of the group member that submitted the benefit claim request), the approval/denial decision, and, if applicable (depending on the approval/denial decision) the total benefit award (which might or might not match the complete benefit award requested in the benefit claim request), a proposed apportioned benefit award amount (e.g., the amount each group member would be responsible for paying), a payment status of the benefit award, and/or any other suitable information.

Configuration information 721 of group information 122 may include information for configuring the application on user devices 102, computer-implemented hub 106, and any other suitable self-executing agreements used throughout system 100, if appropriate.

Computer-implemented hub information 714 may include an address for sending transactions to computer-implemented hub 106 (e.g., an address on distributed ledger system 108). To the extent one or more other self-executing agreements are implemented throughout system 100, addresses for interacting with those self-executing agreements also may be stored with computer-implemented hub information 714. Furthermore, it may be desirable to limit modification and/or the ability to sign transactions on behalf of computer-implemented hub 106 and/or other self-executing agreements to the group administrator, and thus computer-implemented hub information may include suitable information for authenticating messages from the group administrator and/or group management processing system 104 to computer-implemented hub 106 (and/or other self-executing agreements).

FIG. 8 illustrates example details of user device 102, according to certain embodiments of this disclosure. In the example of FIG. 8, user device 102 includes group member application 800. Group member application 800 may be implemented as an application (e.g., a desktop application and/or a mobile application), in a web browser, or in any other suitable manner. As just one example, user device 102 may be a smartphone, and group member application 800 may be a mobile application suitable for execution by a smartphone. As another example, in an embodiment in which group member application 800 operates in a web browser of user device 102, group member application 800 may be implemented using Hypertext Markup Language (HTML). In certain embodiments, implementing group member application 800 as an application, and particularly as a mobile application, may allow group member application 800 to more persistently perform certain operations.

In general, group member application 800 provides a user 112 of user device 102 with access to web portal 116 and/or to interaction with group management module 118, provides interaction with computer-implemented hub 106, provides interaction with access to cryptocurrency addresses 107 of user 112, and potentially provides access to other features available via network 110 of FIG. 1. Group member application 800 also may assist user 112 in establishing cryptocurrency addresses 107 and obtaining appropriate private keys (private keys 804, described below) for those cryptocurrency addresses 107. In the illustrated example, the cryptocurrency addresses 107 associated with user 112 are labeled as cryptocurrency addresses 107(GM)(a) through 107(GM)(n), with the GM representing group member and the a through n representing n distinct (e.g., first, second, third, and so on) but not necessarily consecutive addresses, with a and n being integer's greater than 0, n being greater than a (to the extent more than one cryptocurrency address 107(GM) is used).

As another example, group member application 800 may provide a group member of group 114 with a dashboard or other user interface to view and manage the group member's account with group management processing system 104, to see the current status of group 114, to view benefit claim requests and their associated statuses, to view historical information related to previous benefit claim requests, to view group charter 704 for group 114 (described below), to view and sign group pledge 706, and to access other information or features. Additionally or alternatively, group member application 800 may provide a group member of group 114 with a dashboard or other user interface to view one or more of the cryptocurrency addresses 107(GM) (e.g., a balance at those cryptocurrency addresses 107(GM)) for which user device 102 has access to the corresponding private key (private key 804, described below).

Cryptocurrency management module 802 may be implemented as a browser extension/plug-in, desktop application, mobile application, web application, or in another suitable manner. In one example, cryptocurrency management module 802 is or includes cryptocurrency and/or smart contract wallet software that is configured to facilitate communication between user device 102 (e.g., group member application 800) and distributed ledger system 108, in part to implement transactions in distributed ledger system 108 on behalf of the user 112 of user device 102. As just a few examples, cryptocurrency management module 802 may be METAMASK, MYCRYPTO, TRUSTWALLET, MYETHERWALLET, ARGENT, COINBASE WALLET, GNOSIS SAFE, INSTADAPP, ZERION, POKETTO, and the like.

Cryptocurrency management module 802 may be configured to assist a user 112 of user device 102 with establishing one or more cryptocurrency addresses 107(GM), obtaining an address (e.g., an ETHEREUM wallet) for use with transactions effected using distributed ledger system 108, and facilitating transactions (e.g., exchange/transfer/receipt of cryptocurrency) on behalf of user 112. For example, cryptocurrency management module 802 may facilitate generation of public-private key pairs using a cryptographic method (e.g., elliptic curve cryptography) on behalf of user 112 that is compliant with distributed ledger system 108 (e.g., the ETHEREUM blockchain).

In certain embodiments, at least three cryptocurrency addresses 107(GM) are generated, and cryptocurrency management module 802 stores a private key 804 for each of the generated cryptocurrency addresses 107(GM). In other words, private keys 804 may correspond to a cryptocurrency address 107(GM) (which also could be referred to as a public key or public address) of distributed ledger system 108. For example, a first cryptocurrency address 107(GM) generated for user device 102 may be a withholding cryptocurrency address 107(GM)(a), and cryptocurrency management module 802 may store a first private key 804a corresponding to the withholding cryptocurrency address 107(GM)(a). As another example, a second cryptocurrency address 107(GM) generated for user device 102 may be a benefit cryptocurrency address 107(GM)(b), and cryptocurrency management module 802 may store a second private key 804b corresponding to the benefit cryptocurrency address 107(GM)(b). As another example, a third cryptocurrency address 107(GM) generated for user device 102 may be an exit cryptocurrency address 107(GM)(c), and cryptocurrency management module 802 may store a third private key 804c corresponding to the exit cryptocurrency address 107(GM)(c). Given the labeling of cryptocurrency addresses 107(GM) associated with user devices 102 as cryptocurrency addresses 107(GM)(a)-107(GM)(n), it may be understood that in certain embodiments cryptocurrency address 107(AD), including the reimbursement cryptocurrency address 107(AD)(a), of group administrator is not in the group of cryptocurrency addresses 107(GM)(a)-107(GM)(n) (which might or might not be a consecutive set of cryptocurrency addresses 107).

Group member application 800 and/or cryptocurrency management module 802 may use these private keys 804 to sign transactions that authorize payments from addresses holding cryptocurrency (e.g., the withholding cryptocurrency address 107(GM)(a), the benefit cryptocurrency address 107(GM)(b), and/or the exit cryptocurrency address 107(GM(c)), allow user 112 and/or user device 102 to interact with computer-implemented hub 106, or perform other actions particular to user 112 and/or user device 102 when interacting with distributed ledger system 108.

To that end, cryptocurrency management module 802 may perform key management for user 112, including receiving and storing user 112's resource allocation address and access key, such as cryptocurrency public and private keys. In certain embodiments, because computer-implemented hub 106 may be publicly available on distributed ledger 124, which is often the case for decentralized blockchain technologies, the storage and management of private keys 804 may be maintained on the side of the user (e.g., by cryptocurrency management module 802). In certain embodiments, cryptocurrency management module 802 generates the public-private key pair on user device 102.

User 112 and/or user device 102 may interact directly with distributed ledger system 108 (including with computer-implemented hub 106 and distributed ledger 124) or may interact with distributed ledger system 108 (including with computer-implemented hub 106 and distributed ledger 124) via web portal 116, if appropriate.

User device 102 may send and receive a variety of information and instructions. For example, user device 102 may exchange setup and configuration messages with user devices 102. As another example, user device 102 may exchange setup and configuration messages with group management processing system 104, computer-implemented hub 106, and/or distributed ledger system 108. As another example, user system 102 may send and receive notifications to and from group management processing system 104. As another example, user device 102 may send benefit claim requests to group management processing system 104. As another example, in response to an approval of a benefit claim request (submitted by the group member associated with this user device 102 or by another group member using another user device 102) by group management processing system 104, user device 102 may receive an approval notification (also referred to as an instruction) from group management processing system 104. As another example, user device 102 may communicate with one or more self-executing agreements and/or with one or more cryptocurrency addresses 107(CM) using appropriate private keys 804.

Additional details regarding the operation of user device 102 are described throughout this disclosure.

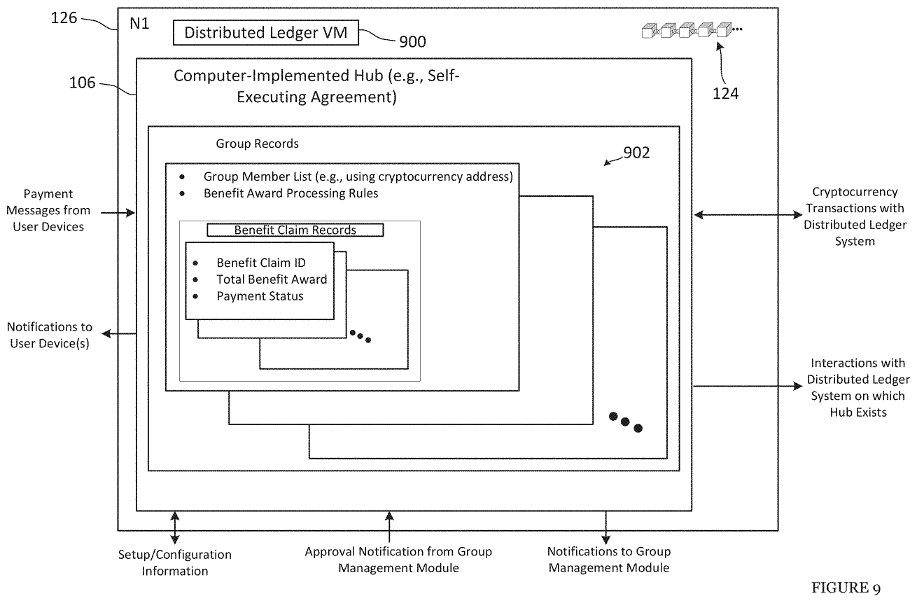

FIG. 9 illustrates example details of computer-implemented hub 106, according to certain embodiments of this disclosure. In particular, FIG. 9 illustrates an instance of computer-implemented hub 106 operating on a node 126 (node N1) within distributed ledger system 108. In certain embodiments, computer-implemented hub 106 operates on multiple (and possibly all) nodes of distributed ledger system 108, that is on multiple nodes of a blockchain environment.

Node 126 includes computer-implemented hub 106, distributed ledger 124, and distributed ledger system virtual machine 900.

Computer-implemented hub 106 includes the instruction base and associated data (e.g., related to group 114) of the self-executing agreement that is to be executed by node 126 (N1), as well as by other nodes in distributed ledger system 108.

Distributed ledger system virtual machine 900 may be a virtual machine on which computer-implemented hub 106 executes and which is responsible for maintaining distributed ledger 124 and communication with other nodes 126 to reach a consensus regarding the results of executing computer-implemented hub 106 and the content of records in distributed ledger 124. In an example in which computer-implemented hub 106 and distributed ledger 124 are implemented using ETHEREUM, distributed ledger system virtual machine 900 may be the ETHEREUM virtual machine (EVM).

In certain embodiments, the instruction base for computer-implemented hub 106 accessible to a node 126 includes all the instructions or software code of computer-implemented hub 106 available for execution on distributed ledger system 108 (e.g., on the blockchain). Computer-implemented hub 106 may be a virtual machine running the instructions of computer-implemented hub 106 on, for example, the ETHEREUM blockchain and may perform some of the main operations of system 100 to perform the escrow operations of the benefit coverage arranged by group 114. These operations may include maintaining a premiums (cryptocurrency) escrow for group 114, processing payment of premiums by users 112 (group members), processing payment of refunds and reimbursements, processing payment of benefit awards in cryptocurrency, enforcing rules established by group 114 (rules that are written into the instruction base of computer-implemented hub 106) related to when such payments are appropriate and who may make and receive those payments, and storing a permanent record of transactions executed using computer-implemented hub 106 in distributed ledger 124.

In certain embodiments, computer-implemented hub 106 stores certain information in association with performing operations within system 100. For example, computer-implemented hub 106 includes group records 902. As shown by the layered arrangement of group records 902, computer-implemented hub 106 might store records for multiple groups 114, and those multiple group records 902 could be for the same group administrator (e.g., employer) or different group administrators (e.g., employers).

In certain embodiments, a group record 902 may include a group member list of the members of group 114, benefit award processing rules, and benefit claim records.

The group member list may include a group member identifier of the current members of group 114. The group administrator (e.g., via group management processing system 104) may cause the group membership information to be updated as group members of group 114 are added or removed. In certain embodiments, the group member identifier includes one or more cryptocurrency addresses 107(GM) of the group member. Because records stored on distributed ledger 124, including computer-implemented hub 106, are publicly available, it may be desirable to omit the actual name of the group members; however, this disclosure contemplates include the actual names, if appropriate.

The benefit award processing rules may include any determinations or other processing rules that computer-implemented hub 106 executes when evaluating transactions or other communications received from user devices 102 and/or group management processing system 104. Example rules are described throughout this disclosure.

The benefit claim records may include a benefit claim ID (which may match the benefit claim ID generated by group management module 118), which is used to correlate communications and transactions to a particular benefit award. The benefit claim records may include a total benefit award, which may include the total benefit award determined using group management module 118. The payment status may include a current status of payment, which may be used by computer-implemented hub 106 to determine when to process certain transactions. For example, computer-implemented hub 106 may pool requests from user devices 102 to transfer funds from the respective withholding cryptocurrency addresses 107(GM)(a) of the user devices 102 to the benefit cryptocurrency address 107(GM)(b) of the benefit award recipient, which may reduce transaction costs associated with recording transactions on distributed ledger 124.

Computer-implemented hub 106 may send and receive a variety of information and instructions. For example, computer-implemented hub 106 may exchange setup and configuration messages with user devices 102 and/or group management processing system 104. As another example, computer-implemented hub 106 may send and receive notifications to and from group management processing system 104, including approval notifications when group management processing system 104 approves a benefit claim request. As another example, computer-implemented hub 106 may send notifications to user devices 102. As another example, computer-implemented hub 106 may receive payment messages (e.g., signed payment transactions) from user devices 102. As another example, computer-implemented hub 106 may communicate with one or more self-executing agreements and/or with one or more cryptocurrency addresses on distributed ledger system 108.

Additional details regarding the operation of user device 102 are described throughout this disclosure.

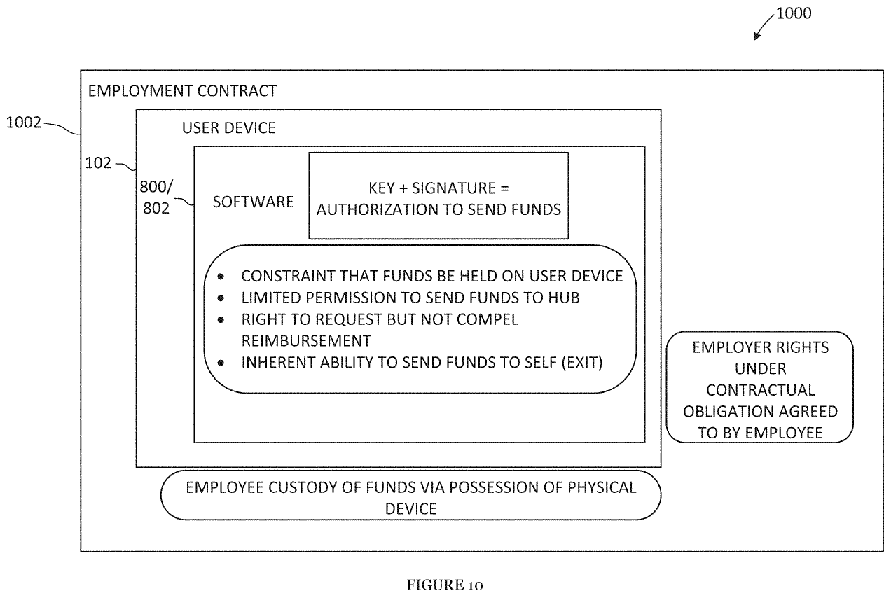

FIG. 10 illustrates an example framework 1000 of certain rights and obligations created by example system 100 for providing a group benefit using a self-executing agreement and distributed ledger, according to certain embodiments of this disclosure. System 100 and/or framework 1000 may provide a joint custody security framework for providing the group benefit. For purposes of this example, it will be assumed that the entity associated with group management processing system 104 is an employer and that a user 112 associated with a user device 102 is an employee of the employer.

An employment contract 1002 between the employee (a user 112 of a user device 102) may establish a foundational relationship between the employee and the employer. Employee custody of funds may be provided within the context of contractual obligations enforced by software, such as group member application 800 and/or cryptocurrency management module 802 on user device 102. The contractual obligations enforced on the employee by software may include holding funds to pay for future claims, crowdfunding benefit to approved claimants, requesting of reimbursement for value of the benefit upon receipt of fiat currency, and exiting of employee's funds upon expiration of a timer or upon mutual agreement (e.g., employee leaving the company).

Employer rights may be predicated on a benefit contract, which may be referred to as a pledge-to-pay contract and may be executed by both the employee and the employer. The benefit contract may be separate from or included in the employment agreement (in the latter case, either wholly included in the employment agreement or included as a separate addendum). The benefit agreement may establish the legal obligations of the employer and employees with regard to providing a group benefit using system 100. The benefit agreement may serve as the group member's (e.g., employee's) agreement with the group and the administrator's agreement with the group member. In part, the benefit agreement may include an employee's agreement to be required as a group member to crowdfund benefit awards, and also specifies the employee's privilege to submit benefit claim requests (e.g., for paid sick leave). Additionally, termination of the benefit contract may start a countdown timer to complete certain actions (e.g., reimbursement). The benefit agreement may be and/or may include group charter 704 and/or group pledge 706. The employer may have a separate benefit contract executed for each employee (user 112) that is to be a member of group 114.

A foundation of the ability to provide the benefit is the employment contract between the employer and employee, which establishes and governs the relationship between the employer and employee. In certain embodiments, a termination of employment also terminates the benefit contract (or leads to termination of the benefit contract).

In certain embodiments, an administrator may approve claims using instructions. That is, an employer may be able to send limited instructions within system 100. For example, the employer may send instructions from group management processing system 104 to user devices 102 to cause user devices 102 to crowdfund claim benefits. These instructions may be auditable off distributed ledger system 108, and payments generated in response to these instructions may be auditable on distributed ledger system 108. As another example, the employer may send instructions from group management processing system 104 to computer-implemented hub 106 to route claim benefits. These instructions may be auditable on distributed ledger system 108. As another example, the employer may send instructions from group management processing system 104 to a user device 102 to request reimbursement of a benefit claim that was paid by the employer in fiat currency. These instructions may be auditable off distributed ledger system 108, and payments generated in response to these instructions may be auditable on distributed ledger system 108. As another example, the employer may send instructions from group management processing system 104 to a user device 102 to cause the user device 102 to exit remaining funds. Payments generated in response to these instructions may be auditable on distributed ledger system 108.

Certain embodiments may place one or more limitations on the instructions the employer is permitted to send, examples of which are described below. It should be understood that the following limitations are described as examples only, and that one or more of these limitations may be omitted in certain embodiments.

An employer may be able to add new members (e.g., users 112) to group 114. In certain embodiments, adding new members may be restricted according to one or more of the following conditions. A first example condition may include that new members (users 112) be eligible to join group 114, according to any suitable restrictions. A second example condition may include that new members indicate they have read group charter 704 and signed group pledge 706. A third example condition may include that the employer/administrator is not permitted to be a member of group 114. A fourth example condition may include that a benefit claim is only paid to a new member after an initial time delay expires. A fifth example condition may include that existing members of group 114 or a designated representative can review potential additions to group 114.

Certain conditions may be placed on instructions from group management processing system 104 that govern the withholding cryptocurrency address 107(GM)(a). A first example condition may include that crowdfunded contributions (e.g., withholding amounts) from users 112 may only be sent to computer-implemented hub 106. A second example condition may include that, other than computer-implemented hub 106, a withholding cryptocurrency address 107(GM)(a) is only permitted to send funds to an exit cryptocurrency address 107(GM)(c). A third example condition may include that upon termination of employment, the employer has a legally binding contractual obligation to instruct user device 102 of the user 112 to send any remaining funds to the exit cryptocurrency address 107(GM)(c) (within a set time period).

Certain conditions may be placed on instructions from group management system 104 that govern computer-implemented hub 106. A first example condition may include that computer-implemented hub 106 not route funds to the administrator/employer. A second example condition may include that computer-implemented hub 106 not route funds to any cryptocurrency address 107 that is not associated with a member of group 114. A third example condition may include that computer-implemented hub 106 only routes funds to other members of group 114. A fourth example condition may include that funds only be routed after a claim award has been approved and an associated instruction sent to user devices 102 of users 112 of group 114 (in most cases). A fifth example condition may include that computer-implemented hub 106 only route funds after receiving the funds from a withholding cryptocurrency address 107(GM)(a). A sixth example condition may include that computer-implemented hub 106 not hold funds for longer than a preset time period (e.g., twenty-four hours). A seventh example condition may include that computer-implemented hub 106 not route payments to new members before a preset delay expires.

Certain conditions may be placed on instructions that govern the benefit cryptocurrency address 107(GM)(b) to which claim benefits may be paid. A first example condition may include that, other than the employer reimbursement cryptocurrency address 107(AD)(a), the benefit cryptocurrency address 107(GM)(b) is only permitted to send funds to an exit cryptocurrency address 107(GM)(c). A second example condition may include that an employee's consent is required before the user device 102 of the employee will send a reimbursement to the employer/administrator. A third example condition may include that the user device 102 not send funds to the administrator unless the group member application 800 verifies that user 112 of user device 102 has given consent. A fourth example condition may include that, upon termination of employment, the employer has a legally binding contractual obligation to instruct the user device 102 of the user 102 to send any remaining funds to the exit cryptocurrency address 107(GM)(c) (within set time period).

In certain embodiments, one or more issues may induce dispute resolution. Examples of such issues are described below.

A first example issue that may prompt dispute resolution may include that the employer did not approve a valid benefit claim (e.g., for paid sick leave) of a member of group 114. This dispute may be resolved directly with HR within the context of existing labor law. In certain embodiments, system 100 does not provide a fundamental guarantee that a benefit claim will be awarded to a member of group 114; only that if the benefit claim is awarded, it will be fairly paid. System 100 may provide an auditable record of the denial of a benefit claim, but the record of the denial might only be available from the employer. In certain embodiments, this type of dispute does not generate a surety claim against the employer.

A second example issue that may prompt dispute resolution may include that the employer approved a benefit claim for a member who was ineligible to receive an award for a benefit claim. This dispute may be resolved directly with HR within the context of existing labor law. Given the additional transparency that may be provided by system 100, system 100 may ease filing a complaint against an employer. System 100 may provide a transparent record on distributed ledger system 108 (on distributed ledger 124) when a benefit claim is paid to help employees file complaints when appropriate. In certain embodiments, this type of dispute can generate a surety claim against the employer.

A third example issue that may prompt dispute resolution may include that the employer did not pay the expected benefit award amount to an employee in fiat currency. This dispute may be resolved directly with HR within the context of existing labor law. System 100 may provide both parties with incentives to settle this dispute quickly for one or more reasons. First, the value of the cryptocurrency currently on the user device 102 of the employee is likely to be greater than the value of the supplemental payment to which the employee believes they are entitled. Second, the employer likely has the legal right to terminate the employee if the employee refuses to act in accordance with the contractual obligation to pay a reimbursement. Third, if the employee is wrongfully terminated because the employee refused to pay a reimbursement, then the employee potentially may file a claim against the surety bond.

A fourth example issue that may prompt dispute resolution may include that the employee refuses to pay the reimbursement they are obligated to pay. In certain embodiments, this scenario is unlikely because most employees have no visual record of this benefit being stored on user device 102. In certain embodiments, without providing a visual indication of the value of the benefit award, the UI simply requests whether the employee received the full value of the benefit award in fiat currency in the employee's paycheck (or other suitable fiat payment mechanism). If the employee confirms that receipt of the value of the benefit payment, then user device 102 (e.g., group member application 800 using an appropriate private key 804 of cryptocurrency management module 802) can initiate the reimbursement substantially immediately. Contractually, the employee previously pledged to pay this reimbursement upon receipt of an equivalent fiat value. An employee's refusal to pay may result in the lawful termination of the employee. The accounting record provided also may ease the ability to provide just cause for termination. The risk and cost of these types of events therefore may be low.

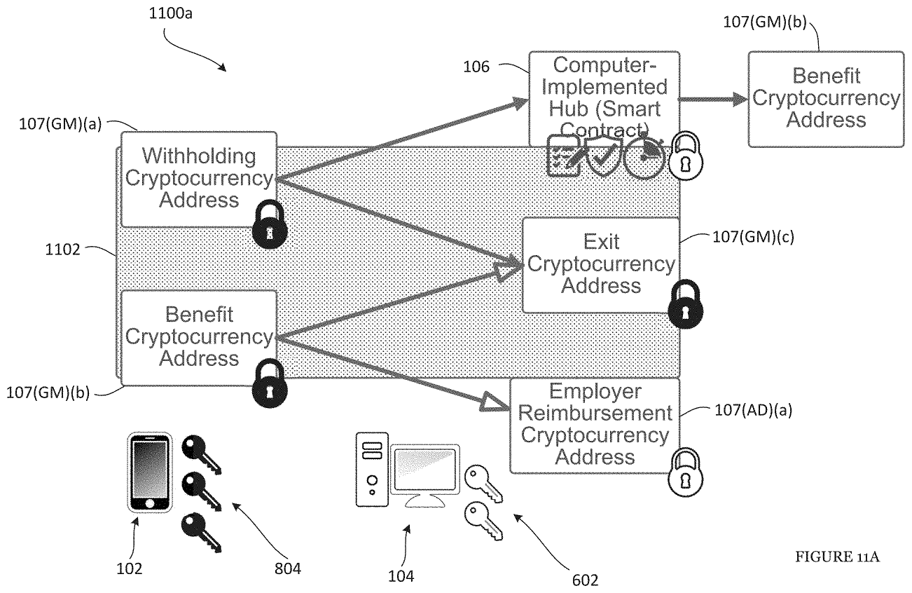

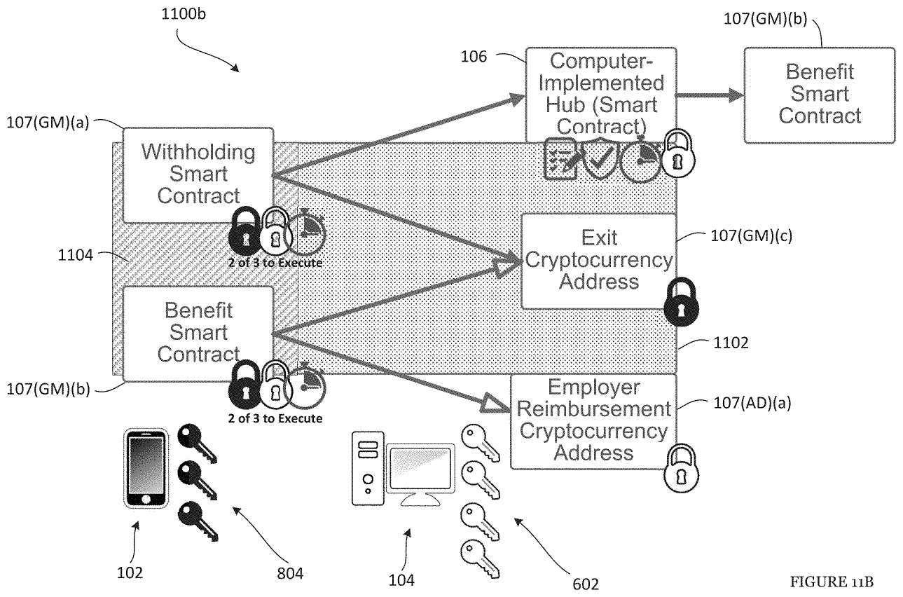

FIGS. 11A-11B illustrate logical boundaries of components of system 100 and associated custody of private keys, according to certain embodiments of this disclosure.

FIG. 11A illustrates a first example configuration 1100a of logical boundaries of components of system 100 and associated custody of private keys 602 and private keys 804, according to certain embodiments of this disclosure. In particular, region 1102 illustrates the logical boundary of group member application 800 on a user device 102 by indication of the cryptocurrency addresses 107(GM) that group member application 800 generates.

In the illustrated example, for a user device 102 and its associated user 112, region 1102 includes a withholding cryptocurrency address 107(GM)(a), a benefit cryptocurrency address 107(GM)(b), and an exit cryptocurrency address 107(GM)(c). Addresses falling outside the logical boundary defined by region 1102 include computer-implemented hub 106 (at its associated address), and an employer reimbursement cryptocurrency address107(AD)(a). Additionally, user device 102 stores private keys 804, and group management processing system 104 stores private keys 602.

FIG. 11A (as well as FIG. 11B described below) uses a shading convention to indicate a correspondence between a private key and an address. For example, black-shaded keys (private keys 804) are able to sign transactions for addresses shown with a black-shaded padlock, and unshaded keys (private keys 602) are able to sign transactions for addresses shown with an unshaded padlock. Although not referred to in FIGS. 11A-11B as an address, computer-implemented hub 106 also may have a publicly-available address. For the addresses of shown in FIGS. 11A-11B, the address may be thought of as a mailbox, the padlock may be thought of as a lock on the mailbox to prevent access to the contents of the mailbox (though, as with many physical mailboxes which include a slot to insert items into the physical mailbox without unlocking the mailbox, items (funds, such as cryptocurrency, or requests for transactions) may be added to an address without opening the lock (e.g., without having the private key for that address), and the private key may be thought of as the key to open the lock.

Possession of a private key for a particular cryptocurrency address 107 may grant the possessor of the private key authority to spend funds from the particular cryptocurrency address 107. Using a private key 804 (private key 804a, as described above with reference to FIG. 8), user device 102 may authorize transactions associated with withholding cryptocurrency address 107(GM)(a). Using a private key 804 (private key 804b, as described above with reference to FIG. 8), user device 102 may authorize transactions associated with benefit cryptocurrency address 107(GM)(b). Using a private key 804 (private key 804c, as described above with reference to FIG. 8), user device 102 may authorize transactions associated with exit cryptocurrency address 107(GM)(c). As the possessor of the private keys 804a, 804b, and 804c, user device 102 has custody of the funds located at withholding cryptocurrency address 107(GM)(a), benefit cryptocurrency address 107(GM)(b), and exit cryptocurrency address 107(GM)(c).

As indicated by the arrows emanating from withholding cryptocurrency address 107(GM)(a) and benefit cryptocurrency address 107(GM)(b), the destination address to which user device 102 may cause funds to be sent from these addresses may be limited, such as by rules encoded into computer-implemented hub 106. For example, using a private key 804 (e.g., private key 804a), user device 102 (e.g., group member application 800 and/or cryptocurrency management module 802) may transfer funds from withholding cryptocurrency address 107(GM)(a) either to computer-implemented hub 106 or exit cryptocurrency address 107(GM)(c). As another example, using a private key 804 (e.g., private key 804b), user device 102 (e.g., group member application 800 and/or cryptocurrency management module 802) may transfer funds from benefit cryptocurrency address 107(GM(b) either to exit cryptocurrency address 107(GM)(c) or employer reimbursement cryptocurrency address 107(AD)(a).

Additionally, as shown by the checklist icon, the verification checkmark, and the clock icons, in certain embodiments, computer-implemented hub 106 may enforce certain restrictions (rules) prior to executing a requested transaction, even if that transaction is signed with an appropriate private key. For example, in response to a request from user device 102, signed with the appropriate private key 804 (e.g., 804a) to transfer funds from withholding cryptocurrency address 107(GM)(a) to computer-implemented hub 106 for transfer to benefit cryptocurrency address 107(GM)(b), computer-implemented hub 106 may apply a rules checklist to the transfer request and, if appropriate, verify that the transfer request satisfies the rules. As another example, computer-implemented hub 106 may implement a time-lock on the transfer request from user device 102. To enforce the time lock, computer-implemented hub 106 waits a predetermined (or otherwise specified) amount of time from a start time before exercising the transfer request, essentially introducing a time delay. The time delay associated with the time lock may have any suitable length. For example, the delay could be a few hours, two days, a week, or any other suitable time. Additionally, the start time may be a time stamp included in the transaction request or a receipt time at which computer-implemented hub 106 received the transaction request.

FIG. 11B illustrates a second example configuration 1100b of logical boundaries of components of system 100 and associated custody of private keys 602 and private keys 804, according to certain embodiments of this disclosure. Configuration 1100b shares certain features in common with configuration 1100a, and those features are incorporated by reference without being reproduced.

In configuration 1100b, in addition to computer-implemented hub 106, both withholding cryptocurrency address 107(GM)(a) and benefit cryptocurrency address 107(GM)(b) are implemented as self-executing agreements, or smart contracts. While in this example user device 102 still has private keys 804a, 804b, and 804c (and possibly more), group management processing system 104 now has four private keys 602 to account for the additional self-executing agreements (e.g., smart contracts). In this example, the self-executing agreements of withholding cryptocurrency address 107(GM)(a) and benefit cryptocurrency address 107(GM)(b) are each configured with at least three security measures. Those security measures include user device 102 signing the transaction with an appropriate private key 804, group management processing system 104 signing the transaction with an appropriate private key 602, and a time lock. In the illustrated example, the self-executing agreements of withholding cryptocurrency address 107(GM)(a) and benefit cryptocurrency address 107(GM)(b) permit execution of requested transaction when two of the three security conditions are satisfied.

The self-executing agreement of withholding cryptocurrency address 107(GM)(a) may receive a transaction request from user device 102 (e.g., to transfer funds from the withholding cryptocurrency address 107(GM)(a) to the benefit cryptocurrency address 107(GM)(b) of another user device 102 via computer-implemented hub 106), and that transaction request may be signed with an appropriate private key 804 of user device 102. At this point, one of the three security measures is satisfied.

Continuing with this example, in response to the signed transaction request, the self-executing agreement of withholding cryptocurrency address 107(GM)(a) may start a time lock timer that is set for two days, as an example. If the time lock timer expires, the self-executing agreement of withholding cryptocurrency address 107(GM)(a) determines that two of the three security measures are satisfied and executes the requested transaction.

Continuing further with this example, prior to expiration of the time lock timer, the group administrator may use an appropriate private key 602 to either stop execution of the transaction (which also would stop the time lock timer, in one example) or authorize the requested transaction (prior to expiration of the time lock timer, essentially allowing the transaction to execute prior to execution of the time lock timer, with two of the three security measures having been satisfied). In certain embodiments, when group management processing system 104 notifies user device 102 (e.g., group member application 800) that a benefit claim request has been approved, group management processing system 104 may send a signed transaction using the appropriate private key 602, essentially pre-satisfying one of the three security measures prior to user device 102 initiating the transaction request.

Security measures for the self-executing agreement of benefit cryptocurrency address 107(GM)(b) may be processed in a similar manner.

Because, in this example, the group administrator potentially has an opportunity to affect the spending of funds at either the withholding cryptocurrency address 107(GM)(a) or the benefit cryptocurrency address 107(GM)(b), user device 102 and group management processing system 104 may be said to have a type of conditional joint custody over funds in withholding cryptocurrency address 107(GM)(a) or the benefit cryptocurrency address 107(GM)(b), as shown in region 1104.

In certain embodiments, just as the group administrator configures computer-implemented hub 106 (which may be implemented as a self-executing agreement, or smart contract), the group administrator may configure the self-executing agreements of withholding cryptocurrency address 107(GM)(a) and benefit cryptocurrency address 107(GM)(b) in configuration 1100b. This configuration may include configuring the authorized private keys 602 and 804, the time lock, and the rule that, in this example, executes when two out of three of the security conditions are satisfied.

FIG. 12 illustrates an example record 1200 that may be stored in distributed ledger 124, according to certain embodiments of this disclosure. For example, in an implementation in which distributed ledger 124 is a blockchain, record 1200 may be a block in the blockchain. Although record 1200 is illustrated and described as including particular information arranged in a particular way, this disclosure contemplates record 1200 include any suitable information arranged in any suitable way. In this illustrated example, record 1200 includes a header 1202 and a data portion 1204.

In certain embodiments, computer-implemented hub 106 is configured to trigger the generation of a record 1200 for storage in distributed ledger 124 of distributed ledger system 108. For example, computer-implemented hub 106 may trigger generation of a record 1200 for each transaction associated with group 114 that is processed use computer-implemented hub 106. A collection of records 1200 forms the record of transactions for a particular group 114 and can be analyzed to determine various information about group 114 over the life of the group's existence, including information associated with the payment of benefits.

Header 1202 includes a hash of the header of the previous record in distributed ledger 124. This disclosure contemplates the use of any suitable hash mechanism. Header 1202 includes a Merkle root, which may be a hash of all the data (e.g., which may include information and/or transactions) of the current record (record 1200). In certain embodiments, header 1202 includes a timestamp.

Data portion 1204 includes the information and/or transactions stored by record 1200. Particular embodiments of record 1200 may include none, some, or all of the information described below in connection with data portion 1204. In the illustrated example, data portion 1204 includes a group profile and transaction information. Examples of a group profile and transaction information are described below.

In certain embodiments, some or all of the group profile is sent to distributed ledger system 108 from group management processing system 104. For example, group management module 118 may access at least some of group information 122 and send that information to distributed ledger system 108 for inclusion in one or more records (e.g., record 1200) of distributed ledger 124. The group profile may include one or more of the following: a group ID and/or group name of group 114, the group membership (e.g., group members, or users 112) of group 114; and group rules associated with group 114 (including, for example, the amount of a premium; the value of a benefit claim payment (e.g., as specified in the group charter and/or as actually paid)).

The transaction information of data portion 1204 of record 1200 may include an incident claim identifier, a claimant public address, and transaction details. In this example, record 1200 relates to a transaction associated with a particular incident, and an incident identifier is stored in record 1200. A claimant public address may include the public address to which policyholders may direct finalization of payment, if appropriate. Because this particular record relates to a claim incident, the transaction recorded by record 1200 might, for example, relate to the initial notification by the secretary to self-execution agreement 106 of the incident claim or to a decision by a policyholder whether or not to finalize payment to the claimant. In the latter case, the transaction details may include the payment details, such as the policyholder address of the policyholder providing payment instructions and the payee's address (which could be the claimant's address if the policyholder's instructions are to finalize payment to the claimant. In certain embodiments, the name of the person who submitted an incident claim and/or the details of the incident associated with the incident claim are not included in record 1200; however, this disclosure contemplates record 1200 including the name of the person who submitted an incident claim and/or the details of the incident associated with the incident claim, if appropriate for a particular implementation. By analyzing a collection of records 1200 for group 114 related to the incident claim associated with the incident claim identifier, a reviewer of the public record created by the collection of records 1200 can determine information demonstrating whether or not an incident claim was paid by policyholders.

Although record 1200 relates to a benefit claim, other records 1200 associated with other aspects of group 114 might or might not relate to a benefit claim. For example, other records may pertain to transactions related to group membership, premium payment (including base premium payment and/or overpayment payment), or any other suitable transactions associated with interaction with computer-implemented hub 106 and/or distributed ledger system 108.

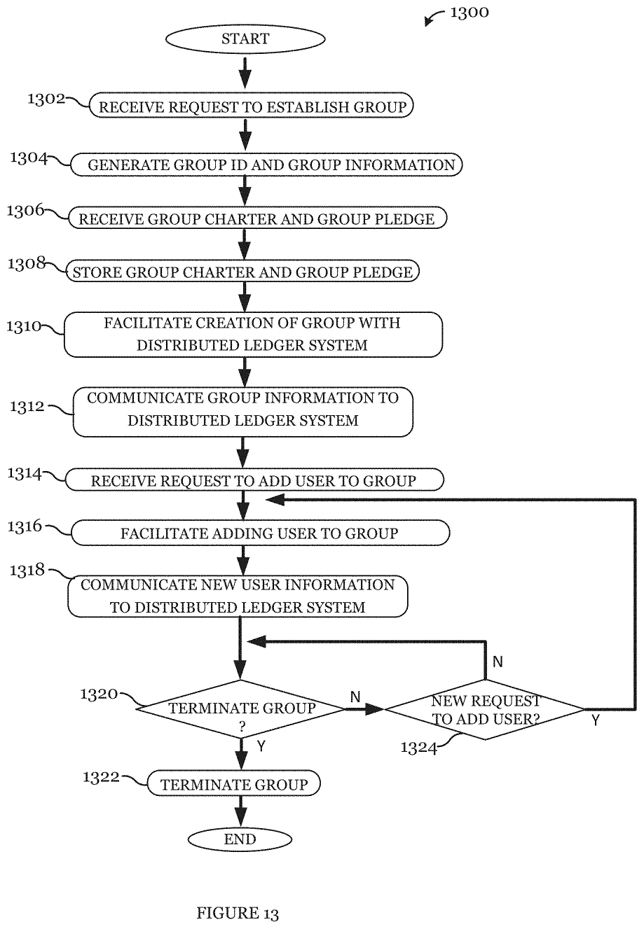

FIG. 13 illustrates an example method 1300 for forming group 114, according to certain embodiments of this disclosure. In certain embodiments, method 1300 is performed by group management processing system 104. This disclosure, however, contemplates any suitable components of system 100 performing operations associated with forming group 114.

At step 1302, group management processing system 104 receives a request to establish a group 114. For example, a user associated with the group administrator may submit the request to establish group 114 via web portal 116 or an application. At step 1304, group management processing system 104 (e.g., group management module 118) may generate a group ID 700 and associated group information 122 in storage module 120.

At step 1306, group management processing system 104 receives group charter 704 and group pledge 706. For example, the group administrator may submit group charter 704 an group pledge 706 via web portal 116 or an application. At this stage, group pledge 706 might or might not be signed.

At step 1308, group management processing system 104 stores group charter 704 and group pledge 706 in the appropriate group information 122 in storage module 120, where group charter 704 and group pledge 706 can be accessed by group members of group 114.

At step 1310, group management processing system 104 facilitates creation of group 114 with distributed ledger system 108. For example, group management module 118, through web portal 116 or an application, may provide a user associated with the group administrator with access to an interface for creating a reimbursement cryptocurrency address of group administrator (of one does not exist already). As another example, group management module 118, through web portal 116, may provide the user associated group administrator with access to an interface for establishing and configuring a computer-implemented hub 106 appropriate for implementing the objectives defined in group charter 704 for group 114. Computer-implemented hub 106 also may be linked to the account for group 114 in distributed ledger system 108. The configuration information may include at least a portion of configuration information 712 shown in FIG. 7 and/or group records 902 shown in FIG. 9.

At step 1312, group management processing system 104 communicates at least some of the information specified in group information 122 to distributed ledger system 108, such as to computer-implemented hub 106. For example, group management module 118 may automatically update computer-implemented hub 106 (and possibly group management module 118), as appropriate.

At step 1314, group management processing system 104 receives a request to add a user 112 to group 114. For example, a user of the group administrator with suitable authority may request via web portal 116 to add a particular user 112a to group 114. For example, a user of the group administrator may send an email to a particular user 112a with a link to web portal 116, through which user 112a can download group member application 800 and review and complete other suitable information (e.g., group charter 704 and/or group pledge 706) for being added to group 114. In certain embodiments, a user of group management module 118 ensures that appropriate information (e.g., a signed group pledge 706, which also may be referred to as a benefit agreement and/or confirmation of downloading of and establishment of an account using group member application 800) has been received from or verified by a user 112 before requesting that the user be added to group 114. A user of group management processing system 104 may deny adding user 112a for a variety of reasons, including failure of user 112a to submit a signed group pledge 706, failure of user 112a to confirm establishment of a user account with distributed ledger system 108, or for any other suitable reason. Because, in certain embodiments, membership and participation in group 114 may be mandatory as part of an employee's employment, someone from the group administrator may follow up and assist user 112a in resolving any issues. In certain embodiments, web portal 116 and/or group management module 118 provides functionality for sending group invites.

At step 1316, group management processing system 104 and/or group member application 800 on user device 102 facilitate adding the user 112 to group 114. For example, group management processing system 104 and/or group member application 800 may facilitate establishing an account for the user (user 112a in this example). Establishing an account for user 112a may include setting up a user name and password for the user to access features associated with group 114 (and potentially group information 122 once user 112a is added as a group member), providing user 112a with access to installing group member application 800 on the user device 102a, providing user 112b with access to and an ability to sign (e.g., possibly digitally sign) group pledge 706, and potentially providing information related to installing cryptocurrency management module 802 and obtaining keys 804, though group member application 800 may handle or assist with handing providing information related to instilling cryptocurrency management module 802 and obtaining keys 804.

In certain embodiments, web portal 116, group member application 800, and/or cryptocurrency management module 802 also facilitates user 112a establishing an account with distributed ledger system 108 (to the extent user 112a does not already have such an account). For example, web portal 116, group member application 800, and/or cryptocurrency management module 802 may provide links for user 112a to access with user device 102a suitable web sites and/or application stores for establishing an account with distributed ledger system 108 and obtaining software for interacting with distributed ledger system 108.

Group management processing system 104 may update the group information 122 for group 114 to reflect that user 112a is a group member. Obtaining group member status also may allow user 112a to access certain additional features via web portal 116 and/or group member application 800. For example, as a group member, user 112a may be able to pay premiums, pay an appropriate portion of an approved benefit claim, transfer a remaining balance (most likely zero initially) from the paid premiums, and perform other suitable actions that are accessible to group members.

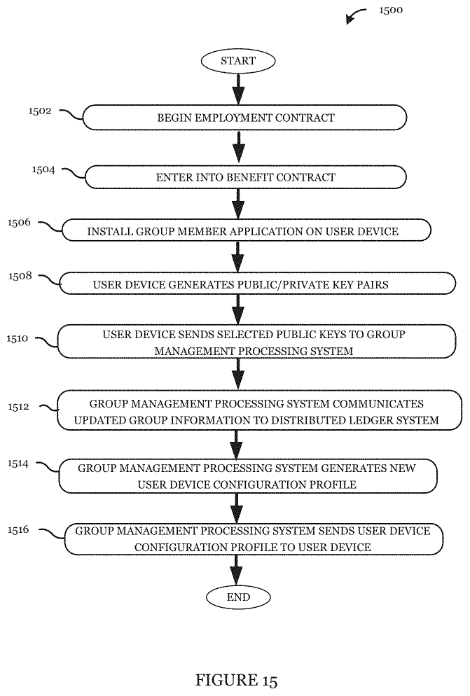

Additional details of an example embodiment for adding a user 112 to group 114 are described below with reference to FIG. 15.

At step 1318, group management processing system 104 communicates at least some of the information specified in group information 122 (including, among other information, the public addresses/keys of the new user 112) to distributed ledger system 108, such as to computer-implemented hub 106. For example, as users 112 provide information via web portal 116 and/or group member application 800, group management module 118 may automatically update computer-implemented hub 106 (and possibly group management module 118), as appropriate. As another example, users 112 may interact directly with computer-implemented hub 106, via web portal 116 or otherwise.

At step 1320, group management processing system 104 determines whether to terminate group 114. This disclosure contemplates group 114 being terminated for any suitable reason. Group management processing system 104 may be continuously open to a group termination instruction being received. If group management processing system 104 detects a group termination instruction at step 1320, then at step 1322 group management processing system 104 terminates group 114. In certain embodiments, records associated with transactions performed in association with group 114 remain stored on distributed ledger 124. After group termination at step 1322, method 1300 may end.

Returning to step 1320, if group management processing system 104 does not detect a group termination instruction, then at step 1324, group management processing system 104 may continue to monitor for a new request to add a new user 112 to group 114. If group management processing system 104 determines at step 1324 that a new request to add a new user 112 to group 114 has been received, then method 1300 returns to step 1316 to process the new request. If group management processing system 104 determines at step 1324 that no new request to add a user 112 has been received, then method 1300 may return to step 1320 to await a termination instruction. In certain embodiments, a new request to add a user 112 to group 114 may be received at any time (or at designated times), and method 1300 may enter step 1316 upon group management processing system 104 receiving such a request.

Of course, portions of method 1300 may be repeated as requests to add additional users 112 to group 114 or as other information is updated. For example, group charter 704 may be modified, which, in certain embodiments, may result in each user 112 being required to sign a new version of group pledge 706 to continue as a group member of group 114.

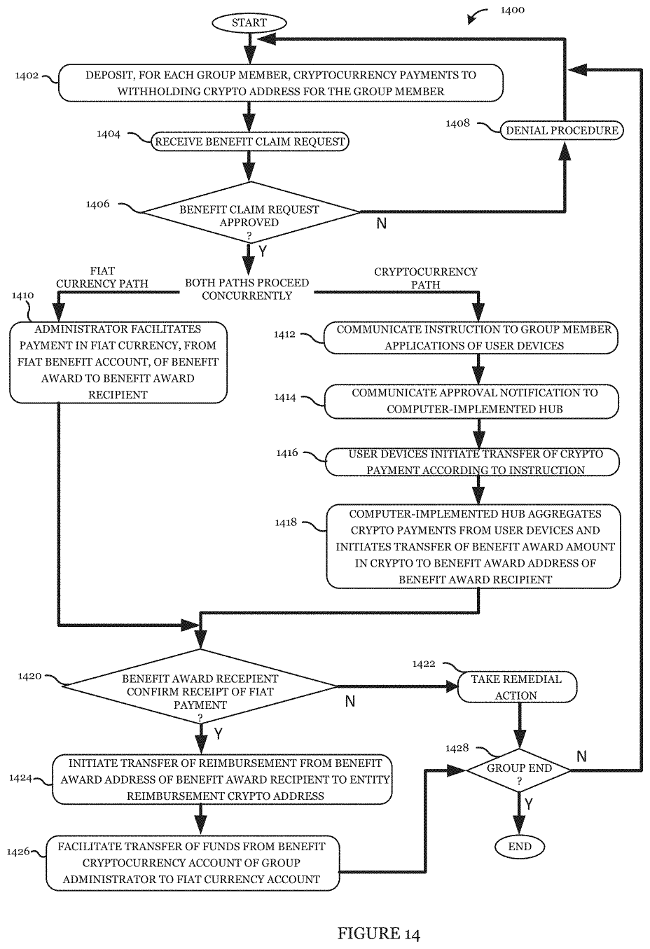

FIG. 14 illustrates an example method 1400 for providing a group benefit using a self-executing agreement and distributed ledger, according to certain embodiments of this disclosure. In certain embodiments, portions of method 1400 are performed by user devices 102, group management processing system 104, and computer-implemented hub 106. This disclosure, however, contemplates any suitable components of system 100 performing the described operations.

At step 1402, group management processing system 104 deposits, for each group member of group 114, cryptocurrency payments to a corresponding cryptocurrency address 107(GM) for the group member (e.g., to the withholding cryptocurrency address107(GM)(a) of the group member). In certain embodiments, these cryptocurrency payments are made at multiple instances. For example, instances may correspond to pay periods that occur at substantially regular intervals (e.g., biweekly or monthly). Throughout method 1400, step 1402 may be repeated as often as appropriate based on the schedule of withholdings agreed on by the group member and the group administrator.

At step 1404, a benefit claim request is received. In certain embodiments, a group member of group 114 may notify a suitable person associated with the group administrator (e.g., an HR administrator or office manager) of a benefit claim request for a benefit (e.g., paid sick leave). For example, this notification could be communicated in person, by phone, or through an appropriate software application (e.g., through HR software that manages employees' hours and attendance). In certain embodiments, group management processing system 104 receives the benefit claim request from a user device 102. The benefit claim request may include an identifier of the user 112 making the benefit claim request and a requested amount of paid sick leave (e.g., in days, hours, or another appropriate value).

At step 1406, a determination is made whether to approve the benefit claim request. In certain embodiments, group management module 118 determines whether to approve the benefit claim request. In certain embodiments, this determination involves a user associated with the group administrator (e.g., an HR administrator or office manager) reviewing the benefit claim request and making the determination. Additionally or alternatively, the determination may be substantially automated based on data associated with the benefit claim request, and possibly further based on information on file related to the group member making the benefit claim request.

If a determination is made not to approve the benefit claim request, then at step 1408, a denial procedure may be performed, after which method 1400 returns to step 1402. As part of the denial procedure, details of the denial of the benefit claim request may be recorded using group management processing system 104 (e.g., and stored in storage module 120). In certain embodiments, some or all of the handling of any dispute resolution associated with the denial of a benefit claim request may be handled by the group administrator (e.g., HR) according to normal HR policies of the group administrator (e.g., the employer). In certain embodiments, group management module 118 may send a notification to the benefit claim requester explaining why the benefit claim request was not approved.

Returning to step 1406, if the benefit claim request is approved, then method 1400 proceeds according to two concurrent paths for handling the approved benefit claim request. Although described as concurrent, these paths may be handled in any suitable order or concurrently according to particular scenarios or implementation details. One path (step 1410) corresponds to payment of the benefit claim request in fiat currency, and the other path (steps 1412-1418) corresponds to crowdfunding of the benefit claim request in cryptocurrency.

In the first path for paying the benefit award in fiat currency, at step 1410, the group administrator facilitates payment in an appropriate fiat currency of the total benefit award amount to the benefit award recipient. In certain embodiments, the fiat currency payment is made using the banking network, and could be made from a dedicated fiat benefit claim account of the group administrator. Payment of the benefit award in fiat currency causes the fiat benefit claim account to incur an operating deficit. In certain embodiments, the fiat benefit claim payment may be added to the benefit award recipient's next paycheck, but this disclosure contemplates making this fiat payment in any suitable manner. If appropriate, group management module 118 may facilitate this fiat payment.

Turning to the second path to crowdfund the benefit award in cryptocurrency, at step 1412, group management module 118 communicates an instruction to group member applications 800 of user devices 102. This instruction is designed to trigger group member applications 800 to initiate a transaction to transfer an amount of cryptocurrency from the corresponding cryptocurrency address 107(GM) that holds the accumulating funds of step 1402 (e.g., the withholding cryptocurrency address 107(GM)(a) of the group member) using the private key 804 (e.g., 804a) stored on the user device 102 to computer-implemented hub 106 for evaluation and transfer to the benefit award recipient. The instruction may include a benefit claim ID and a proposed apportioned benefit award amount (e.g., the amount this user device 102 (and its associated user 112) is being asked to pay toward the total benefit award).

In certain embodiments, as part of communicating the instruction to a group member application 800 of a particular user device 102, group management module 118 may attempt to send the instruction and determine whether the instruction was successfully received by the particular user device 102. For example, group member application 800 may be configured to transmit an acknowledgment of receipt of the instruction or the confirmation of receipt may be determined in another suitable manner. This confirmation, in part, serves as a proxy for determining whether the particular user device 102 is online. If group management module 118 determines that transmission of the instruction to the particular user device 102 failed, then, in certain embodiments, group management module 118 may attempt to resend the instruction a predetermined number of times. If group management module 118 ultimately determines that transmission of the instruction fails (potentially after a predetermined number of attempts), then group management module 118 may log the failure for manual follow up with the user 112 of the particular user device 102 by a representative of group administrator.

At step 1414, group management module 118 communicates an approval notification to computer-implemented hub 16. This notification is designed to assist computer-implemented hub 106 in evaluating transactions that computer-implemented hub 106 receives from user devices 102. The approval notification may include the benefit claim ID (e.g., the same benefit claim ID that group management module 118 included in the instruction to user devices 102), a benefit cryptocurrency address 107(GM)(b) of the benefit award recipient, and a total benefit award amount.

At step 1416, user devices 102 initiate a transfer of a cryptocurrency payment according to the instruction communicated by group management processing system 104 at step 1412 and received by user device 102. For example, group member application 800 may initiate a transfer, via computer-implemented hub 106, of a cryptocurrency payment from the withholding cryptocurrency address 107(GM)(a) of this user device 102 to the benefit cryptocurrency address 107(GM)(b) of the benefit claim recipient. If user device 102 is powered on and online, the initiation of the transfer may be automatically performed by group member application 800 and/or cryptocurrency management module 802 in response to user device 102 receiving the instruction communicated by group management processing system 104 at step 1412.

At step 1418, computer-implemented hub 106 aggregates the cryptocurrency payments requested by user devices 102 at step 1416 and initiates a transfer of the benefit award amount in cryptocurrency to the benefit cryptocurrency address of the benefit award recipient. In certain embodiments, rather than aggregating the cryptocurrency payments, computer-implemented hub 106 simply performs any suitable verifications associated with the transfers requested by user devices 102 and, assuming the verifications pass, completes the requested transfers individually.

Group management module 118 may request transaction/payment updates from computer-implemented hub 106 or a suitable third-party service for requesting blockchain transaction status. The payment update may indicate whether computer-implemented hub 106 has received a payment from all group members and, if so, whether the amount received matched the proposed apportioned benefit award amount. Additionally or alternatively, the payment update may indicate whether computer-implemented hub 106 has transferred the payments received from user devices 102 to the benefit cryptocurrency account of the benefit award recipient.

At step 1420, group member application 800 and/or group management module 118 determines whether the benefit award recipient has confirmed receipt of the payment in the appropriate fiat currency. For example, as described herein, the benefit award recipient may be presented with a notification on his or her user device 102 requesting confirmation that the benefit award recipient received the benefit award paid by the group administrator at step 1410. In certain embodiments, if the benefit award recipient confirms, via group member application 800, receipt in fiat currency of the benefit award, then group member application 800 sends a confirmation notification to group management module 118, allowing group management module to determine that the benefit award recipient confirmed receipt in fiat currency of the benefit award.

If group management module 118 determines that the benefit award recipient has not confirmed receipt of the payment in the appropriate fiat currency, the method proceeds to step 1422, at which certain remedial action may be taken, such as attempting to track down the payment in the fiat currency, authorizing the benefit award recipient to keep the funds in the benefit cryptocurrency address 107(GM(b) of the benefit award recipient, or another remedial action.

In certain embodiments, the remedial action of step 1422 may include the following. Details of the benefit award recipient's refusal to confirm receipt in fiat currency of the benefit award may be recorded (e.g., by group management module 118, potentially with input from a user associated with the group administrator and/or benefit award recipient). In certain embodiments, dispute resolution is handled outside group management module 118, and in such an embodiment group management module 118 may send the recorded details to a third-party.

In one example dispute resolution outcome, the group administrator may agree to provide a supplemental benefit in fiat currency to the benefit award recipient (e.g., in a paycheck or other format) if the initial value paid to the benefit award recipient was incorrect. To maintain employment, the benefit award recipient sends a confirmation using their user device 102, confirming that the correct benefit award amount in fiat currency was received. In certain embodiments, at this point, method 1400 essentially proceeds to step 1424.

In another example dispute resolution outcome, the benefit award recipient may keep any payment received in fiat currency and potentially any amounts at cryptocurrency addresses 107(GM)(a)-107(GM)(c), but the benefit award recipient may no longer be eligible for employment (unless the parties negotiate some other outcome). If the benefit award recipient believes they were terminated wrongfully, the benefit award recipient could potentially file a claim against the group administrator's surety bond. In certain scenarios, the surety bond may be contested and a complaint may be evaluated by a third party to determine potential damages. When membership in group 114 terminates, funds at benefit cryptocurrency address 107(GM)(b) move to exit cryptocurrency address 107(GM)(c) to be handled according to exit processing procedures.

Of course, in certain embodiments, an initial failure by a benefit award recipient to confirm receipt in fiat currency of the benefit award may be due to a misunderstanding, technical issue, or some other problem or oversight, and a follow up by group administrator (e.g., a phone call or email to the benefit award recipient) may facilitate resolving the issue such that the benefit award recipient subsequently confirms receipt, returning method 1400 to the “yes” outcome of step 1420.

Following step 1422, to the extent the outcome of the remedial action at step 1422 did not essentially return method 1400 to step 1424, method 1400 may proceed to step 1428, described below.

Returning to step 1420, if group member application 800 determines that the benefit award recipient confirmed that the benefit award was received in fiat currency, then the user device 102 (e.g., group member application 800) of the benefit award recipient may automatically initiate a reimbursement of the group administrator using the funds at the benefit cryptocurrency address 107(GM)(b) for the benefit award recipient that are tied to this benefit award. For example, group member application 800 of the benefit award recipient's user device 102 may initiate a transfer of the funds at the benefit cryptocurrency address 107(GM)(b) of the benefit award recipient to the reimbursement cryptocurrency address 107(AD)(a) of the group administrator. As a particular example, group member application 800 of the benefit award recipient's user device 102 may sign a transaction request using private key 804b, and send that signed transaction request to distributed ledger system 108 to initiate a transfer of the funds at the benefit cryptocurrency address 107(GM)(b) of the benefit award recipient to the reimbursement cryptocurrency address 107(AD)(a) of the group administrator.

In another example embodiment, if group management module 118 determines that the benefit award recipient has received the payment in the appropriate fiat currency, then group management module 118 sends an instruction to computer-implemented hub 106 to trigger reimbursement of the group administrator (transfer of funds from the benefit cryptocurrency address 107(GM)(b) of the benefit award recipient to the reimbursement cryptocurrency address 107(AD)(a) of the group administrator).

At step 1426, group management module 118 may facilitate the transfer of funds from the reimbursement cryptocurrency address 107(AD)(a) of the group administrator. This process may involve group management module 118 using a private key 602 (e.g., private key 602a) associated with the reimbursement cryptocurrency address 107(AD)(a) of the group administrator to access the funds in the reimbursement cryptocurrency address 107(AD)(a) of the group administrator and having those funds exchanged for a fiat currency. The converted funds may be deposited in a fiat-currency-based reimbursement account of the group administrator. For example, the converted funds may be deposited in the same account from which the benefit award recipient was paid, in fiat currency, for the benefit award at step 1410, which may return the fiat-currency-based account to a zero net balance.

Step 1428 represents a termination condition for method 1400 such that if group 114 disbands, method 1400 ends. If group 114 has not disbanded, then method 1400 returns to step 1402. To the extent not made clear elsewhere, it should be understood that system 100 may process multiple benefit claim requests simultaneously, such that multiple occurrences of steps 1404-1428 may be occurring simultaneously. Furthermore, to the extent an occurrence of steps 1404-1428 overlaps an appropriate time for an occurrence of step 1402 (e.g., the end of a pay period), then step 1402 may be performed without waiting for a “no” outcome” to step 1428, if appropriate for a given implementation.

FIG. 15 illustrates an example method 1500 for adding a user 112 (new group member) to group 114, according to certain embodiments of this disclosure. For purposes of this example, the group administrator is an employer, the new user 112 is a new employee of the employer and will be referred to as user 112a, and group 114 is a group of employees of the employer. This disclosure contemplates other suitable relationships between users and administrators.

At step 1502, an employment contract between the employer and user 112a begins. At step 1504, the employer and user 112a enter into a benefit contract that governs the provision of the benefit provided using system 100. In certain embodiments, the benefit contract is or includes the terms of group charter 704 and/or group pledge 706. The benefit contract may create certain obligations for user 112a, including an obligation for amounts to be withheld from wage payments to user 112a and deposited in cryptocurrency at a withholding cryptocurrency address 107(GM)(a), an obligation to crowdfund approved benefit claims, and an obligation to acknowledge reimbursement requests.

At step 1506, user 112a installs group member application 800 on user device 102 of user 112a. As described herein, user 112a may be sent (e.g., by group management processing system 104) a notification with a link to download group member application 800.

At step 1508, user device 102 may generate public/private key pairs for one or more cryptocurrency addresses 107 for use with participating in group 114. For example, group member application 800 and/or cryptocurrency management module 802 may facilitate generation of the public/private key pairs for use with participating in group 114. In certain embodiments, the addresses include a withholding cryptocurrency address 107(GM)(a) (and corresponding private key 804a), a benefit cryptocurrency address 107(GM)(b) (and corresponding private key 804b), and an exit cryptocurrency address 107(GM)(c) (and corresponding private key 804c). This disclosure, however, contemplates implementing participation in group 114 using any suitable number of cryptocurrency addresses 107 and corresponding private keys 804.

At step 1510, user device 102 (e.g., group member application 800) sends selected public keys to group management processing system 104. For example, user device 102 may send one or more of the public keys generated at step 1508 to group management processing system 104. In certain embodiments, user device 102 sends the withholding cryptocurrency address 107(GM)(a) and the benefit cryptocurrency address 107(GM)(b) to group management processing system 104, which will inform a user associated with the group administrator of where to transfer the withholding amounts for that user 112a and where to instruct computer-implemented hub 106 to route payment of an approved benefit claim for that user 112a.

At step 1512, group management processing system 104 communicates updated group information to distributed ledger system 108 (e.g., to computer-implemented hub 106). For example, the updated group information may inform computer-implemented hub 106 of the new group member (user 112a), including sending some or all of the addresses (e.g., public keys) received by group management processing system 104 at step 1510. Group management processing system 104 also may inform user devices 102 of the new group member and any associated information.

In certain embodiments, a new member delay timer for the new group member is started on computer-implemented hub 106. Computer-implemented hub 106 may enforce a rule prevent the new group member from executing transactions via computer-implemented hub 106 until the timer expires. In other words, this new member delay timer ensure that a new group member is a group member for a predetermined time period prior to permitting the new group member to execute transactions using computer-implemented hub. In certain embodiments, the new member delay timer merely prevents the new group member from submitting benefit claim requests but still allows the new group member to crowdfund approved benefit claim requests of other group members.

At step 1514, group management processing system 104 generates a new user device configuration profile for user 112a. At step 1516, group management processing system 104 sends the new user device configuration profile to the user device 102a of user 112a. This user device configuration profile configures certain parameters/behavior of group member application 800 on the user device 102a. In certain embodiments, this user device configuration profile enforces one or more obligations on user 112a through configuration of group member application 800. These obligations may include holding of funds, crowdfunding of approved benefit awards, acknowledgment of reimbursement requests, and exiting of funds from cryptocurrency addresses 107 upon termination. Method 1500 then ends.

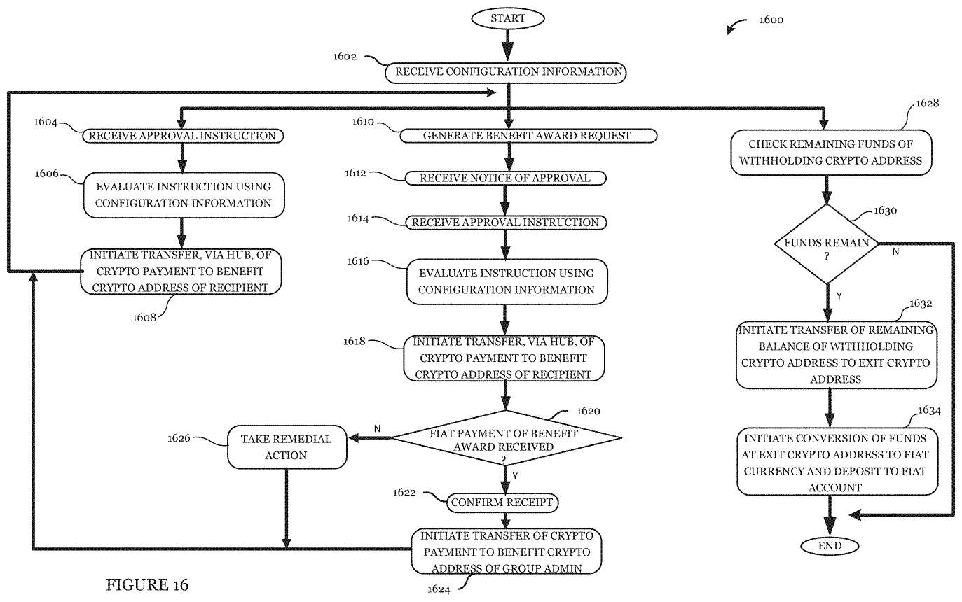

FIG. 16 illustrates an example method 1600 for providing a group benefit using a self-executing agreement and distributed ledger, according to certain embodiments of this disclosure. In certain embodiments, method 1600 is performed by user device 102. This disclosure, however, contemplates any suitable components of system 100 performing the described operations.

For ease of description for purposes of method 1600, it will be assumed that the user 112 is user 112a and that the user device 102 of user 112a is user device 102a. For purposes of method 1600, it will be assumed that group member application 800 and cryptocurrency management module 802 have already been installed on user device 102a. Additionally, it will be assumed that withholding cryptocurrency address 107(GM)(a) and associated private key 804a have been generated, that benefit cryptocurrency address 107(GM)(b) and associated private key 804b have been generated, and that exit cryptocurrency address 107(GM)(c) and associated private key 804c have been generated. Additionally, it will be assumed that private key 804a, private key 804b, and private key 804c are stored on user device 102a using cryptocurrency management module 802. Further, it will be assumed that group management processing system 104 (e.g., group management module 118) has been sending withholding amounts to withholding cryptocurrency address 107(GM)(a) of user 112a/user device 102a. As described previously, withholding cryptocurrency address 107(GM)(a) of user 112a/user device 102a correlates with a private key 804a stored on user device 102a.

At step 1602, user device 102a receives configuration information or updated configuration information, from group management processing system 104 for example. In certain embodiments, the configuration information includes the number of group members in group 114, the maximum allowable benefit award value, the maximum number of sick days that can be requested at a time, the largest possible daily benefit rate of any group member, and/or any other suitable information.

At this point, user device 102a may proceed down any of multiple paths, depending somewhat on the events of other group members and somewhat on user 112a of user device 102a. For purposes of this example, three options are provided and will be described from left to right. In particular, steps 1604-1608 correspond to a scenario in which user device 102a crowdfunds an approved benefit claim of another member of group 114, steps 1610-1626 correspond to a scenario in which user 112a of user device 102a is the recipient of an approved benefit award, and steps 1628-1634 correspond to a scenario in which user 112a of user device 102a exits group 114.

At step 1604, user device 102a (e.g., group member application 800) may receive an approval instruction from group management processing system 104, notifying user device 102a that a benefit award has been approved. The approval instruction may include a benefit claim ID and a proposed apportioned benefit award amount (e.g., the amount this user device 102a (and its associated user 112a) is being asked to pay toward the total benefit award).

At step 1606, user device 102a may evaluate information from the approval instruction according to the configuration information received at step 1602.

As a first example, user device 102a may determine whether the particular proposed apportioned benefit award amount does not exceed a maximum allowable value. In a context in which the benefit is for paid sick leave, the maximum allowable value may be captured as one or more of a maximum allowable number of sick days that can be awarded in a single benefit award (e.g., five days) and/or a maximum possible daily benefit rate of any particular group member, for example. In certain embodiments, group member application 800 may perform the following calculation: (Maximum allowable number of sick days*the daily benefit amount)/current number of group members=maximum expected daily benefit amount. Group member application 800 may then determine whether the proposed apportioned benefit award amount is less than or equal to the maximum expected benefit amount. If the proposed apportioned benefit award amount does not exceed the maximum expected benefit amount, then group member application 800 may initiate the transfer of the proposed apportioned benefit award amount (or another amount, as described below).

As another example, group member application 800 may access the private key 804a for the withholding cryptocurrency address 107(GM)(a) of user 112a associated with user device 102a, and use the private key to determine the current balance of withholding cryptocurrency address 107(GM)(a). Group member application 800 may determine whether the proposed apportioned benefit award amount exceeds the current balance of the withholding cryptocurrency address 107(GM)(a) for user device 102a. If the proposed apportioned benefit award amount does not exceed the current balance of the withholding cryptocurrency address 107(GM)(a) for user device 102a, then group member application 800 may initiate the transfer of the proposed apportioned benefit award amount.

If the proposed apportioned benefit award amount exceeds the current balance of the withholding cryptocurrency address 107(GM)(a) for user device 102a, then group member application 800 may initiate the transfer of the remaining balance of the withholding cryptocurrency address 107(GM)(a) for user device 102a (or of a lesser amount, depending on the implementation). In this scenario, group member application 800 may notify computer-implemented hub 106 (e.g., as part of the signed transaction that includes the transfer request) that the transfer amount authorized by the signed transaction request is less than the proposed apportioned benefit award amount due to insufficient funds being available in the withholding cryptocurrency address 107(GM)(a) of user device 102a.

If group member application 800 on user device 102a determines that the instruction from group management module 118 is not valid for some reason, in certain embodiments, group member application 800 on user device 102a may send an error report or other suitable notification to group management module 118 or another destination associated with the group administrator. This error report or other suitable indication may specify why the instruction failed.

At step 1608, group member application 800 of user device 102a initiates a transfer, via computer-implemented hub 106, of a cryptocurrency payment from the withholding cryptocurrency address 107(GM)(a) of user device 102a to the benefit cryptocurrency address 107(GM)(b) of the benefit award recipient (in this case, another user device 102). The particular amount for which the transfer is initiated may vary according to the terms of group charter 704 or other group administrator policy, as well as according to the above determinations made by group member application 800. In certain embodiments, group member application 800 automatically handles this transaction request without intervention from user 112a, as user 112a previously consented to this transaction request as part of the benefit agreement. Following step 1608, method 1600 may return to a waiting state for a next step.

Assuming the next step is step 1610, at step 1610, group member application 800 of user device 102a may facilitate generating a benefit claim request. The benefit claim request may include an identifier of user 112a and a requested amount of paid sick leave (e.g., in days, hours, or another appropriate value). At step 1612, group member application 800 of user device 102a may receive a notice of approval of the benefit claim request, from group management module 118. The notice of approval may be a message that group management module 118 sends to a user device 102 for which a benefit claim request is approved (e.g., the group administrator has approved a paid sick leave claim made by the user 112 associated with that user device 102).

In certain embodiments, steps 1610-1612 may be performed by user 112 contacting HR (or another suitable individual or group associated with the group administrator) using traditional HR software, in person, or by phone, potentially outside the context of group member application 800 and/or group management processing system 104, and receiving the notice of approval (or denial) through that mechanism.

At step 1614, group member application 800 may receive an approval instruction from group management module 118. This approval instruction may correspond to the instruction described above with reference to step 1412 of FIG. 14. The instruction may include a benefit claim ID and a proposed apportioned benefit award amount (e.g., the amount user device 102a (and its associated user 112a) is being asked to pay toward the total benefit award).

At step 1616, group member application 800 evaluates the instruction using configuration information received at step 1602. This evaluation may be substantially similar to the evaluation described above with reference to step 1606.

At step 1618, group member application 800 initiates a transfer, via computer-implemented hub 106, of a cryptocurrency payment from the withholding cryptocurrency address 107(GM)(a) of user device 102a to the benefit cryptocurrency address 107(GM)(b) of the benefit award recipient (in this case, also user device 102a). The particular amount for which the transfer is initiated may vary according to the terms of group charter 704 or other group administrator policy, as well as according to the above determinations made by group member application 800.

At step 1620, group member application 800 may receive an indication (e.g., from user 112a of user device 102a) of whether user 112a of user device 102a received a payment in fiat currency (e.g., in a paycheck of the user 112a) of the benefit award. For example, group member application 800 may prompt user 112a, using a pop-up notification as a particular example, to indicate whether user 112a received the payment in fiat currency of the benefit award. If the indication indicates that user 112a of user device 102a received a payment in fiat currency of the benefit award, group member application 800 of user device 102a transmits at step 1622 a confirmation of receipt to group management module 118.

At step 1624, group member application 800 of user device 102a initiates, using an appropriate private key 804b, a transfer of the cryptocurrency at the benefit cryptocurrency address 107(GM)(b) of user device 102a (which may have received a payment in cryptocurrency from the withholding cryptocurrency addresses 107(GM)(a) of some or all group members of group 114 via computer-implemented hub 106) to a reimbursement cryptocurrency address 107(AD)(a) of the group administrator. In certain embodiments, this transfer may be initiated automatically, without intervention by user 112a, by group member application 800 of user device 102a in response to user 112a confirming receipt of the benefit award amount in fiat currency, as user 112a previously consented to this transaction request as part of the benefit agreement and by confirming receipt of the fiat currency covering the benefit award. This transferred cryptocurrency may reimburse, partially or wholly, the group administrator for the payment in fiat currency of the benefit award received/confirmed at step 1620. Additionally, in certain embodiments, the transfer of this cryptocurrency from the benefit cryptocurrency address 107(GM)(b) of user device 102a returns the benefit cryptocurrency address 107(GM)(b) of user device 102a to a zero balance and reduces or eliminates an operating deficit from a fiat currency benefit fund of the group administrator.

In certain embodiments, steps 1622-1624 may be combined such that the transfer of the cryptocurrency at the benefit cryptocurrency address 107(GM)(b) of user device 102a to the reimbursement cryptocurrency address 107(AD)(a) of the group administrator confirms to the group administrator that payment of the benefit award amount in fiat currency was received by user 112a.

Returning to step 1620, if the indication indicates that user 112a of user device 102a has not received a payment in fiat currency of the benefit award (or user 112a fails to respond to the notification requesting confirmation of receipt of the benefit award in fiat currency), method 1600 proceeds to step 1626, at which certain remedial action may be taken, such as attempting to track down the payment in the fiat currency, authorizing the benefit award recipient to keep the funds in the benefit cryptocurrency address 107(GM)(b) of the benefit award recipient, or another remedial action. Such remedial action may include dispute resolution. Following step 1626, method 1600 may return to a waiting state for a next step.

Assuming the next step is step 1628 (to begin an exit of user 112a from group 114), at step 1628, group member application 800 of user device 102a checks the remaining balance of the withholding cryptocurrency address 107(GM)(a) of user device 102a. Based on the results of step 1628, group member application 800 determines at step 1630 whether funds remain in the withholding cryptocurrency address 107(GM)(a) of user device 102a.

If group member application 800 determines at step 1630 that funds do not remain in the withholding cryptocurrency address 107(GM)(a) of user device 102a, then the method 1600 ends.

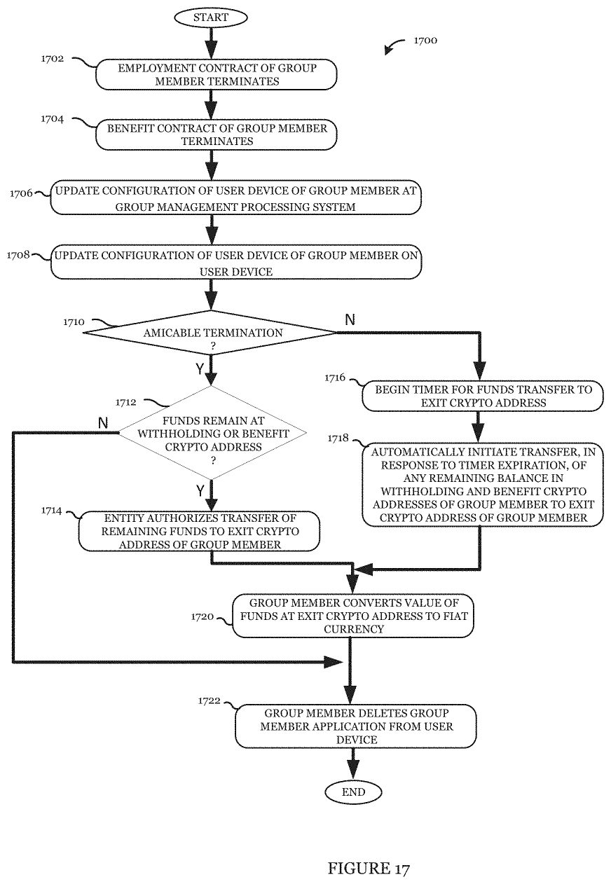

If group member application 800 determines at step 1630 that funds remain in the withholding cryptocurrency address 107(GM)(a) of user device 102a, then method 1600 proceeds to step 1632, at which group member application 800 initiates a transfer, using private key 804b of the remaining balance at the withholding cryptocurrency address 107(GM)(a) to an exit cryptocurrency address 107(GM)(c). Furthermore, in certain embodiments, using private key 804c, group member application 800 may facilitate exchanging the cryptocurrency in the exit cryptocurrency address 107(GM)(c) of the user device 102a to a fiat currency and depositing the converted funds to a fiat currency account of the user 112a of user device 102a. In certain embodiments, one or more of these transactions may be initiated automatically, without intervention from user 112a, by group member application 800, as user 112a previously consented to these transactions as part of the benefit agreement. Additional details of an example exit process are described below with reference to FIG. 17.

Steps 1628-1634 generally coincide with user 112a leaving group 114, obtaining a refund of any remaining funds that user 112a has contributed (any remaining funds in the withholding cryptocurrency address 107(GM)(a) determined at step 1628). Following step 1634, method 1600 may end.

FIG. 17 illustrates an example method 1700 for a group member exiting group 114, according to certain embodiments of this disclosure. For purposes of this example, it will be assumed that the group member exiting group 114 is user 112a with a corresponding user device 102a. Furthermore, it will be assumed that the group administrator is an employer of user 112a.

At step 1702, the employment contract of the group member (user 112a) terminates. The employment contract may terminate because user 112a is fired or otherwise terminated by the employer, user 112a gives notice or otherwise terminates the employment, the employer dissolves, or for any other suitable reason.

At step 1704, the benefit contract for user 112a terminates. In certain embodiments, the benefit contract specifies that termination of the employment contract of user 112a also terminates the benefit contract for user 112a. In certain embodiments, the benefit contract may provide that user 112a is entitled to any remaining funds at withholding cryptocurrency address 107(GM)(a) of user 112a upon termination of the employment contract and/or benefit contract (which, in certain embodiments, may be included as part of a same contract or a main contract and a supplement, for example).

At step 1706, group management processing system 104 updates a user device configuration profile for user 112a and associated user device 102a. In certain embodiments, this updated configuration profile prohibits group management module 118 from instructing user device 102a to transfer funds from withholding cryptocurrency address 107(GM)(a) of user 112a to a benefit cryptocurrency address 107(GM)(b) of a benefit award recipient and/or prohibits group member application 800 from initiating a transaction to transfer funds from withholding cryptocurrency address 107(GM)(a) of user 112a to a benefit cryptocurrency address 107(GM)(b) of a benefit award recipient. For example, because the benefit contract for user 112a has terminated, user 112a no longer has an obligation to crowdfund benefit awards.

At step 1708, group management processing system 104 sends the updated user device configuration profile to the user device 102a of user 112a. This user device configuration profile configures certain parameters/behavior of group member application 800 on user device 102a. In certain embodiments, this updated configuration profile prohibits group member application 800 from initiating a transaction to transfer funds from withholding cryptocurrency address 107(GM)(a) of user 112a to a benefit cryptocurrency address 107(GM)(b) of a benefit award recipient.

Step 1710 reflects that, in certain embodiments, different acts/operations may be performed dependent on whether the termination of employment of user 112a was amicable.

If the termination is amicable, then method 1700 may proceed to step 1712. At step 1712, group member application 800 or group management module 118 determines whether funds remain at the withholding cryptocurrency address 107(GM)(a) or benefit cryptocurrency address 107(GM)(b) of user 112a/user device 102a. If group member application 800 or group management module 118 determines at step 1712 that funds do not remain at the withholding cryptocurrency address 107(GM)(a) or benefit cryptocurrency address 107(GM)(b) of user 112a/user device 102a, then method 1700 proceeds to step 1722, described below.

If group member application 800 or group management module 118 determines at step 1712 that funds remain at the withholding cryptocurrency address 107(GM)(a) or benefit cryptocurrency address 107(GM)(b) of user 112a/user device 102a, then at step 1714, group management module 118 can instruct group member application 800 to initiate (potentially substantially immediately or at a scheduled time, such as the employee's last day of employment) a transfer of any remaining funds at the withholding cryptocurrency address 107(GM)(a) and benefit cryptocurrency address 107(GM)(b) of user 112a/user device 102a to the exit cryptocurrency address 107(GM)(c) of user 112a/user device 102a. For example, group management module 118 may send an instruction to group member application 800 on user device 102a that causes group member application 800 to initiate a transaction via distributed ledger system 108 to transfer any remaining funds at either or both of withholding cryptocurrency address 107(GM)(a) (using private key 804a) and benefit cryptocurrency address 107(GM)(b) (using private key 804b) to exit cryptocurrency address 107(GM)(c) of user 112a/user device 102a. Alternatively, steps 1712 and 1714 could be performed entirely by group member application 800 based on updated configuration information received at step 1708. The method then proceeds to step 1720, described below.

Returning to step 1710, if the termination is not amicable, then method 1700 may proceed to step 1716. At step 1716, a timer begins for transferring any remaining funds at the withholding cryptocurrency address 107(GM)(a) and benefit cryptocurrency address 107(GM)(b) of user 112a/user device 102a to the exit cryptocurrency address 107(GM)(c) of user 112a/user device 102a. In certain embodiments, the timer executes on group management processing system 104 (e.g., by group management module 118). In certain embodiments, the timer executes on user device 102a (e.g., by group member application 800).

At step 1718, in response to expiration of the timer of step 1716, a transfer of any remaining balance at withholding cryptocurrency address 107(GM)(a) and benefit cryptocurrency address 107(GM)(b) of user 112a/user device 102a to exit cryptocurrency address 107(GM)(c) of user 112a/user device 102a is automatically initiated by group management module 118 and/or group member application 800. For example, if group management module 118 executes the timer, upon expiration of the timer group management module 118 may send an instruction to group member application 800 to cause group member application 800 to initiate a transfer of any remaining balance at withholding cryptocurrency address 107(GM)(a) and benefit cryptocurrency address 107(GM)(b) of user 112a/user device 102a to exit cryptocurrency address 17(GM)(c) of user 112a/user device 102a. As another example, if group member application 800 executes the timer, upon expiration of the timer group member application 800 to initiate a transfer of any remaining balance at withholding cryptocurrency address 107(GM)(a) and benefit cryptocurrency address 107(GM)(b) of user 112a/user device 102a to exit cryptocurrency address 107(GM)(c) of user 112a /user device 102a.

At step 1720, user 112a/user device 102a facilitates converting the value of funds at exit cryptocurrency address 107(GM)(c) to fiat currency. The manner in which this occurs may vary depending on whether the termination is amicable.

For an amicable termination, user 112a may authorize sending remaining funds at exit cryptocurrency address 107(GM)(c) (e.g., using a transaction signed with private key 804c) to a cryptocurrency address of the group administrator, and the group administrator may send fiat currency of equal or greater value to the employee (e.g., as a distinct payment or part of a severance payment, for example). To the extent such payment is not automatically directly deposited in a bank account of user 112a, user 112a may then deposit the payment (if desired), completing conversion to fiat currency.

For a non-amicable termination, an authorized third-party exchange service may be notified (e.g., by group management module 118 or a representative of group administrator) of a user 112a needing conversion of funds, and the third-party exchange service may contact user 112a to facilitate converting the value of the remaining balance at exit cryptocurrency address 107(GM)(c) to fiat currency. User 112a may open an account with the third-party exchange service and linked to a bank account of user 112a. User 112a may authorize sending remaining funds at exit cryptocurrency address 107(GM)(c) (e.g., using a transaction signed with private key 804c) to a cryptocurrency address of the third-party exchange service, and the third-party exchange service may transfer the appropriate amount of fiat currency to the bank account of user 112a, completing the exchange to fiat currency.

At step 1722, user 112a may delete group member application 800 from user device 102a. Method 1700 may then end.

Although this disclosure describes particular techniques for handling disbursement of funds at termination of employment, this disclosure contemplates system 100 handling disbursement of funds in any suitable manner. Furthermore, although different acts/operations are described depending on whether or not the termination is amicable, this disclosure contemplates the same acts/operations being performed for both amicable and non-amicable terminations.

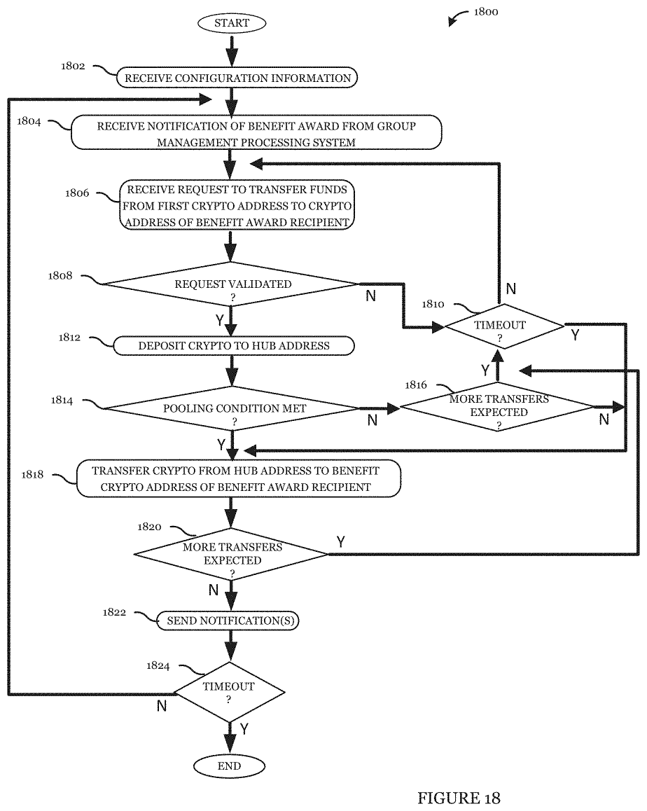

FIG. 18 illustrates an example method 1800 for providing a group benefit using a self-executing agreement and distributed ledger, according to certain embodiments of this disclosure. In certain embodiments, method 1800 is performed by computer-implemented hub 106. Thus, in certain embodiments, method 1800 is performed on distributed ledger system 108. This disclosure, however, contemplates any suitable components of system 100 performing the described operations.

At step 1802, computer-implemented hub 106 receives configuration information or updated configuration information, from group management processing system 104 for example. In certain embodiments, the configuration information includes a public key address (one or more of cryptocurrency addresses 107(AD)) of group administrator, the number of group members in group 114, public key addresses (one or more of cryptocurrency addresses 107(GM)) of current active group members of group 114, public key addresses (one or more of cryptocurrency addresses 107(GM)) of new group members, public key addresses (one or more of cryptocurrency addresses 107(GM)) of previous group members of group 114, information regarding how to calculate premium amount for each group member, the maximum number of sick days that can be requested at a time, and/or any other suitable information.

At step 1804, computer-implemented hub 106 may receive a notification from group management processing system 104 notifying computer-implemented hub 106 that a benefit award has been approved. The approval notification may include a benefit claim ID (which may match a benefit claim ID that group management processing system 104 sends to user devices 102 to facilitate correlation of payments and communications), an identifier of the benefit award recipient (e.g., a public address, such as benefit cryptocurrency address 107(GM)(b) of the benefit award recipient), and a value of the benefit award to be paid.

At step 1806, computer-implemented hub 106 receives from a user device 102 a request to transfer a cryptocurrency payment from the withholding cryptocurrency address 107(GM)(a) of that user device 102 to the benefit cryptocurrency address 107(GM)(b) of the benefit award recipient. In certain embodiments, the request includes a benefit claim ID, a signed transaction (e.g., signed using private key 804a for the withholding cryptocurrency address 107(GM)(a) associated with that user device 102), the value of the cryptocurrency payment sent, and a sent timestamp.

At step 1808, computer-implemented hub 106 may determine whether the received transaction request is validated, which may include making one or more determinations.

As a first example, computer-implemented hub 106 may determine whether the benefit claim ID included in the request matches an open benefit claim ID for which computer-implemented hub 106 is accepting payments. To the extent the transaction request does not include any identifying information of the benefit award recipient (e.g., because in certain embodiments the user device 102 might not be provided information regarding the identity of the benefit award recipient), the benefit claim ID may be used by computer-implemented hub 106 to determine a benefit cryptocurrency address 107(GM)(b) of the benefit award recipient.

As another example, computer-implemented hub 106 may determine whether the specified value of the cryptocurrency payment sent (e.g., from the withholding cryptocurrency address 107(GM)(a) for the user device 102) matches an expected value. As a particular example, computer-implemented hub 106 may verify that the amount received from user device 102 meets the following condition: received amount from user device 102=total benefit award amount/the number of group members in group 114. This particular comparison assumes that the payment that computer-implemented hub 106 expects to receive from each user device 102 is divided equally among the group members of group 114 (expected payment=total benefit award amount/number of group members), which might or might not be the case for a given implementation. Thus, the expected payment for a particular group member could be determined in any suitable manner. In certain embodiments, the expected payment for a particular group member (user device 102) equals the proposed apportioned benefit award amount for that group member (user device 102).

As another example, if the payment received from a user device 102 is less than the proposed apportioned benefit award amount for that user device 102 (which may be treated as the expected received payment), then computer-implemented hub 106 may have received a notification from that user device 102 that this would be the case, or computer-implemented hub 106 may make this determination on its own.

If computer-implemented hub 106 determines that the received payment from a user device 102 differs from the expected received payment, then computer-implemented hub 106 may send a notification to group management module 118. This may allow the group administrator to address any deficiency in a suitable manner, if desired.

Other rules that may be enforced by computer-implemented hub 106 may include enforcing a time-lock on transferring funds from the respective withholding cryptocurrency addresses 107(GM)(a) of users 112, enforcing a minimum membership time for the benefit claim requestor, and any other suitable rules.

For example, certain embodiments may implement a time lock, which introduces a delay before a transaction signed with the appropriate private key is completed. The time lock may provide an opportunity for the proper owner of the private key (e.g., the user 112 of the user device 102 on which the private key is store) to intervene if that owner did not authorize or expect the transaction (e.g., possibly because the private key was compromised), thereby potentially enhancing security of the system.

As another example, enforcing a minimum membership time for the benefit claim requestor may include requiring that a benefit claim requestor be a group member for a certain amount of time (e.g., at least two weeks) before being eligible to receive payment for a benefit award, which may limit the opportunity for fraud in the system, such as by the group administrator adding and immediately paying awarding a benefit claim to an individual who should not be a group member.

If computer implemented hub 106 determines at step 1808 that the transfer request is not validated, then computer-implemented hub 106 may wait for additional transfer requests. To that end, a timeout check may be performed at step 1810 to determine whether the time has expired for user devices 102 to submit transaction requests for this benefit claim ID. If the time has not expired, then computer-implemented hub 106 may continue to wait for new requests to transfer funds at step 1806. If the time has expired, then the method may proceed to step 1818, described below.

Returning to step 1808, if computer-implemented hub 106 determines at step 1808 that the transfer request is validated, then computer-implemented hub 106 may deposit the cryptocurrency funds that are the subject of the request to a cryptocurrency address 107 of computer-implemented hub 106.

At step 1814, computer-implemented hub 106 may determine whether a pooling condition is met. The pooling condition could be dictated by the value of the funds in the hub cryptocurrency address, the percentage of group members who have submitted validated requests to transfer funds from their respective withholding cryptocurrency addresses 107(GM)(a) (e.g., which could be any suitable percentage), or any other suitable criteria. Pooling may be implemented to reduce or minimize fees associated with performing transactions in distributed ledger system 108.

If computer-implemented hub 106 determines that the pooling condition is not met at step 1814, then computer-implemented hub 106 may wait for additional transfer requests at step 1816. If more transfer requests are expected, computer-implemented hub 106 again use a timeout determination at step 1810. If more transfer requests are not expected at step 1816, then method 1800 may proceed to step 1818, described below. In certain embodiments, group management processing system 104 (or a suitable person associated with the group administrator) may monitor computer-implemented hub 106 and send a report to the group administrator for manual follow up, if appropriate. In such case, depending on implementation, computer-implemented hub 106 might or might not be configured to proceed to step 1818 if additional transfer requests are expected but have not been received.

Returning to step 1814, if computer-implemented hub 106 determines at step 1814 that the pooling condition is met, then at step 1818 computer-implemented hub 106 may transfer the cryptocurrency funds from the cryptocurrency address 107 of computer-implemented hub 106 to the benefit cryptocurrency address 107(GM)(b) of the benefit award recipient.

At step 1820, computer-implemented hub 106 determines whether more cryptocurrency transfer requests are expected. For example, the pooling condition may be met before all cryptocurrency transfer requests from user devices 102 are received for a given benefit claim ID, so if computer-implemented hub 106 determines at step 1820 that more transfer requests are expected, then computer-implemented hub 106 may return to steps 1810 and 1806 to await additional transfer requests. If computer-implemented hub 106 determines that no further transfer requests are expected for this benefit claim ID, then method 1800 may proceed to step 1822.

At step 1822, computer-implemented hub 106 may send suitable status notifications to one or more of user devices 102 and/or group management processing system 104. Additionally or alternatively, group management module 118 may request transaction/payment updates from computer-implemented hub 106 or a suitable third-party service for requesting blockchain transaction status. The payment update may indicate whether computer-implemented hub 106 has received a payment from all group members and, if so, whether the amount received matched the proposed apportioned benefit award amount. Additionally or alternatively, the payment update may indicate whether computer-implemented hub 106 has transferred the payments received from user devices 102 to the benefit cryptocurrency account of the benefit award recipient.

Computer-implemented hub 106 may then await a notification from group management processing system 104 of a new benefit award, implementing a timeout check (at step 1824) in the process. If a timeout occurs, method 1800 may end. Otherwise, method 1800 may return to step 1804.

Although this disclosure describes certain method steps as occurring in a particular order, it should be understood that the steps may be performed in any suitable order, according to particular implementations, including simultaneously or in a different order than the order described. Furthermore, the methods may include additional or fewer steps than those described.

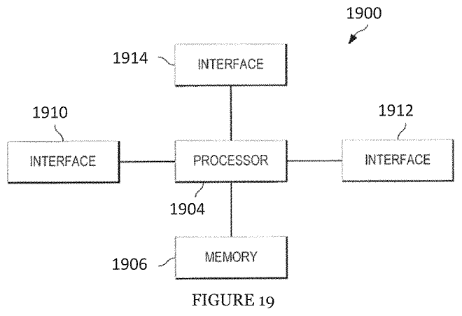

FIG. 19 illustrates a block diagram of an example processing system 1900, according to certain embodiments of this disclosure. Processing system 1900 may be configured to perform methods described in this disclosure, and may be installed in a host device. As shown, processing system 1900 includes a processor 1904, a memory 1906, and interfaces 1910-1914, which may (or may not) be arranged as shown in FIG. 19. Processor 1904 may be any component or collection of components adapted to perform computations and/or other processing related tasks, and the memory 1906 may be any component or collection of components adapted to store programming and/or instructions for execution by processor 1904. In an embodiment, memory 1906 includes a non-transitory computer readable medium. The computer-readable non-transitory media includes all types of computer readable media, including magnetic storage media, optical storage media, and solid-state storage media and specifically excludes signals. It should be understood that the software can be installed in and sold with the device. Alternatively, the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

In some embodiments, processing system 1900 is included in a network device that is accessing, or part otherwise of, a telecommunications network. In one example, processing system 1900 is in a network-side device in a wireless or wireline telecommunications network, such as a base station, a relay station, a scheduler, a controller, a gateway, a router, an applications server, or any other device in the telecommunications network. In other embodiments, processing system 1900 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A system, comprising:
one or more processors; and
a non-transitory computer-readable medium storing instructions that, when executed by the one or more processors, cause the one or more processors to perform operations comprising:
communicating, to a computer-implemented hub comprising a self-executing agreement implemented in a computer-implemented distributed ledger system, configuration information, the configuration information comprising, for each group member of a plurality of group members of a group, a first public key of a first public-private key pair for a first cryptocurrency address for the group member;
depositing, for each group member of the plurality of group members, a first cryptocurrency payment to the first cryptocurrency address for the group member, the first cryptocurrency payment corresponding to a withholding amount withheld from a wage payment to the group member, each of the plurality of group members associated with a respective user device storing a first private key of the first public-private key pair for the first cryptocurrency address for the group member;
receiving an approved benefit claim request for a requesting group member of the plurality of group members;
communicating, in response to the approved benefit claim request, a claim award notification to the computer-implemented hub, the claim award notification being a message that is digitally signed according to a private key that authorizes configuration of the computer-implemented hub; and
communicating, in response to the approved benefit claim request, an instruction to an application stored on each user device, the instruction to cause the application to automatically sign a transaction request using the first private key stored on the user device to automatically initiate a transfer of a partial benefit claim payment from the first cryptocurrency address of the group member associated with the user device to the computer-implemented hub for depositing to a second cryptocurrency address associated with the requesting group member according to a ruleset enforced by the computer-implemented hub in accordance with the configuration information and the claim award notification.

2. The system of claim 1, wherein the operations comprise depositing the first cryptocurrency payment to the first cryptocurrency address at a plurality of instances, the plurality of instances corresponding to pay periods that occur at substantially regular intervals.

3. (canceled)

4. The system of claim 1, wherein:
the configuration information comprises information indicating the group members of the plurality of group members; and
the operations comprise signing a message that includes the configuration information using a first management private key that allows the computer-implemented hub to be configured using the configuration information of the message.

5. The system of claim 1, wherein the instruction communicated to the application stored on each user device comprises:
a benefit claim identifier; and
a proposed apportioned benefit award amount for the benefit claim request, as approved.

6. The system of claim 5, wherein the claim award notification comprises:
the benefit claim identifier;
an indication of the requesting group member as a benefit award recipient; and
a total benefit award amount for the benefit claim request, as approved.

7. The system of claim 6, wherein the operations further comprise receiving, following payment in a fiat currency of the total benefit award to the requesting group member, a reimbursement notification indicating deposit of cryptocurrency from the second cryptocurrency address of the requesting group member to a reimbursement cryptocurrency address to at least partially reimburse an entity for payment in the fiat currency of the total benefit award to the requesting group member.

8. The system of claim 7, wherein the entity is an employer of the plurality of group members.

9. The system of claim 6, wherein the operations further comprise receiving, following payment in a fiat currency of the total benefit award to the requesting group member, a confirmation notification from the user device of the requesting group member confirming that the requesting group member received the payment in the fiat currency of the total benefit award.

10. The system of claim 1, further comprising:
receiving an indication of a new group member;
communicating an indication of the new group member to the computer-implemented hub.

11. The system of claim 1, wherein the benefit claim request is a request for:
paid sick leave;
health benefits; or
workers compensation.

12. A non-transitory computer-readable medium storing instructions that, when executed by one or more processors, cause the one or more processors to perform operations comprising:
receiving, by a user device associated with a first group member of a plurality of group members of a group, an instruction from a device associated with a trusted intermediary to transfer a first cryptocurrency payment from a first cryptocurrency address to a benefit cryptocurrency address of a benefit award recipient, the instruction associated with an approval of a benefit claim request of the benefit award recipient, the first cryptocurrency address configured for storing first cryptocurrency funds for funding a benefit award associated with a benefit claim, the first cryptocurrency address associated with a first private key stored on a user device of the first group member, the first private key being hidden at a user interface level of the user device; and
initiating, automatically in response to receiving the instruction, the transfer, via a computer-implemented hub, of the first cryptocurrency payment from the first cryptocurrency address to the benefit cryptocurrency address of the benefit award recipient, the transfer of the first cryptocurrency payment being signed according to the first private key with which the first cryptocurrency address is associated, the computer-implemented hub comprising a self-executing agreement implemented by a distributed ledger system, the distributed ledger system comprising a plurality of decentralized processing nodes each configured to execute the self-executing agreement and that operate according to a consensus mechanism, the self-executing agreement comprising computer instructions configured to, when executed by a processing node, execute the transfer according to one or more rules.

13. The non-transitory computer-readable medium of claim 12, wherein the instruction received from the device associated with the trusted intermediary comprises:
a benefit claim identifier; and
a proposed apportioned benefit award amount for the benefit claim request, as approved.

14. The non-transitory computer-readable medium of claim 13, wherein the first cryptocurrency payment from the first cryptocurrency address to the benefit cryptocurrency address of the benefit award recipient via the computer-implemented hub is less than the proposed apportioned benefit award amount for the benefit claim request, as approved.

15. The non-transitory computer-readable medium of claim 14, wherein initiating the transfer comprises sending a transfer request to the computer-implemented hub, the transfer request comprising:
the benefit claim identifier;
the transfer of the first cryptocurrency payment, signed according to the first private key with which the first cryptocurrency address is associated, the transfer comprising a request to transfer the first cryptocurrency payment from the first cryptocurrency address to a cryptocurrency address of the computer-implemented hub for transfer to the benefit cryptocurrency address of the benefit award recipient; and
an indication of an amount of the first cryptocurrency payment.

16. (canceled)

17. The non-transitory computer-readable medium of claim 12, wherein the first cryptocurrency payment is one of a plurality of first cryptocurrency payments made by the plurality of group members, each group member of the plurality of group members associated with a corresponding first cryptocurrency payment, the computer-implemented hub configured to transfer an aggregate of the first cryptocurrency payments to the benefit cryptocurrency address, the aggregate of the first cryptocurrency payments covering at least a portion of a benefit award associated with the approval of the benefit claim request.

18. The non-transitory computer-readable medium of claim 17, wherein:
the benefit award recipient is the first group member; and
the operations further comprise:
receiving a payment indication that the first group member received, in a fiat currency, the benefit award paid by an entity; and
initiating, in response to receiving the payment indication, a transfer of a second cryptocurrency payment from a second cryptocurrency address to a reimbursement cryptocurrency address associated with the entity to at least partially reimburse the entity for payment in the fiat currency of the benefit award to the benefit award recipient, the second cryptocurrency address being the benefit cryptocurrency address, the second cryptocurrency address associated with a second private key stored on the user device of the first group member, the transfer of the second cryptocurrency payment being signed according to the second private key with which the second cryptocurrency address is associated.

19. The non-transitory computer-readable medium of claim 18, wherein the entity is an employer of the plurality of group members.

20. The non-transitory computer-readable medium of claim 12, wherein the operations further comprise initiating, in response to an exit instruction received through a user interface of the user device, a transfer of a remaining balance of the first cryptocurrency address to a third cryptocurrency address, the first cryptocurrency address returning to a zero balance, the third cryptocurrency address associated with a third private key stored on the user device of the first group member.

21. (canceled)

22. A method, comprising:
depositing, by a processing system over time, for each group member a group, respective first cryptocurrency payments to respective first cryptocurrency addresses for each group member, each group member associated with a respective user device storing a first private key for the first cryptocurrency address for the group member;
communicating, in response to an approved benefit claim request, a claim award notification to a computer-implemented hub, the computer-implemented hub comprising a self-executing agreement implemented in a computer-implemented distributed ledger system; and
communicating, in response to the approved benefit claim request for a requesting group member of the group, an instruction to an application stored on each user device to cause the user devices to crowdfund a total benefit claim payment corresponding to the approved benefit claim request using cryptocurrency from the respective first cryptocurrency addresses of the group members, the instruction to cause the application to use the first private key stored on the respective user device to initiate a transfer of a partial benefit claim payment from the first cryptocurrency address of the group member associated with the respective user device to a computer-implemented hub for depositing to a second cryptocurrency address associated with the requesting group member according to a ruleset enforced by the self-executing agreement in accordance with the claim award notification.

23. The method of claim 22, wherein:
the method further comprises communicating, by the processing system to the computer-implemented hub, configuration information, the configuration information comprising, for each group member of the group, a first public key of a first public-private key pair for the first cryptocurrency address for the group member, the first public-private key pair for the first cryptocurrency address for the group member comprising the first public key and the first private key for the first cryptocurrency address for the group member; and
communicating, by the processing system to the computer-implemented hub, the configuration information comprises signing a message that comprises the configuration information using a first management private key that allows the computer-implemented hub to be configured using the configuration information of the message.

24. The method of claim 22, further comprising receiving, by the processing system following payment in a fiat currency of the total benefit payment to the requesting group member, a reimbursement notification indicating deposit of cryptocurrency from the second cryptocurrency address of the requesting group member to a reimbursement cryptocurrency address to at least partially reimburse an entity for payment in the fiat currency of the total benefit payment to the requesting group member.
